(19) United States
(12) Patent Application Publication
(10) Pub. No.: US 2008/0127654 A1
(43) Pub. Date: Jun. 5, 2008

(54) Container for Transport and Storage for Compressed Natural Gas

(76) Inventors: Charles M. Darling, Houston, TX (US); Catherine M. Fonfara, Houston, TX (US); A. Bruce Murray, Houston, TX (US); Karen D. Barker, Arlington, VA (US)

Correspondence Address: JAMES REMENICK;NOVAK DRUCE & QUIGG, LLP, 1300 I STREET NW, SUITE 1000 WEST TOWER, WASHINGTON, DC, 20005, US

(21) Appl. No.: 11/970,299

(22) Filed: Jan. 7, 2008

Related U.S. Application Data
(63) Continuation-in-part of application No. 11/781,132, filed on Jul. 20, 2007.
(60) Provisional application No. 60/831,962, filed on Jul. 20, 2006.

(51) Int. Cl. F17C 7/00

(52) U.S. Cl. 62/50.2; 220/560.11

(57) ABSTRACT

A method and apparatus for unloading natural gas (NG), including gasifying liquid and/or compressed NG using the latent heat of water and propane, and/or storing liquid or compressed NG gas in a storage cavern system that utilizes a buffer layer to prevent hydrating the NG gas, the storage cavern system being configured such that the NG may be forced out of a first storage chamber by increasing the amount of brine in a second chamber to displace a buffer fluid located therein such that the displace buffer fluid enters the first storage chamber and displaces the NG, as well as the processes for compressing, chilling and/or liquefying quantities of LNG and transporting those volumes to markets for redelivery.

### CROSS REFERENCE TO A RELATED APPLICATION

This application claims priority to Provisional Application No. 60/831,962 filed Jul. 20, 2006 entitled ‘Container for Transport and Storage for Compressed Natural Gas’, the contents of which are incorporated by reference in its entirety.

### BACKGROUND OF THE INVENTION

1. Field of the Invention

This invention is directed to apparatus, systems, and methods for unloading, vaporizing, storing, and supplying natural gas in fluid form. The invention further relates to containers and transportation lines for carrying and transporting natural gas and other fluid forms.
2. Description of the Background

Current systems and methods for unloading and storing natural gas (NG) are both expensive and difficult to manage. When NG is transported in bulk, other than by pipeline, it typically is in liquid form, which requires extreme refrigeration for a reduction in temperature sufficient to form a liquid. When the liquid NG (LNG) arrives at a given destination, it is offloaded from transport tankers and stored onshore in specialized storage facilities while still in a liquid state. This unloading and land based storage of LNG causes difficulties that prohibit the proliferation of NG use in countries such as the United States.

At some point in the process of getting NG to the consumer, LNG is returned to a gaseous state. Even in the gaseous state, storage of LNG requires pressurized facilities, which presents both actual and perceived risks. Both types of risks stem from safety concerns, specifically catastrophic failure of the storage tanks, and under certain circumstances, followed by explosions and fire. Although current technology minimizes the risk of accidents, it cannot mitigate the risk of terrorism related failures. This fear has led many communities to refuse permission for the building of construction of unloading facilities and storage facilities.

Due to public safety concerns, stringent regulations are often put into place controlling when and where LNG tankers are permitted to dock. Other commercial and recreational boat traffic is often diverted when LNG tankers are present. This disruption to other businesses is a significant financial burden for every community in which there exists LNG traffic. Expenses related to offloading NG are already significant. Those expenses are significantly increased when considering all the safety precautions that must be taken into account.

One mechanism to address these concerns is disclosed in U.S. Pat. Nos. 4,325,656; 5,511,905; 6,530,240; 6,555,155; 6,584,781; 6,725,671; 6,739,140; 6,813,893; 6,848,502; 6,880,348 and 6,945,055 (the disclosures of which are all hereby specifically incorporated by reference). These United States patents address concerns of LNG storage and propose storage of LNG in salt caverns. However, there are problems associated with thermal shock where the very cold NG hits the warmer cavern walls and creates unwanted and destructive fissures. Further, there is unwanted mixing of the LNG with seawater.

Onshore facilities built to store NG in a liquid state, and then to convert the LNG into gas at some later time is also extremely costly. New systems and methods for unloading and gasifying LNG without incurring the economically unreasonable costs are needed to enlarge the NG market domestically and abroad.

### SUMMARY OF THE INVENTION

The invention overcomes the problems and disadvantages associated with current systems and methods of unloading and storing LNG.

One embodiment of the invention is directed to methods and apparatus for safely warming natural gas in a pipeline comprising passing the natural gas through a pipeline that is submerged in seawater, wherein the seawater is at a temperature which is warmer than the temperature of the natural gas. The seawater warms the natural gas through forced or natural circulation. The pipeline is preferably constructed of a cryogenically qualified material, which is well known to those skilled in the art, and commercially available. Preferably, the pipeline is a jacketed pipe system that comprises an inner pipe filled with the natural gas, an outer pipe filled with circulating a fluid buffer such as propane, a seawater exchange warmer, and a circulation pump. In this configuration, the jacketed pipe system may convert liquid natural gas to dense-phase natural gas between a berthing barge and a pumping platform, after the pumping platform, and/or between a pumping platform and a shoreline. Preferably the jacketed pipe system contains a monitor for detecting leakage of natural gas. The pipeline is preferably buried in or attached to the sea floor and enrooted to a shore side facility for distribution to customers.

The natural gas in this system is warmed by a wrapped pipe system comprised of wrapping pipeline around a pumping platform, wherein the pipeline is warmed by seawater around the pumping platform. Further, the pipeline comprises different stages of piping that gasifies the natural gas, such as, for example, a first stage comprising a jacketed pipe to carry the natural gas from a tanker or storage facility; a second stage comprising cryogenic piping; and a third stage comprising non-cryogenic piping. The different stages of piping are preferably sized such that they correspond to the calculated temperature of the natural gas at each position along the pipeline. Also preferably, the pipeline is insulated.

Another embodiment of the invention is directed to berthing facilities capable of docking a natural gas tanker internally or externally comprising a floating pumping platform; an optional surge tank; a pump or plurality of pumps; an optional boil off compressor; a generator; piping; an unloading arm; insulated liners designed for both top and bottom fill; and an underwater natural gas storage facility. The berthing facility comprises a series of pumps located on the tanker, or alternatively, on a pumping platform or on the berthing facility. Preferably the plurality of pumps are in parallel, and the piping is wrapped around the pumping platform to accommodate forced circulation and facilitate natural gas warming. Preferably the second floating platform houses dense phase equipment for the transfer of dense phase natural gas. Also preferably, the piping is buried in or on a sea floor enrooted to a shore-side facility.

The berthing facility further comprises an underwater cavern as a natural gas storage facility, or a series of caverns or a depleted reservoir. Also preferably, the facility comprises a safety system such as, for example, an emergency alarm and fire preventing and fighting systems, and/or an escape module.

Another embodiment of the invention is directed to methods and apparatus of offloading or storing liquid natural gas comprising offloading natural gas from a natural gas tanker into a first underwater cavern that contains a fluid buffer that forms between the natural gas and water in the cavern. Additionally, such methods and apparatus further comprise a second cavern that contains the fluid buffer, wherein fluid buffer can be pumped from the second cavern into the first cavern as desired. Alternatively, or in addition, the fluid buffer is transferred into the second cavern as the first cavern is filled with natural gas. Also preferably, the fluid buffer is transferred from a pool into the second cavern thereby displacing a portion of the fluid buffer into the bottom of the first cavern thereby raising the pressure in the first cavern to a desired pressure level. In this system, the natural gas can be gasified during transfer into the first cavern, or upon commencement of offloading from the natural gas tanker.

Another embodiment of the invention is directed to methods and apparatus of storing natural gas in an underwater facility with dense phase equipment comprising: pumping the natural gas from a tanker into an underwater facility; interposing a fluid buffer between the natural gas and seawater to reduce a propensity of the seawater to mix with the natural gas; and periodically supplementing the fluid buffer with additional buffer to maintain the thickness of the buffer layer. Preferably the fluid buffer comprises propane, methane or a combination thereof. Further, the underwater facility is formed such that a diameter around the bottom of the facility is reduced thereby reducing the surface area over which seawater can enter the natural gas and over which the fluid buffer can enter the natural gas. Preferably, the underwater facility is bottle shaped.

Another embodiment of the invention is directed to an underwater cavern containing: natural gas and water; and a fluid buffer between the natural gas and the water. Preferably the fluid buffer comprises propane, ethane or a combination thereof.

Another embodiment of the invention is directed to methods and apparatus of transferring natural gas into an underwater cavern comprising acclimating the cavern to about the temperature as the natural gas by repeatedly transferring heated natural gas into the cavern, wherein the natural gas is colder than the cavern, and each repeated transfer comprises natural gas that is colder than the previous transfer. Using these methods and apparatus, the natural gas is heated by transfer through pipes submerged in water, wherein the water is warmer than the natural gas.

Other embodiments and advantages of the invention are set forth in part in the description, which follows, and in part, be obvious from this description, or be learned from the practice of the invention.

### DESCRIPTION OF THE FIGURES

FIG. 1 shows an apparatus for unloading, gasifying, and storing LNG according to an embodiment of the invention.

FIG. 2 shows an overhead view of a berthing facility and a pumping platform according to an embodiment of the invention.

FIG. 3 shows a tube-in-tube gasification system according to an embodiment of the invention.

FIG. 4 shows an apparatus for unloading, gasifying, and storing LNG using a series of caverns to control LNG pressure according to an embodiment of the invention.

FIG. 5 shows an apparatus for unloading, gasifying, and storing LNG wherein a storage cavern is subjected to temperature control to control cavern pressure according to an embodiment of the invention.

FIG. 6 shows an apparatus for unloading, gasifying, and storing LNG using an offshore mooring and platform, and an onshore storage cavern according to an embodiment of the invention.

FIG. 7 shows an apparatus for unloading, gasifying, and storing LNG using an offshore storage cavern with a separate surge tank according to an embodiment of the invention.

FIG. 8 shows an apparatus for unloading, gasifying, and storing LNG using a depleted reservoir with a separate surge tank according to an embodiment of the invention.

FIG. 9 shows an apparatus for unloading, gasifying, and storing LNG using an offshore cavern without a separate surge tank according to an alternate embodiment of the invention.

FIG. 10 shows an apparatus for unloading, gasifying, and storing LNG using an offshore depleted reservoir without a separate surge tank.

FIG. 11 shows an example of an LNG tanker unloading LNG onto a berthing facility according to an alternate embodiment of the invention.

FIG. 12 shows a CNG container of one embodiment of the invention.

FIG. 13 shows a comparison of cylindrical & spherical tank configurations

FIG. 14 shows a cylindrical tank orientation.

FIG. 15 depicts the load sequence used for the material and geometric nonlinear finite element analysis with the final autofrettage pressure.

FIG. 16 depicts the dimensions of cylindrical tanks.

FIG. 17 shows the estimated 9% nickel stress-strain behavior for plastic FEA

FIG. 18 depicts 9% nickel Coefficient of Thermal Expansion (CTE) Data; mean values between 70° F. and indicated temperature

FIG. 19 depicts a plot of stress rupture of glass composites.

FIG. 20 depicts the steel shell overall length.

FIG. 21 depicts the end cap dimensions.

FIG. 22 depicts the composite overwrap configuration.

FIG. 23 depicts a finite element model of a section of the cylinder.

FIG. 24 depicts cylinder steel and composite hoop stress history for analysis load sequence.

FIG. 25 shows the Von Mises yield envelope for 75 ksi yield steel.

FIG. 26 depicts the Inconel Cylinder-to-Cap Joint Model.

FIG. 27 depicts the Cylinder-to-Cap Joint Steel Axial Stress and Composite Helical Ply Stress History for Analysis Load Sequence.

FIG. 28 shows the low-cycle fatigue curve for 9% nickel steel.

FIG. 29 shows the dome thickness profiles used in the finite element analysis.

FIG. 30 illustrates the details of the polar composite construction.

FIG. 31 illustrates details of the boss fitting design.

FIG. 32 illustrates details of the steel fitting design.

FIG. 33 illustrates the MPDE lined pressure vessel finite element model.

FIG. 34 depicts polar composite interface details.

FIGS. 35 and 36 depict polar fitting Von Mises stress at 1.0×MEOP (maximum expected operating pressure) and 2.0×MEOP.

FIG. 37 depicts the Von Mises stress at 4.0×MEOP.

FIG. 38 depicts the HDPE liner Von Mises stress and Meridianal strain at MEOP 3600 psi.

FIG. 39 depicts the MDPE liner Von Mises stress at MEOP=3600 psi.

FIG. 40 depicts the hoop fiber strain versus the axial location at the minimum burst pressure at 4.0×MEOP=14,400 psi.

FIG. 41 depicts Helical Pattern No. 1 IML Fiber Strain vs. Axial Location @ Minimum Burst Pressure (4.0×MEOP)=14,400 psi

FIG. 42 depicts Helical Pattern No. 1 IML Fiber Strain vs. Radial Location @ Minimum Burst Pressure (4.0×MEOP)=14,400 psi.

FIG. 43 illustrates Helical Pattern No. 1 OML Fiber Strain vs. Axial Location @ Minimum Burst Pressure (4.0×MEOP)=14,400 psi.

FIG. 44 illustrates Helical Pattern No. 1 OML Fiber Strain vs. Radial Location @ Minimum Burst Pressure (4.0×MEOP)=14,400 psi.

FIG. 45 illustrates Helical Pattern No. 2 IML Fiber Strain vs. Axial Location @ Minimum Burst Pressure (4.0×MEOP)=14,400 psi.

FIG. 46 illustrates Helical Pattern No. 2 IML Fiber Strain vs. Radial Location @ Minimum Burst Pressure (4.0×MEOP)=14,400 psi.

FIG. 47 illustrates Helical Pattern No. 3 IML Fiber Strain vs. Axial Location @ Minimum Burst Pressure (4.0×MEOP)=14,400 psi.

FIG. 48 illustrates Helical Pattern No. 3 IML Fiber Strain vs. Radial Location @ Minimum Burst Pressure (4.0×MEOP)=14,400 psi.

FIG. 49 illustrates Helical Pattern No. 4 OML Fiber Strain vs. Axial Location @ Minimum Burst Pressure (4.0×MEOP)=14,400 psi.

FIG. 50 illustrates Helical Pattern No. 4 OML Fiber Strain vs. Radial Location @ Minimum Burst Pressure (4.0×MEOP)=14,400 psi.

FIG. 51 shows, at a radius, r, the fiber angle relative to a meridianal line varies from one edge of the band to the other.

FIG. 52 illustrates the theoretical Composite Contour and Assumed Composite Contour.

FIG. 53 illustrates a thermal Analysis for the Heating of Cryogenic Liquid Methane

FIG. 54 shows a Cylindrical Tank in Air, Filled with Saturated Cryogenic Liquid and Vapor (side view).

FIG. 55 depicts a plot of the temperature history, from which it can be observed that the change in slope at about −124 deg F. due to the elimination of the vapor phase, precluding the absorption of energy by the change in phase.

FIG. 56 depicts energy, change in energy, D³T, and time as functions of temperature. The change in energy rises at first, drops by a factor of three at the point that the vapor phase is eliminated, then decreases thereafter.

FIG. 57 depicts internal energy, heating rate, time increment, and pressure as a function of temperature. The time interval rises to triple its initial value, then suddenly drops by a factor of two when the vapor phase is eliminated and, finally, rises again. The slope of the pressure curve increases markedly and becomes nearly constant at this same point.

FIG. 58 depicts liquid volumetric fraction, heat transfer coefficient, and densities of liquid and vapor as functions of temperature. Notice that the fluid starts as a mixture of liquid and vapor, becomes liquid only partially through the process, and ends up as supercritical fluid. Heat transfer coefficient decreases modestly.

FIGS. 59 and 60 depict Tank Schedule Phases 1 and 2.

### DESCRIPTION OF THE INVENTION

Conventional methods for unloading and storing LNG are expensive and difficult to manage and adequately control. Processes such as loading and offloading in bulk, regasification and transportation are difficult to operate and operate efficiently. For example, LNG transported by marine tanker must be offloaded from transport tankers and stored onshore in specialized storage facilities in a liquid state. This unloading and land based storage of LNG causes difficulties that have impaired efficient utilization of LNG as a natural gas source in many countries. Storing LNG presents many risks including safety concerns, specifically catastrophic failure of the storage tanks and possible explosion. Current technology minimizes these risks, although they still exist as do risks of terrorism-related failures.

Apparatus, systems and methods have been surprisingly discovered that substantially minimize these and other risks associated with natural gas. With the systems and methods of the invention, the natural risks associated with the handling of natural gas are minimized as are the risks imposed from terrorism and unintended accidents. Further, the systems and methods of the invention are also highly efficient, taking advantage of available environmental conditions to create a cost-effective natural gas management system.

The invention is directed to the transportation, loading and unloading of all forms of natural and petroleum gases including, but not limited to liquid natural gas (LNG), liquid petroleum gas (LPG), compressed natural gas (CNG), compressed petroleum gas (CPG), and also other gasses, such as, but not limited to helium and hydrogen. Natural gas comprises a mixture of low molecular weight hydrocarbons. A typical composition contains about 85% methane and about 10% ethane, with the balance composed of propane, butane and nitrogen. Petroleum gas (PG) comprises a large variety of low molecular weight hydrocarbons including propane, butane, hexane, pentane, and gasoline to name a few. Further, pure forms and other combinations of any of the components of natural gas and petroleum gas may also be used according to the invention. Although the invention is described using natural gas, the use of natural gas is exemplary only and PG, pure forms of the components of NG and PG as well as hydrogen and helium, and combinations of all of these gasses, are equally applicable to the systems and methods of the invention.

The invention also applies to both the liquid and gaseous forms of natural gas. Liquid, as used herein, refers to the form of a substance between a solid and a gas. The form or state of a substance is determined by both the temperature and pressures at which the substance is maintained. Many gases may exist in a state of dense-phase. Dense phase gas has the attributes of a gas, meaning that it should be maintained under pressure, but is sufficiently dense so as to have the physical characteristics to act as a liquid. Dense gases are gases at very cold temperatures, usually less than 0° C., preferably less than minus 50° C., more preferably less than minus 100° C., and even more preferably less than minus 150° C.

In particular, the invention is directed to transporting and storing LNG as well as CNG. The transportation of CNG, as compared to LNG, has the potential to allow non-pipeline transportation of NG on far more economic terms, reducing the huge infrastructure costs of an LNG project and making its utilization more economic. In such instances, a CNG infrastructure would be significantly more cost-effective than an LNG project. CNG eliminates the cost of CO₂ removal, liquefaction and the need for extreme reductions in temperature and the corresponding maintenance, while being capable of holding significant volumes of natural gas on one tanker. Bulk transport of NG occurs now in one, two and three billion cubic feet quantities. Although CNG generally requires more space, the additional space requirement needed is sufficiently offset by the saving achieved in time, energy and cost.

Costs are additionally be reduced by using light weight composite or composite wrapped steel tanks of small to large dimensions. The use of composite wrapped tanks or composite filament wound tank reduces the need for thick steel tank walls, which reduces the weight needed for containment and transportation of CNG. By utilizing one variety of hoop wrapping composites to carry CNG, the production costs for such containers are less costly because production tooling is used that is also used for regular all-steel storage tanks. Hoop wrapped composite cylinders also offer increased safety levels, as the lighter steel liner has the strength of steel and the additional strength of diagonally-wrapped tightly woven composite fibers which are durable and tolerant to stress damage. Wrapping the cylinders radially or laterally is desirable, depending upon the scale of the cylinders and manufacturing parameters, but may also include other wrapping arrangements as well. The attainable volumetric ratio for CNG, even if less than the volumetric ratio for LNG, is maximized by optimizing the temperature and pressure to benefit from the effect of super compressibility, which increases the attainable volumetric ratio.

The cylinder liner may be steel, aluminum or other suitable material that retains its strength at the lowest transportation temperatures to be maintained during transportation or during unloading of the CNG. The composite wrapping or filaments may comprise carbon such as graphite, or fiber glass, with a bonding material of epoxy or other resin. Examples of suitable resins include, but are not limited to esters, rubbers, high-strength man-made polymers, petroleum-derived resins, and combinations thereof. A complete composite, in some embodiments, eliminates the liner. The shape of at least one embodiment is spherical, but is preferably cylindrical with closed, but protruding ends to minimize or eliminate the presence of any sharp angles to the overall structure. Containers are arrayed vertically or horizontally, but in either formation comprise groups of interconnected containers to facilitate loading and unloading either simultaneously or sequentially. The containers, as a result of the composite wrapping, have additional protection from impacts and jostling that are possible during operation and transportation. The composite wrapping thus serves at least two purposes: strengthening the containers and protecting the containers.

Containers preferably provide refrigeration with commercial freezer units that are viable for ship use. Means for temperature control include but is not limited to, using liquid nitrogen, inert gas circulation, and insulation system.

Containers are preferably transported in conex boxes aboard aquatic vessels, land vehicles, or freight trains including but not limited to, ships, barges, trucks, and trains. The conex boxes are weather-proof and are preferably equipped with forklift slots for transportability. The conex box is suited for temporary or permanent storage of the containers indoors or outdoors. Frames are preferably utilized within the conex box to stabilize the containers during transport. Further, conex boxes housing the containers are preferably stacked side by side and atop one another.

Container Design

The container system involves the use of commercial, off-the-shelf, steel pipeline segments that are composite over-wrapped for additional strength. These pipeline segments are then interconnected through manifolds to produce a high volume tank structure. The purpose of this tank structure is the ocean-based transportation of dense phase natural gas to remote ports of call. As such, the tank structure is mounted in the hold of a commercially available tanker ship. The tank structure also has a pumping and refrigeration system to facilitate the uploading and offloading of the working fluid and to maintain the desired operating temperature and pressure. The entire system follows a modular design approach so that any individual segment is removable for maintenance at any time, which allows the system to be highly maintainable for a long operational lifetime.

Operational Characteristics

In certain embodiments, a number of critical operational characteristics are preferably met in order to assure that the system will be feasible from an engineering and economic standpoint. First, the tank structure is preferably loaded with low pressure liquid natural gas in order to assure that the ship can utilize existing port facilities. This liquid will preferably possess an approximate temperature of −260° F. with a pumping pressure of approximately 25 psig. Once en route to its final destination, the liquid is preferably allowed to warm up to an optimized temperature and pressure that maximizes the amount of fluid storage for a given system weight. A fluid state of near −60° F. and 2160 psig was selected to optimize the capacity ratio for the closed thermodynamic system. Generally, the capacity ratio describes the multiplication factor that occurs when the compressed gas is allowed to expand to ambient conditions. This capacity ratio, which ranges from 600 to 635, approaches the critical temperature of rich natural gas, beyond which the gas enters a liquid phase. So, any further decrease in temperature would not yield an increase in performance since the liquid state is incompressible. In order to maintain this capacity ratio and temperature, the fluid is actively pumped and circulated through a primary heat exchanger, which is further discussed below. Once the destination is reached, the dense phase gas is offloaded from the ship. The first phase of the offloading process preferably utilizes the stored fluid's high pressure to force it off the ship. However, once the pressure in the tanks has equalized with the offloading line pressure (typically at around 800-900 psig), the remainder of the gas inside the tanks is preferably actively pumped off. A small amount of residual pressure is left in the tanks to make the system more economically viable, since low pressure stored gas stakes more time and energy to remove.

A secondary aspect of the operational preferences involves the voyage and cycle time. The travel time between most ports of call is approximately 2 weeks. So, once the tank structure has been filled, the total travel time to a remote destination and to return back for the next shipment is approximately one month. On average, the tanks undergo 12 thermal-pressure cycles per year, which translates into 240 thermal-pressure cycles over the 20 year preferred minimum lifetime of the tanks. However, in order to assure proper safety margins and increase the overall lifetime of the system, the tanks are designed to withstand over 500 thermal-pressure cycles.

Full Scale System Design

Given the large size of available tanker ships, the system, in certain embodiments of the invention, exceeds the minimum required capacity of 2 billion cubic feet. In one embodiment, the system's volume capacity is approximately 2.7 to 2.9 billion cubic feet, depending upon the exact capacity ratio for the natural gas. This represents a 40% improvement over the minimum requirement; however, the cost increase is substantially less than 40%, making this preferred addition economically viable. The cost increase preferably remains lower due to learning curves and material negotiations. This volume is ascertained in certain embodiments by linking together an array of tanks through a manifolded, daisy-chain configuration. The actual array of certain embodiments consists of 22 columns and 23 rows of 48-inch diameter by 80-feet long composite over-wrapped pipeline segments. Preferably, the tank structure is 110 feet wide by 115 feet high.

The pipeline segments are composed of ½ inch thick alloyed steel that is specifically formulated to handle the extreme temperature ranges in certain embodiments. To further improve the cold-temperature characteristics while simultaneously improving the fatigue characteristics, the steel pipeline segments are autofrettaged in certain embodiments, which plastically deforms the pipeline segments leaving them in a state of residual stress that resists thermal contraction. A standard autofrettage cycle consists of taking the metallic specimen up to a higher-than-operating pressure by a prescribed, calculated percentage, thus overstressing the material. Overall, this prevents the metallic pipeline from delaminating from the composite overwrap when it is thermally shocked in certain embodiments.

In a preferred embodiment, each daisy-chain of tank segments consists of 9 pipeline segments attached end-to-end. These attachment points consist of 900-series (ANSI B16.5) endcaps and flanges. Preferably, each flange junction will be securely bolted together with twenty 2-inch bolts. This series of flanges and endcaps are preferably rated to above the system's operating pressure, and they are preferably man-rated, meaning they have a factor of safety of 4.0 in certain embodiments. Each endcap and weld-neck flange are preferably welded together first, then the assembly is welded to the pipeline segment before the segment is overwrapped. This protects the composite material from any thermal damage in preferred embodiments.

As mentioned above, the overall preferred volume is obtained by manifolding each nine-segment tank chain to adjacent chains to form an overall tank structure in certain embodiments. The initial manifolding scheme in a preferred embodiment is to cluster groups of 16 tank chains together to make them more manageable and modular. This cluster of 16 tank chains will preferably be interconnected with 20-inch tubing that is made from standard elbow fittings, t-fittings, and straight pipe segments, which makes the connections much less expensive than custom manifolds. Also, each tank chain has its own set of cryogenic-rated valves to make each unit removable. Additionally, the manifolded structures are preferably bolted to the tank chains, which also preferably make the structure modular.

A comprehensive thermal control system is used in certain embodiments to preferably maintain the desired temperature and pressure. The preferred combination of tank foam insulation and active chilling through a heat exchanger will be based upon the results of calculations currently underway that seek to describe how long it takes for the fluid to warm from −260° F. to −60° F. and what the overall heat transfer rate is in certain embodiments. Once that information is obtained, the heat exchanger and positive displacement pumping system is preferably sized to content with the calculated temperature loss. A positive displacement pumping system is selected in certain embodiments to combat any adverse effects caused by pumping dense phase fluids, such as fluid cavitation and pump seizure. The pumping and cooling system preferably also has a separate leak detection and emergency venting capability to maximize the safety of the system. The actual piping of the emergency venting system is preferably based on the actual ship selected for system integration. A secondary cooling and safety method which involves the flooding of the cargo hold with cooled gaseous nitrogen, is also optional in certain embodiments. In order for such a system to remain economical, a portion of the nitrogen purge is optionally injected directly from shore. This results in a much smaller set of secondary tanks to keep up with the gradual decay rate of the nitrogen, especially considering the sizeable volume of gas that will be initially preferred. This nitrogen rich environment also preferably suppresses the potential for any type of flame termination in certain embodiments if a substantial leak in one of the tanks occurs.

A heating element also is selectively used to facilitate the offloading of the working fluid at the port of call, depending upon what degree of thermal cooling expansion occurs as the fluid is offloaded. This rate of thermal cooling is directly dependent upon the rate at which the fluid is removed from the tanks, so calculations are preferably completed for each instance, the gas temperature change rate is determined for various fluid extraction rates. The processing station's line temperature ratings also have an impact upon the determination to include and size a heating element in certain embodiments.

Storage Tank Geometry

High-pressure gas containment vessels present a number of technical challenges due to the inherently high stresses they manage during their operating cycles and the natural permeability of solids to gases. In order to maintain a constant stress rate in the tank's wall, the wall thickness increases proportionally to the pressure and tank radius in preferred embodiments. As such, a network of high-pressure tanks is designed to maximize containment volume while minimizing weight and constant stress levels in preferred embodiments. This point of optimization ensures that the desired system is commercially feasible for certain embodiments.

Tank Selection Scheme

1) Overall containment volume for a fixed size.
2) Figure of Merit, ρV/W, which indicates overall system efficiency.
3) Other factors, including manufacturability and transportability.
   Design Approaches

Current LNG tankers use several large spherical tanks to contain the liquid at atmospheric pressure. This system uses high pressure tanks to store the fluid as a dense phase gas in some embodiments. The following configurations are possible:
1) Several very large spherical tanks. This approach involves the use of roughly three 50-meter diameter thick-walled spherical tanks on the deck of a custom built tanker. These tanks are manifolded together for optimum filling and emptying.
2) Numerous small cylindrical tanks. This approach involves the manifolding of a large array of small cylindrical tanks in order to meet the large volume requirement. These tanks are stacked in such a way as to minimize the amount of volume they occupy while still meeting the containment volume requirement.
3) Numerous long cylindrical tanks. This approach involves having approximately half the number of cylindrical tanks whose lengths were approximately double the length of the previous short tanks.
   Analysis
   Case 1: Large Spheres

Assumption: Spheres are 50 meters in diameter and also made of carbon fiber. The use of metal would result in the tanks that would likely be too heavy for a ship to support and too difficult to manufacture, and so not as economically fiable.

Spherical Vessel Design
Composite thickness=53.0 in
OD=1968.5 in (55 m)
Liner ID=1857.9 in
Internal Volume=1,943,242 cubic feet
Weight=36,228,262 lb
   Fiber Weight=21,990,866 lb
   Resin Weight=14,109,340 lb
   MDPE Weight=91,984 lb
   A286 Fitting Weight=36,072 lb (Qty. 2)
   ρV/W=1,334,706 in·lb/lb
      Case 2: Small Cylinders

Assumption: The cylindrical vessels are closely packed in a stacked configuration.

Cylinder Vessel Design
MR60H Carbon Fiber/Epoxy
MEOP=3600 psi
   FS=4.0; Design Burst=14,400 psi
Liner=MDPE, 0.25 in. thick
Cylinder Composite Thickness=1.584 in.
   Helical thickness=0.755 in.
   Hoop thickness=0.829 in.
A286 Steel End Fittings
   5.0 in. Opening Diameter
   6.0 in. Boss Diameter
Vessel Internal Volume=120.9 ft.
Vessel Weight=2,138 lb.
   Fiber Weight=1,200 lb.
   Resin Weight=700 lb.
   MDPE Weight=196 lb.
   A286 Fitting Weight=42 lb. (2 fittings)
Envelope=Cube w/side=sphere diameter=50 m (1,968.5 in.)
24,120 Cylindrical Vessels (42 in. diameter×192 in. long)
   10 Vertical layers
   53 Staggered rows/layers
      27 rows w/46 vessels
      26 rows w/45 vessels
   Total Internal Volume=2,916,203 cubic feet/24,120 vessels
   Total weight=51,568,560 lb./24,120 vessels
   ρV/W=1,407145 in·lb/lb
      Case 3: Larger Cylinders

Assumption: The larger cylindrical vessels are closely packed in a stacked configuration.

Cylinder Vessel Design
MR60H Carbon fiber/epoxy
MEOP=3600 psi
   FS=4.0; Design Burst=14,400 psi
Liner=MDPE, 0.25 in. thick
Cylinder composite thickness=1.584 in.
   Helical thickness=0.755 in.
   Hoop thickness=0.829 in.
A286 Steel end fittings
   5.0 in Opening diameter
   6.0 in. Boss diameter
Vessel weight=4,355 lb.
   Fiber weight=2,470 lb
   Resin weight=1,440 lb
   MDPE weight=403 lb.
   A286 Fitting weight=42 lb.
12,060 Cylindrical vessels (42 in. diameter×480 in. long)
5 Vertical layers
52 Staggered rows/layers
   27 Rows w/46 vessels
   26 Rows w/45 vessels
Total internal volume=4,522,500 cubic feet/12,060 vessels
Total weight=52,521,300 lb./12,060 vessels
ρV/W=2,142,640 in·lb/lb
   Other Trade Considerations

The values reported for each type of tank above represent a best-case scenario in regards to weight. Specifically, the large spherical tank is significantly (up to 30%) heavier than is reported due to manufacturing inefficiencies near the polar fittings. From a structural standpoint, since the spherical tank does not have a straight cylindrical portion, the principle stress is longitudinal, which is on average one half the magnitude of the hoop stress (tangential wall stress) found in a cylindrical span. Since no hoop circuit section is present in the spherical shape, only helical winding plies are needed to overwrap the tank.

However, this all-helical ply design presents a manufacturing difficulty near the two polar fittings, where there is the potential for substantial fiber and resin buildup. This effect occurs since every pass by the filament winder's head travels partially around the polar fittings, so an increased amount of fiber accumulates at the polar location. The fiber buildup gives the sphere an oblong, “football” shape, and it does substantially reduce the strength of the overwrap. To combat this situation, the helical wind angle, which is the angle that fibers are applied to the tank, is progressively and periodically increased (and in certain embodiments then decreased at the same time that the inner diameter is also increased) to produce a step-down effect in certain embodiments of this invention. Stepping back the winding fiber in this manner increases the winding time and complexity, which drives up the cost. However, this step-back approach is only partially effective, as a certain degree of fiber and resin buildup is at times inevitable. Additionally, from the standpoint of loads, helical plies typically possess a lower allowable stress than circular hoop plies, so additional fiber is added to offset this reduction in strength. The reduction in allowable stress for helical layers may be attributed to the differential tensioning that the fiber goes through during its winding trajectory, specifically, near the polar fittings. Also, helical layers are more difficult to control during winding, so pattern irregularities may further diminish the fiber strength. These effects are sometimes exacerbated by the fact that spherical tanks have larger polar fittings per unit surface area than cylindrical tanks, so the inefficiencies near these fittings are relatively worsened.

Another major trade consideration is the ease of manufacturability associated with size. In particular, larger tanks become disproportionately expensive to fabricate as new tooling and production components dramatically increase in cost. In fact, no winding machine currently in use is capable of winding a 50-meter sphere, so an entirely new, custom machine would be needed, at substantial cost. Overall, from an over-wrap standpoint, tanks are typically size-limited by both the manufacturing processes involved and the increase in wall thickness preferred to keep the stress/strain rates at an acceptable level.

Cylinder length is also limited by several additional factors. While the tank is being filament wound, it should remain in a nearly non-bended state to ensure that no fiber slippage and disorientation occurs. However, while being filament wound, the tank can only be supported on its ends, as any mid-span support would directly interfere with the winding process and damage fiber that has already been placed. As a result, a filament-wound tank should preferably not exceed 40-50 feet, unless an increased liner is used.

Tank Preferences

The first factor to be preferably examined is total volume of each system configuration. From the information listed above, the volume of the large sphere configuration is 1,943,242 cubic feet, while the volumes of the small cylinders and larger cylinders were 2,916,203 cubic feet and 4,522,500 cubic feet, respectively. From a direct comparison of the volume envelopes for each of the configurations, the larger cylinders have a substantial volume advantage over the other two configurations in certain embodiments.

The next factor to be preferably examined is the Figure of Merit, pV/W, which represents the ratio of the pressure (p) of the system multiplied by the system's total volume (V), then divided by the system's total weight (W). This figure of merit quantifies the overall efficiency of the tank system by comparing the amount of material a tank can hold to the tank's overall dry weight. From the information listed above, the pV/W of the large sphere configuration is 1,334,706 in·lb/lb, while the pV/W of the small cylinder and large cylinder configurations are 1,407,145 in·lb/lb and 2,142,640 in·lb/lb, respectively. When examining this figure of merit, a larger number indicates a higher efficiency since a given tank can hold more material per unit mass. From a direct comparison of the pV/W values for each of the analyzed systems, the longer cylinders have a substantial efficiency advantage over the other two configurations.

The final factor to be preferably considered is the overall manufacturability and winding efficiency of various sizes. As previously stated, a larger diameter becomes disproportionately inefficient from the manufacturing process alone. Preferably, that given the high pressure of the system, a diameter of between 40 and 50 inches is used to optimize the volume to weight ratio. Additionally, the length of a cylinder is limited by the amount of bending that is produced during winding. This effect is dependent upon the stiffness of the mandrel/liner. For example, for a thin walled, pressurized liner, the amount of bending in a 40 to 50 foot long tank approaches the fiber slippage limit. However, this limit is increased by increasing the thickness/stiffness of the liner material. Preferably, the dimensions equate to a 40 to 50 inch diameter cylindrical tank with a length of approximately 40 feet.

Transportation Options

Technical difficulties in the transportation of LNG arise mainly from the need to meet pressure and temperature insulation, safety standards and infrastructure adaptation for logistics, transportation and service. Cost considerations include serviceability, fill and expulsion characteristics, regulatory compliance issues (safety) and scalability. They also include recurring expenses (RE) and non-recurring expenses (NRE).

Selection Criteria

The proposed configurations for transportation were studied with regard to the following aspects:
A) Technical Performance: (pressure, temperature insulation, mounting and connecting configurations, fill and expulsion characteristics).
B) Life Cycle Performance: (shelf life, service life, degradation, disposal)
C) Logistics and Safety: (storage, transportation, failure modes, monitoring)
D) Serviceability: (maintenance, repairs, replacement and field service capability)
E) Cost: (RE, NRE)
Applied Rating: 1=not acceptable; 2=poor; 3=fair; 4=good; 5=excellent
   Design Approaches & Characteristics

All configurations include remote monitoring for leaks or fire and automated shut-down capability for groups of tanks. The competing configurations are:

1. Bundled Clusters of 5 Vessels, Horizontal Storage. (L=16-36 ft.)
This approach holds clusters of 5 vessels each in a horizontal position. The individual vessels are held in a ring-shaped configuration with one vessel at the core and four around it. Where preferred for maximizing utilization of cargo space, the clusters are laid horizontally on top of each other. The vessels are connected with pressure lines serially within a cluster, and the clusters are connected in parallel mode. This configuration allows the shutdown or bypass of clusters. The vessels are optionally wrapped for thermal insulation individually or as clusters.

2. Bundled Clusters of 5 Vessels, Vertical Storage. (L=16-36 ft.)
This approach holds clusters of 5 vessels each in a vertical position. It mirrors candidate 1 but is rotated 90 degrees. The individual vessels are held in a ring-shaped configuration with one vessel at the core and four around it. Where preferred for maximizing utilization of cargo space, the clusters are stacked vertically on top of each other. The vessels are connected with pressure lines serially within a cluster, and the clusters are connected in parallel mode. This configuration allows for shutdown or bypass of clusters. The vessels are optionally wrapped for thermal insulation individually or as clusters.

3. Rack Mounted (L=16-36 ft.)
This approach uses racks built to fit the internal shape and dimensions of a particular cargo hull. The orientation is optionally horizontal or vertical. A rack or rack segment constitutes a cluster in terms of its pressure line connection scheme, allowing shutdown or bypass or certain segments in case of failure. The vessels are optionally wrapped as clusters or individually, dependent upon the particular installation configuration for thermal insulation.

4. Container Mounted 20 ft. (4 Vessels per Container) (L=16 ft)
This approach incorporate serially connected vessels into a standard size 20 ft. shipping container, of which 2 side by side vessels are at the bottom and 2 on top horizontally mounted. The containers are flanged at the small ends for a parallel connection into the system. The vessels are individually wrapped for thermal insulation, and the container walls are padded with flame retardant material. This enclosed configuration enables remote monitoring with sensors for automatic shutdown or bypass in case of malfunction and the containers can be stacked as preferred in certain embodiments.

5. Container Mounted 40 ft. (6 Vessels per Container) (L=16 ft)
This approach incorporates two sets of four serially connected vessels into a standard size 40 ft shipping container, of which 2 pairs of side by side vessels are at the bottom and 2 on top horizontally mounted. The containers are flanged at the small ends for a parallel connection into the system. The vessels are individually wrapped for thermal insulation, and the container walls are padded with flame retardant material. This enclosed configuration enables remote monitoring with sensors for automatic shutdown or bypass in case of malfunction and the containers can be stacked as preferred in certain embodiments.

6. Container Mounted 40 ft. (4 Vessels per Container) (L=36 ft)
The approach incorporates one set of four 36 foot long serially connected vessels into a standard size 40 foot shipping container, of which 2 side by side vessels are at the bottom and 2 on top horizontally mounted. The containers are flanged at the small ends for a parallel connection into the system. The vessels are individually wrapped for thermal insulation, and the container walls are padded with flame retardant material. This enclosed configuration enables remote monitoring with sensors for automatic shutdown or bypass in case of malfunction and the containers can be stacked as preferred in certain embodiments.

7. Strings of Individual Vessels, Customs Configured to a Cargo Hull (L=16-36 ft)
This approach custom fits individual vessels to the internal shape and dimensions of a particular cargo hull. Shutdown or bypass of certain segments in case of failure is accommodated depending on configuration of the installation and the size of the total tank capacity. The vessels are wrapped individually for thermal insulation.
   Analysis:

The analysis is based on the fact that a type of pressure vessel, for a particular application has been selected. That type of vessel is used for the following examination of the possible approaches. Therefore, this analysis examines the differences among various approaches to arranging, integrating and operating them in a ship for transportation purposes. Consequently, the base point ratings for technical and life cycle performance are similar among the approaches, and vary only by the impact that the particular approaches have on their performance.

Preferred Approach

| | | | | | |
|---|---|---|---|---|---|
| Technical | Life Cycle | Logistics/ | Service- | | TOTAL |
| Performance | Performance | Safety | ability | Cost | Points |

Rating: 1 = not acceptable 2 = poor 3 = fair 4 = good 5 = excellent

| | | | | | | |
|---|---|---|---|---|---|---|
| Config. 1 | 3 | 4 | 4 | 2 | 4 | 17 |
| Bundled | Positive points for | Life cycle impact | Requires | Access to | | |
| clusters of | the opportunity to | of this approach is | custom made | individual | | |
| 5 vessels, | wrap whole | neutral. | holding | vessels is | | |
| horizontal | clusters for | | structures for | limited. | | |
| storage. | thermal | | transportation | Removing | | |
| (L = 16- | insulation. | | to the | clusters for | | |
| 36 ft) | Negative points | | integration | access | | |
| | for the potentially | | site. Limited | requires | | |
| | complex | | containment | specialized | | |
| | holding structure | | of leaks or | holding/lifting | | |
| | required to | | fire in this | equipment. | | |
| | accommodate | | “open” | | | |
| | stacking the | | configuration. | | | |
| | clusters | | | | | |
| | horizontally, | | | | | |
| | possibly in | | | | | |
| | multiple layers. | | | | | |

| | | | | | |
|---|---|---|---|---|---|
| Technical | Life Cycle | Logistics/ | Service- | | |
| Performance | Performance | Safety | ability | Cost | TOTAL |

Rating: 1 = not acceptable 2 = poor 3 = fair 4 = good 5 = excellent

| | | | | | | |
|---|---|---|---|---|---|---|
| Config. 2 | 4 | 4 | 4 | 3 | 4 | 19 |
| Bundled | Positive point in | Life cycle impact | Requires | Access to | | |
| clusters of | technical | of this approach is | some holding | individual | | |
| 5 vessels, | performance is | neutral. | structure for | vessels is | | |
| vertical | the opportunity to | | transportation | limited. | | |
| storage. | wrap whole | | to the | Removing | | |
| (L = 16- | clusters for | | integration | clusters for | | |
| 36 ft) | thermal | | site. Limited | access | | |
| | insulation. | | containment | requires | | |
| | Vertical clusters | | of leaks or | specialized | | |
| | are easier to | | fire in this | holding/lifting | | |
| | hold, since the | | “open” | equipment, | | |
| | bending moments | | configuration. | although less | | |
| | and torsional | | | involved than | | |
| | forces are smaller | | | candidate 1. | | |
| | in comparison to | | | | | |
| | candidate 1. | | | | | |
| Config. 3 | 4 | 4 | 3 | 4 | 3 | 18 |
| Rack | Positive points for | Life cycle impact | Requires | Access to | Cost is | |
| mounted. | the absence of | of this approach is | some holding | individual | impacted by | |
| (L = 16- | bending moments | neutral. | structure for | vessels is | limited pre- | |
| 36 ft) | and torsional | | transportation | good. Clusters | fabrication | |
| | forces in a rack | | to the | are defined by | opportunity. | |
| | mounted | | integration | the | | |
| | configuration. | | site. Limited | connections | | |
| | | | opportunity | within the | | |
| | | | for | system. | | |
| | | | containment | Access | | |
| | | | of leaks or | requires | | |
| | | | fire in this | specialized | | |
| | | | “open” | holding/lifting | | |
| | | | configuration. | equipment, | | |
| | | | | although less | | |
| | | | | involved than | | |
| | | | | candidate 1. | | |
| Config. 4 | 5 | 5 | 5 | 5 | 3 | 23 |
| Container | Positive point in | Life cycle impact | Strong | Access to | Cost is | |
| mounted | technical | of this approach is | logistical | individual | impacted by | |
| 20′ | performance is | positive as the | performance | vessels is | the added cost | |
| (4 vessels | the reduced | encapsulation | using | good. Field | of containers | |
| per | bending | protects against | worldwide | service | but is reduced | |
| container). | moments and | environmental | used | capability is | by pre- | |
| (L = 16 ft) | torsional forces in | impact. | standards for | enhanced by | fabrication and | |
| | a container | | handling and | the exchange | modularization | |
| | mounted | | transportation. | capability of | opportunities. | |
| | configuration. | | Allows safety | “tank units” | | |
| | Allows individual | | monitoring | (1 container). | | |
| | thermal insulation | | and fire | | | |
| | of the vessels and | | containment. | | | |
| | flame retardant | | | | | |
| | treatment of the | | | | | |
| | container walls. | | | | | |
| Config. 5 | 5 | 5 | 5 | 5 | 4 | 24 |
| Container | Positive point in | Life cycle impact | Strong | Access to | Cost is | |
| mounted | technical | of this approach is | logistical | individual | impacted by | |
| 40′ | performance is | positive as the | performance | vessels is | the added cost | |
| (8 vessels | the reduced | encapsulation | using | good. Field | of containers | |
| per | bending | protects against | worldwide | service | but is reduced | |
| container). | moments and | environmental | used | capability is | by pre- | |
| (L = 16 ft) | torsional forces in | impact. | standards for | enhanced by | fabrication and | |
| | a container | | handling and | the exchange | modularization | |
| | mounted | | transportation. | capability of | opportunities. | |
| | configuration. | | Allows safety | “tank units” | | |
| | Allows individual | | monitoring | (1 container). | | |
| | thermal insulation | | and fire | | | |
| | of the vessels and | | containment. | | | |
| | flame retardant | | Slightly better | | | |
| | treatment of the | | use of cargo | | | |
| | container walls. | | volume than | | | |
| | | | candidate 4. | | | |
| Config. 6 | 5 | 5 | 5 | 5 | 5 | 25 |
| Container | Positive point in | Life cycle impact | Strong | Access to | Cost is | |
| mounted | technical | of this approach is | logistical | individual | impacted by | |
| 40′ | performance is | positive as the | performance | vessels is | the added cost | |
| (4 vessels | the absence of | encapsulation | using | good. Field | of containers | |
| per | bending | protects against | worldwide | service | but is reduced | |
| container) | moments and | environmental | used | capability is | by pre- | |
| (L = 36 ft) | torsional forces in | impact. | standards for | enhanced by | fabrication and | |
| | a container | | handling and | the exchange | modularization | |
| | mounted | | transportation. | capability of | opportunities. | |
| | configuration. | | Allows safety | “tank-units” | | |
| | Allows individual | | monitoring | (1 container). | | |
| | thermal insulation | | and fire | | | |
| | of the vessels and | | containment. | | | |
| | flame retardant | | Better use of | | | |
| | treatment of the | | cargo volume | | | |
| | container walls. | | than candidate | | | |
| | | | 5. | | | |
| Config. 7 | 4 | 4 | 3 | 4 | 4 | 19 |
| Strings of | Positive point in | Life cycle impact | Requires | Clusters are | | |
| individual | technical | of this approach is | specialized | defined by the | | |
| vessels, | performance is | neutral. | holding | connections | | |
| customs | the absence of | | structure for | within the | | |
| configured | bending | | transportation | system. | | |
| to a cargo | moments and | | to the | Access to | | |
| hull. | torsional forces in | | integration | individual | | |
| (L = 16- | a individually | | site. Limited | vessels is | | |
| 36 ft) | mounted | | containment | good but will | | |
| | configuration. | | of leaks or | require | | |
| | | | fire in this | specialized | | |
| | | | “open” | holding/lifting | | |
| | | | configuration. | equipment, | | |
| | | | | although less | | |
| | | | | involved than | | |
| | | | | candidate 1 | | |
| | | | | and 2. | | |

Recommendations:

Configuration 6, using commercially available 40 ft shipping containers filled with 4 vessels of 36 ft length offers an optimal combination of properties based on this analysis. Its particular benefit is facilitated by the use of internationally standardized shipping containers, for which all the handling and transporting infrastructure is readily available. The tank units (containers) also fit common land and air transportation methods for rapid deployment or replacement. This approach is completely modular and offers upward or downward scalability for customers with different capacity needs or existing fleets. It allows the use of practically any size and type of container ships for gas transportation, eliminating the need for purpose-built gas vessel ships. An additional benefit is the availability of cooler or freezer containers, which have the capability to keep gases at low temperatures during transportation. The integrated performance monitoring and automated shutdown capabilities of the containerized approach reduce risk, liability, and cost. (Candidate 4 uses the same approach but loses in cost performance comparison, as it preferably uses twice the number of containers. Candidate 5 [although better than 5] does not reach the volume utilization factor of number 6).

** Internationally standardized container dimensions
and capacity (standard general purpose container)

| | |
|---|---|
| Length: 40′ (12.192 m) | Internal Length: 39′ 5.375″ (12.024 m) |
| With: 8′ (2.438 m) | Internal With: 7′ 8.625″ (2.353 m) |
| Height: 8.5 feet (2.591 m) | Internal Height: 7′ 10″ (2.388 m) |
| Cubic: | 2385 cft or 67.5 cbm |
| Recommended load volume: | 2050 cft or 58 cbm |
| Rating, Gross mass: | 30,480 kg (67,200 lbs) |
| Tare mass: | 2,800 kg-4,000 kg |
| Payload: | 26,480 kg-27,680 kg |
| Average recorded maximum | 24,000 kg |
| payload: | |
| Purchase Cost: | $ 2000.00 average (standard |
| | general purpose container, steel) |
| Rent: | $ 150.00 month average (cost |
| | quotes of 2006) |
| Commercially available | Reefers (for perishable items) |
| variations: | Dehumidifiers |
| | Air conditioners (cool) |
| | Super cool (−27 C. or −17 F.) |
| | Super freezers (−60 C. or −76 F.) |
| | High cube (9.5 ft high) (2,690 cft) |

Cylindrical and Spherical Tank Geometry

High-pressure gas containment vessels present a number of technical challenges due to the inherently high stresses they manage during their operating cycles and the natural permeability of solids to gases. In order to maintain a constant stress rate in the tank's wall, the wall thickness increases proportionally to the pressure and tank radius. As such, a network of high-pressure tanks should be designed to maximize containment volume while minimizing weight and constant stress levels. This point of optimization helps ensure that the desired system is commercially feasible.

Selection Scheme:

1.) Overall containment volume for a fixed size.

2.) Figure of Merit, pV/W, which indicates overall system efficiency.

3.) Other factors, including manufacturability and transportability.

Competing Design Approaches:

Current LNG tankers use several large spherical tanks to contain the liquid at atmospheric pressure. This system alternatively uses high-pressure tanks to store the fluid as a dense phase gas. The following configurations are possible:
1.) Several very large spherical tanks. This approach involves the use of preferably three 50-meter diameter (˜164 ft) thick-walled spherical tanks on the deck of a custom built tanker. These tanks are manifolded together for optimum filling and emptying.
2.) Numerous small cylindrical tanks. This approach involves the manifolding of a large array of small cylindrical tanks in order to meet the large volume requirement. These tanks are stacked in such a way as to minimize the amount of volume they occupy while still meeting the containment volume requirement.
3.) Numerous longer cylindrical tanks. This approach involves having approximately half the number of cylindrical tanks whose lengths were approximately double the length of the previous short tanks.
   Analysis:
   Case 1: Large Spheres

Spheres are 50 meters in diameter (˜164 ft) and also made of carbon fiber. If metal were used instead, the tanks would likely be too heavy for a ship to support and likely too difficult to manufacture, and therefore not likely to be economically feasible.

Spherical Vessel Design
Composite Thickness=55.0 in
OD=1968.5 inch (55 m)
Liner ID=1857.9 in
Internal Volume=1,943,242 ft3
Weight=36,228,262 lb
   Fiber Weight=21,990,866 lb
   Resin Weight=14,109,340 lb
   MDPE Weight=91,984 lb
   A286 Fitting Weight=36,072 lb (2 Fittings)
pV/W=1,334,706 in-lb/lb
   Case 2: Small Cylinders

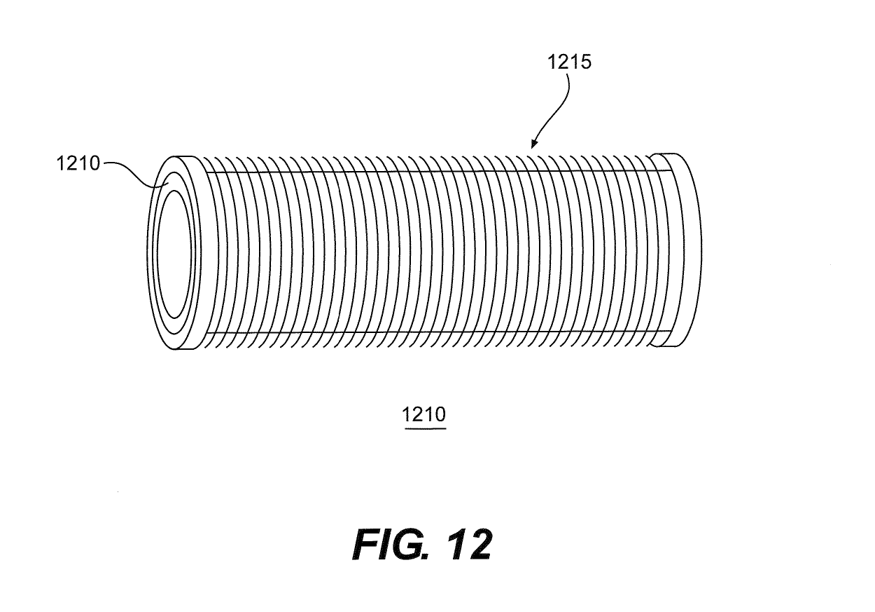

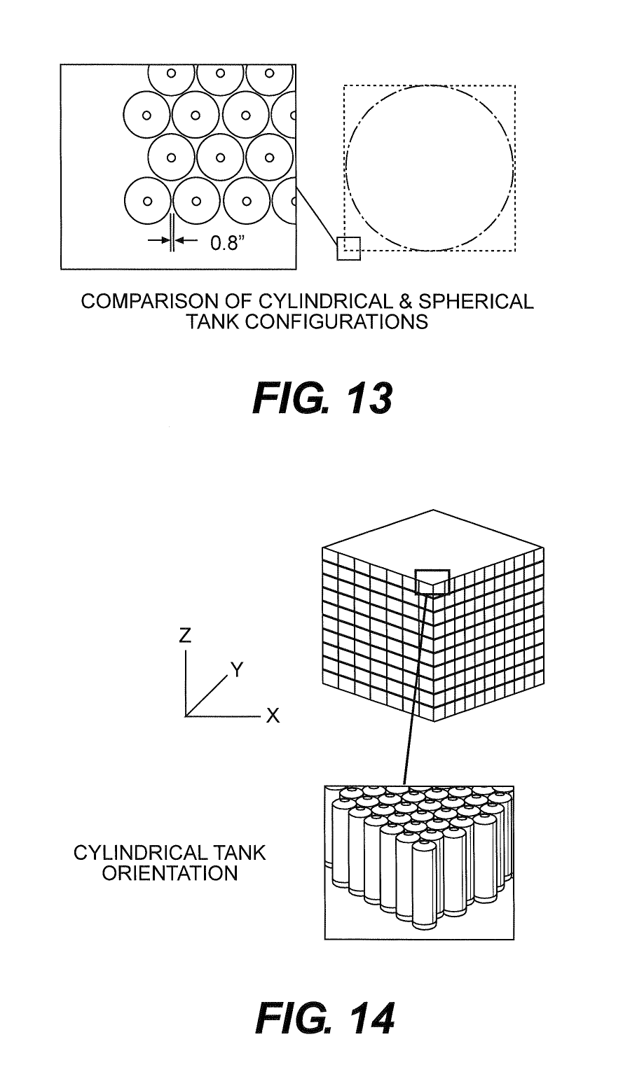

The cylindrical vessels are closely packed in a stacked configuration, as depicted in FIGS. 13 & 14.

Cylinder Vessel Design

MR60H Carbon Fiber/Epoxy
MEOP = 3600 psi
FS = 4.0 → Design Burst = 14400 psi
Liner = MDPE, 0.25″ Thick
Cylinder Composite Thickness = 1.584″
Helical Thickness = 0.755″
Hoop Thickness = 0.829″
A286 Steel End Fittings
5.0″ Opening Diameter
6.0″ Boss Diameter
Vessel Internal Volume = 120.9 ft
Vessel Weight = 2138 lb
Fiber Weight = 1200 lb
Resin Weight = 700 lb
MDPE Weight = 196 lb
A286 Fitting Weight = 42 lb (2 Fittings)
Envelope = Cube W/Side = Sphere Diameter = 50 M (1968.5 Inch)
24,120 Cylindrical Vessels (42″ Dia. × 192″ Long)
10 Vertical Layers
53 Staggered Rows/Layer
27 Rows W/46 Vessels
26 Rows W/45 Vessels
Total Internal Volume = 2,916,203 ft3/24,120 Vessels
Total Weight = 51,568,560 Lb/24,160 Vessels
pV/W = 1,407,145 in-lb/lb

Case 3: Larger Cylinders

The larger cylindrical vessels are closely packed in a stacked configuration, as depicted in FIGS. 13 & 14, similarly to the small cylinders.

Cylinder Vessel Design

MR60H Carbon Fiber/Epoxy
MEOP = 3600 psi
FS = 4.0 → Design Burst = 14400 psi
Liner = MDPE, 0.25″ Thick
Cylinder Composite Thickness = 1.584″
Helical Thickness = 0.755″
Hoop Thickness = 0.829″
A286 Steel End Fittings
5.0″ Opening Diameter
6.0″ Boss Diameter
Vessel Weight = 4355 lb
Fiber Weight = 2470 lb
Resin Weight = 1440 lb
MDPE Weight = 403 lbs
A286 Fitting Weight = 42 lbs
12,060 Cylindrical Vessels (42″ Dia. × 480″ Long)
5 Vertical Layers
52 Staggered Rows/Layer
27 Rows W/46 Vessels
26 Rows W/45 Vessels
Total Internal Volume = 4,522,500 ft³/12,060 Vessels
Total Weight = 52,521,300 lb/12,060 Vessels
pV/W = 2,142,640 in-lb/lb

Other Trade Considerations:

The values reported for each type of tank above represent a best-case scenario in regards to weight. Specifically, the large spherical tank is significantly (up to 30%) heavier than is reported due to manufacturing inefficiencies near the polar fittings. From a structural standpoint, since the spherical tank does not have a straight cylindrical portion, the principle stress is longitudinal, which is on average one half the magnitude of the hoop stress (tangential wall stress) found in a cylindrical span. Since no hoop circuit section is present in the spherical shape, only helical winding plies are needed to overwrap the tank.

However, this all-helical ply design presents a manufacturing difficulty near the two polar fittings, where there is the potential for substantial fiber and resin build-up. This effect occurs since every pass by the filament winder's head travels partially around the polar fittings, so an increased amount of fiber accumulates at the polar location. The fiber build-up would give the sphere an oblong, “football” shape, and it does substantially reduce the strength of the overwrap. To combat this problem, the helical wind angle, which is the angle that fibers are applied to the tank, is preferably progressively and periodically increased then decreased at the same time that the inner diameter is also increased to produce a step-down effect. Stepping back the winding fiber in this manner increases the winding time and complexity, which increases the cost of certain embodiments. However, this step-back approach is only partially effective, as a certain degree of fiber and resin build-up is inevitable in certain embodiments. Additionally, from the standpoint of loads, helical plies typically possess a lower allowable stress than circular hoop plies, so additional fiber is added to offset this reduction in strength in certain embodiments. The reduction in allowable stress for helical layers is attributed to the differential tensioning that the fiber goes through during its winding trajectory, specifically near the polar fittings. Also, helical layers are more difficult to control during winding, so pattern irregularities further diminish the fiber strength. These effects are sometimes exacerbated by the fact that spherical tanks have larger polar fittings per unit surface than cylindrical tanks, so the inefficiencies near these fittings are relatively worsened.

Another major trade consideration is the ease of manufacturability associated with just the size. In particular, larger tanks become disproportionately expensive to fabricate as new tooling and production components dramatically increase in cost. In fact, no winding machine currently in use is likely capable of winding a 50-meter sphere, so an entirely new custom built machine may be needed. Overall, from an over-wrap standpoint, tanks are typically size limited by both the manufacturing processes involved and the increase in wall thickness to keep the stress/strain rates at an acceptable level. In other words, as the diameter of a tank increases, the corresponding volume and the wall thickness grows by the same factor. Reviewing the fiber build-up and knock-down issues detailed above, an increase in wall thickness causes a given tank to become less weight efficient after a certain point. This effect is particularly true of higher pressure tanks, as their over-wrap is already significantly thick.

Cylinder length is also limited by several additional factors. While a tank is being filament wound, it should remain in a nearly non-bended state to ensure that no fiber slippage and disorientation occurs. However, while being filament wound, a tank can only be supported on its ends, as any mid-span support would directly interfere with the winding process and damage fiber that has already been laid down. Therefore, once the tank is supported on its ends, the tank mandrel that is being filament wound is basically a long beam that bends under its own weight, which, depending on the mandrel, can be significantly heavy. To reduce this condition, a filament wound tank with a thin walled liner, should preferably not exceed approximately 40-50 feet in length. Additional length may be achieved by using a more rigid, thicker liner.

Recommendations:

The first factor to be preferably examined is total volume of each system configuration. From the information reported above, the volume of the large sphere configuration is 1,943,242 ft³, while the volumes of the small cylinders and larger cylinders were 2,916,203 ft³ and 4,522,500 ft³, respectively. Therefore, from a direct comparison of the volume envelopes for each of the analyzed systems, the longer cylinders clearly have a substantial volume advantage over the other two system embodiments in certain embodiments.

The next factor to be preferably scrutinized is the Figure of Merit, pV/W, which represents the ratio of the pressure (p) of the system multiplied by the systems total volume (V), then divided by the system's total weight (W). This figure of merit preferably quantifies the overall efficiency of the tank system by comparing the amount of material a tank can hold to the tanks overall dry weight. From the information reported above, the pV/W of the large sphere configuration is 1,334,706 in-lb/lb, while the pV/W of the small cylinders and larger cylinders was 1,407,145 in-lb/lb and 2,142,640 in-lb/lb, respectively. When examining this Figure of Merit, a larger number indicates a higher efficiency since a given tank can hold more material per unit mass. So, from a direct comparison of the pV/W values for each of the analyzed systems, the longer cylinders clearly have a substantial efficiency advantage over the other two system embodiments.

The final factor to be preferably considered is the overall manufacturability and winding efficiency of various sizes. As stated above, a larger diameter becomes disproportionately inefficient from the manufacturing process itself. Given the high pressure of the system, a diameter of between 40 and 50 inches should preferably be used to optimize the volume to weight ratio. Additionally, the length of a cylinder is limited by the amount of bending that will be produced during winding. This effect is dependant upon the stiffness of the mandrel/liner. For a thin walled, pressurized liner, the amount of bending in a 40 to 50 feet long tank approaches the fiber slippage limit. However, this limit can be increased by increasing the thickness/stiffness of the liner material. One preferred embodiment is the use a 40 to 50 inch diameter cylindrical tank with a length of approximately 40 feet.

Steel-Lined Composite Tank Design

### 1. INTRODUCTION

This section summarizes the design and analysis a 48 inch diameter, 9% nickel steel pipe for pressurized gas containment. The steel shell is load sharing in the cylindrical section and the steel end caps carry all of the pressure. The composite wraps around the domes, only to develop the axial stress in the helical composite to relieve the stress in the relatively thin steel cylinder.

### 2. PREFERRED EMBODIMENTS

The pressure vessel in one embodiment is a load carrying 9% nickel steel shell with a filament wound composite reinforced cylinder. The reinforcing fiber was selected based on the performance requirements and cost. E-glass fiber was selected since it satisfies the performance requirements and is the most economical structural fiber.

The basic shell is a welded assembly consisting of a composite reinforced 0.5 inch thick, 48.0 inch OD cylinder and two identical end caps. The overall length consists of two standard 40 foot long pre-welded cylinder sections plus the end caps. The end caps are sized in this analysis and are 36.5 inches long. The overall length of the design is 1033.0 inches (86.1 feet).

The service life preferred embodiments consist of the following:
Service Pressure=2160 psi @−60° F. for 500 cycles with a 340 hr/cycle hold
Service Pressure=25 psi @−260° F. for 500 cycles with a 340 hr/cycle hold.

The total hold time is preferably 20 years for each service environment.

A minimum ultimate safety factor of 3.0 was specified for the over-wrapped cylinder in certain embodiments. The tank is preferably subjected to an autofrettage cycle to optimize the overwrapped cylinder performance. The recommended autofrettage pressure was developed for this invention.

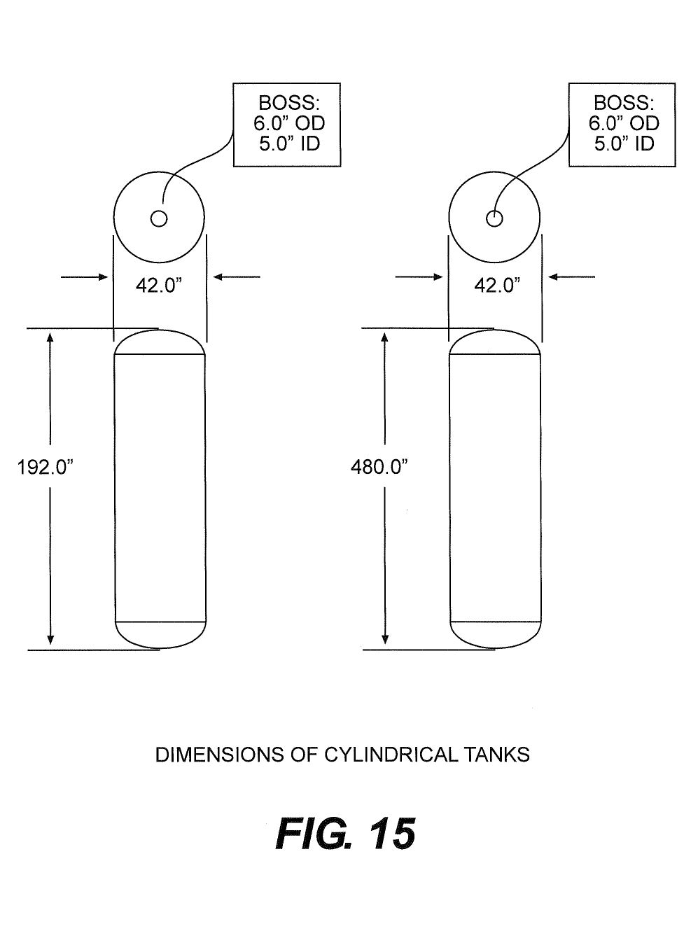

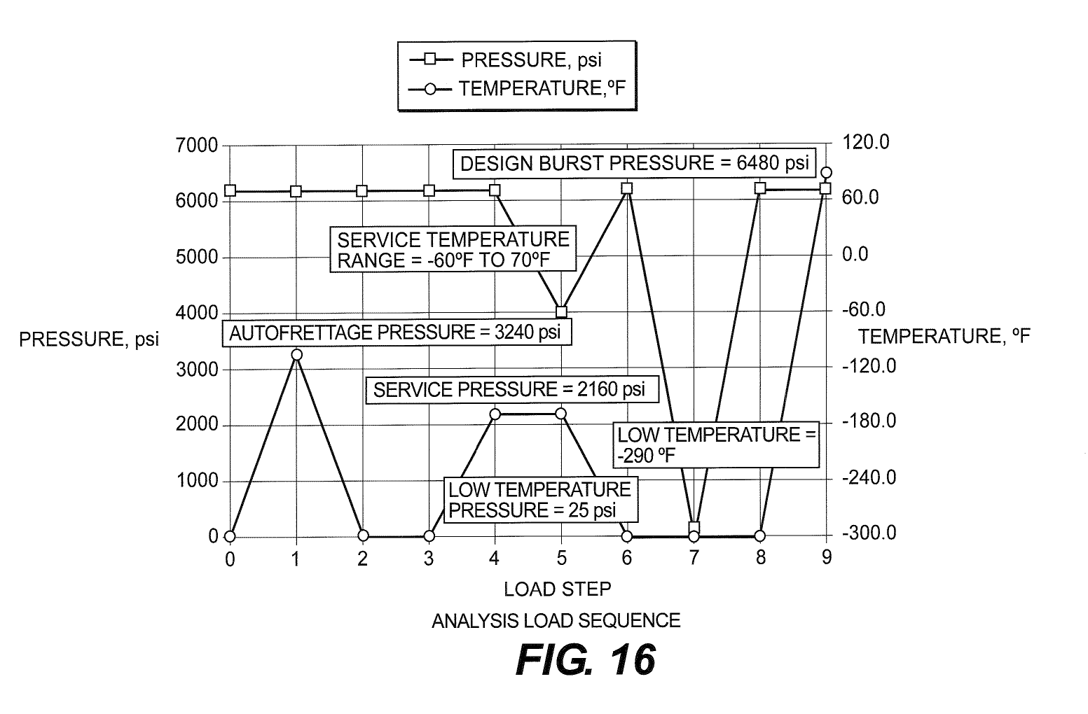

The load sequence used for the material and geometric nonlinear finite element analysis with the final autofrettage pressure is shown in FIG. 15. The sequence includes the autofrettage cycle, both high pressure and low temperature service cycles and a final design burst at 3.0×Service.

The end cap design is not included here, but is preferably used for analysis of the cylinder/cap joint and was designed per ASME B 16.9 (Ref. 3). The weld filler is assumed to have the same properties as the base material in certain embodiments. A standard ASME B16.5 900 lb 20 inch welding neck flange is preferably welded into each end cap.

### 3. MATERIALS

The pipe and end weldment material is annealed 9% nickel steel and has the following elastic properties (Ref. 1):

TABLE 3.1
9% Nickel Steel Properties

| Property | Value |
|---|---|
| E, msi | 29.0 |
| ν | 0.28 |
| G, msi | 11.3 |
| e, % | 20 |
| ρ, lbₘ/in³ | 0.29 |
| FTU, ksi | 100 |
| FTY, ksi | 75 |

Stress-strain data beyond the yield strength, necessary for the analysis, was not available for this material. The stress-strain curve shown in FIG. 15 was constructed for this analysis using the Ramberg-Osgood equation. The curve passes through the 0.2% yield strength of 75 ksi and the ultimate strength of 100 ksi at the ultimate elongation of 20%. The curve is typical of other ductile steels with similar yield and ultimate elongation.

Owens Corning® 366-AD-113 Type 30 E-Glass Roving is used for the design of this pressure vessel. This roving was chosen for this embodiment for its high tow density to maximize the winding bandwidth and minimize thickness problems in the polar region near the fittings. The tow has the following properties per the Owens Corning® datasheet:
1. Tow cross sectional area, CSA=2.672E-3 in²/tow.
2. Fiber modulus, E_{f}=10.5 msi.
3. Fiber density, ρ_{f}=0.092 lb/in³.
4. Impregnated strand tensile strength=500 ksi.
5. Flexural strength=227 ksi, fiber volume=72.8%.

A test specimen and testing method was developed to examine the strength and stiffness of filament wound composites (Ref. 2). Testing of OCF type 30 fiberglass shows that the fiber ultimate strength is 305 ksi.

The filament winding tensile strength allowable is estimated based on the Owens Corning® datasheet flexural strength (227 ksi). This approach is conservative since it includes compressive behavior. The average strength based on the fiber area is 315 ksi and an A-Basis type allowable, assuming a 9% COV (coefficient of variation) is 249 ksi. This value is supported by values used by others. The McDonnell Douglas Composites Manual presents Sikorsky Helicopter mean, A-Basis and B-Basis allowables of 270, 210 and 235 ksi (9.1% COV). The Brunswick Defense Division advertised hoop and helical fiber strength allowables of 270 and 240 ksi (“Composite Rocket Motor Case Design”, March 1979).

Based on all test data and properties used by others, the following design allowables were used for design of this vessel:
Fiber Strength=218 ksi
Fiber Strain=20760 μin/in.

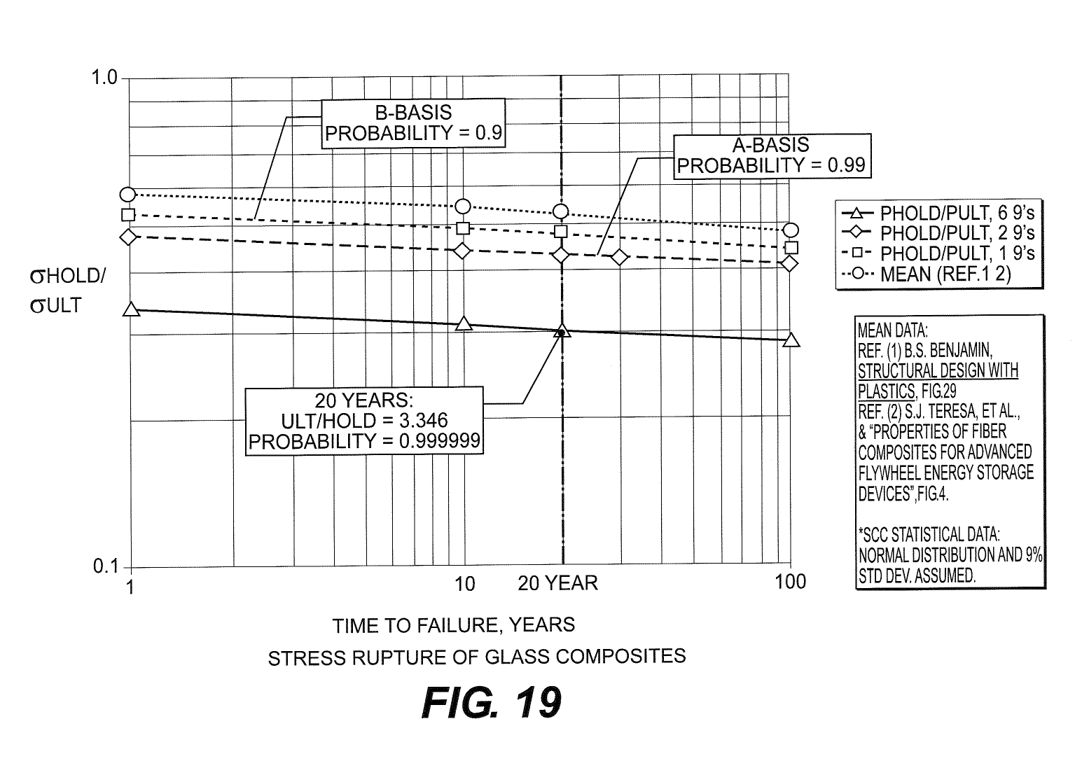

Fiberglass composites have significant strength degradation for long term loads. FIG. 19 is a plot of this degradation as a function of load duration. The mean data is taken from the references given in the figure. The statistical data assumes a normal distribution of data for any given load duration and a 9% standard deviation. The data was developed for small test articles and may be unconservative for large pressure vessels. The red curve with a probability that 99.9999% of the tests would survive the load period at a given percent of short term ultimate load (1 in 1.×10⁶ would fail) is used for design of glass pressure vessels. This curve yields safety factors consistent with composite pressure vessel codes such as NGV2.

### 4. END CAP DESIGN

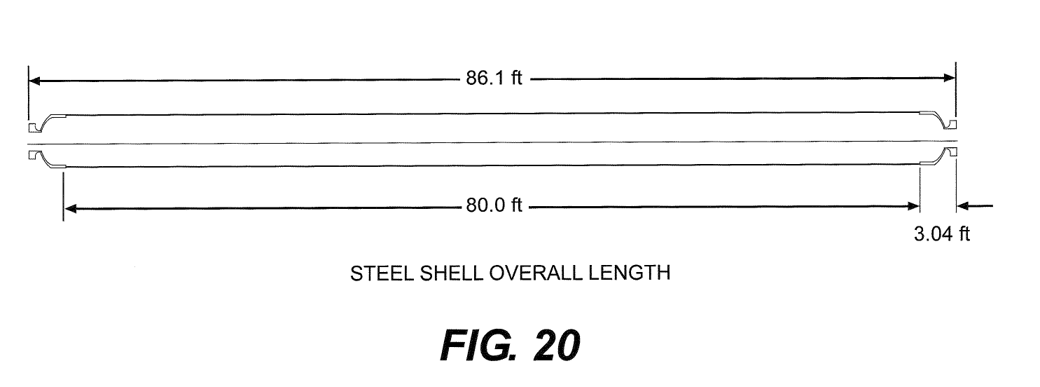

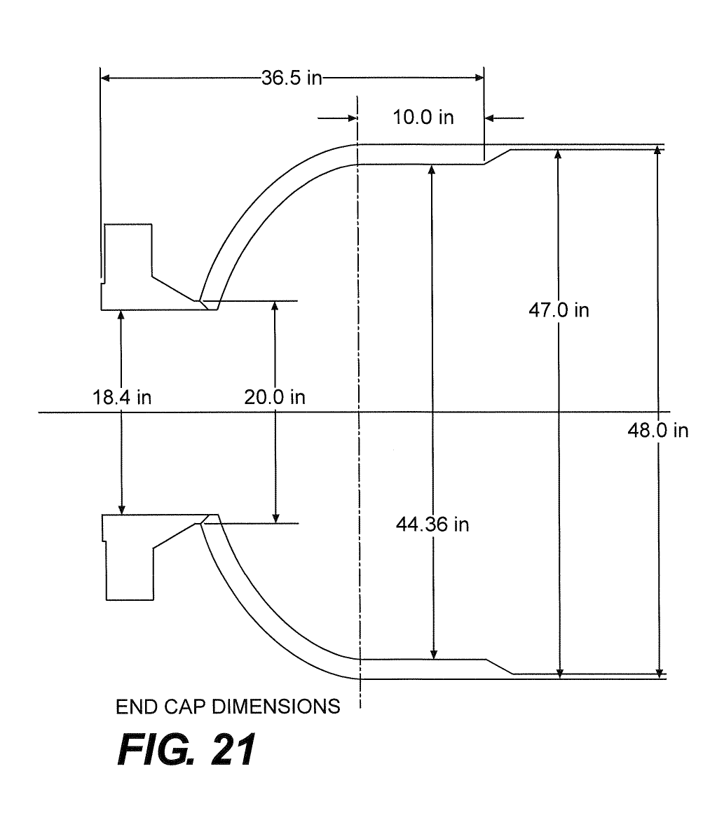

FIGS. 20 and 21 show the overall shell length dimensions and end cap details. End cap basic dimensions are defined in ASME B16.9, Table 11 which gives the following direction for 48.0 inch OD end caps:
1) Straight cylinder length E1: Table Note (1): “Length E1 applies to thickness greater than that given in column “Limiting Wall Thickness” for NPS 24 and smaller. For NPS 26 and larger, length E1 shall be by agreement between the manufacturer and purchaser.”
2) Table General Note (b): “The shape of these caps shall be ellipsoidal and shall conform to the shape requirements as given in the ASME Boiler and Pressure Vessel Code.”

A straight cylinder length of 10 inches was chosen so that the weld joint is remote from the end of the hoop overwrap. An ellipsoidal outside surface dome contour with a 0.707 minor-to-major aspect ratio was assumed. The actual aspect ratio is not critical for the overwrap design.

The thickness of the end cap was calculated per ASME B16.9 as follows:
The thickness is the thickness of a straight pipe of same material per ASME B31. Assume the same material as over wrapped pipe, 9% Nickel Steel. The minimum wall thickness per ASME B31, paragraph 104.1 is:

$${t}_{m} = \frac{{PD}_{0}}{2 ( SE + Py ) )} + A = 1.82 inch$$
Where:
   P=design pressure=2160 psi
   D₀=Outside Diameter=48 inch
   SE=28.6 ksi for Mittal 9% Nickel Steel (not given in B31)
   A=additional thickness compensation=(Mark's Handbook says 0.065 inch)
   y=coefficient for temperature <900 F=0.4

The external dimensions of the 900 lb welding neck flange are specified by ASME B16.5. The bore diameter depends on the strength of the metal used and is calculated as follows:
The thickness is the same as a pipe 20 inch pipe. Assume the same material as 48 inch pipe, 9% nickel steel:

$${t}_{m} = \frac{{PD}_{0}}{2 ( SE + Py ) )} + A = \frac{2160 \cdot 20}{2 ( 28600 + 2160 \cdot .4} + 0.065 = 0.80 inch$$

$$Bore Diameter = 20 - 2 x t = 18.4 inch$$

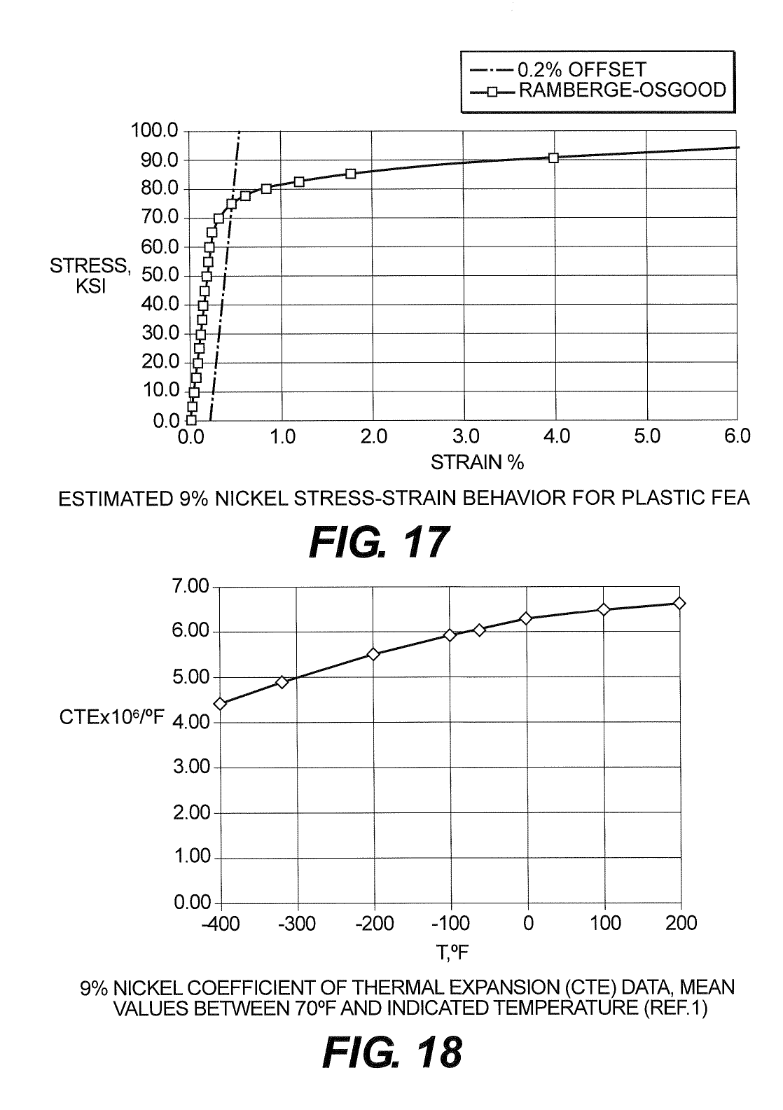

The composite design was developed based on netting analysis and a helical-to-hoop fiber stress ratio of 60%. This ratio was selected to force a hoop failure mode in the cylinder. Typically a 70% ratio is sufficient for a geodesic iso-tensoid dome. However, this dome is not optimum shape and the lower ratio was necessary. The winding schematic in FIG. 17 describes the details of the composite fabrication.

### 5. COMPOSITE OVERWRAP

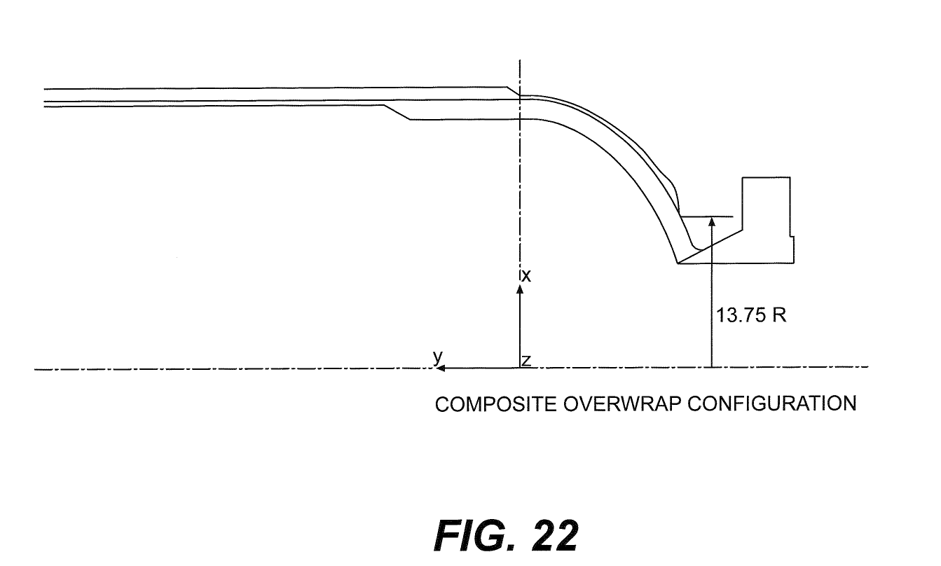

The composite design is described in FIG. 22 and Table 5.1. The composite overwrap thickness is 80% hoop plies and 20% helical layers in certain embodiments. The helical layers were needed to prevent uncontrolled axial yielding during a burst test. The helical layers were designed with a 4.0 inch pullback from the boss neck with a 340 wind angel to prevent the band from interfering with the welding neck flange during winding. A bulk factor of 1.7 (fiber volume=58.8%) was assumed in the thickness calculations. The total thickness is 1.05 inch and the OD is 50.1 inch. The weights and internal volume are summarized in Table 5.2. The total weight of the overwrapped pipe is 38,417 lb and the internal volume is 1044.4 ft³. The vessel dimensional changes are shown for each of the analysis conditions in Table 5.3.

TABLE 5.1
48 Inch Pipe Winding Sequence

| | | | | | | No. | | | | Total | | Pull- |
|---|---|---|---|---|---|---|---|---|---|---|---|---|
| | No. | No. | Wind | Bulk | Band | Circuits | No. Tows | No. Tows | Ply Thickness | Thickness | r_{OML}, inch | Back |
| Pattern | Layers | Plies | Angle, ° | Factor | Width, in. | per Layer | per Band | per in. | @ Equator, in. | @ Equator, in. | @ Cylinder | inch |
| H1 | 1 | 2 | 34.00 | 1.70 | 2.977 | 42 | 10 | 3.360 | 0.01526 | 0.0305 | 24.031 | 4.00 |
| Hp1 | | 9 | 88.80 | 1.70 | 3.257 | | 10 | 3.070 | 0.01395 | 0.1255 | 24.156 | |
| H2 | 1 | 2 | 34.00 | 1.70 | 2.977 | 42 | 10 | 3.360 | 0.01526 | 0.0305 | 24.187 | 4.00 |
| Hp2 | | 9 | 88.80 | 1.70 | 3.257 | | 10 | 3.070 | 0.01395 | 0.1255 | 24.312 | |
| H3 | 1 | 2 | 34.00 | 1.70 | 2.977 | 42 | 10 | 3.360 | 0.01526 | 0.0305 | 24.343 | 4.00 |
| Hp3 | | 9 | 88.80 | 1.70 | 3.257 | | 10 | 3.070 | 0.01395 | 0.1255 | 24.468 | |
| H4 | 1 | 2 | 34.00 | 1.70 | 2.977 | 42 | 10 | 3.360 | 0.01526 | 0.0305 | 24.499 | 4.00 |
| Hp4 | | 9 | 88.80 | 1.70 | 3.257 | | 10 | 3.070 | 0.01395 | 0.1255 | 24.624 | |
| H5 | 1 | 2 | 34.00 | 1.70 | 2.977 | 42 | 10 | 3.360 | 0.01526 | 0.0305 | 24.655 | 4.00 |
| Hp5 | | 8 | 88.80 | 1.70 | 3.257 | | 10 | 3.070 | 0.01395 | 0.1116 | 24.766 | |
| H6 | 1 | 2 | 34.00 | 1.70 | 2.977 | 42 | 10 | 3.360 | 0.01526 | 0.0305 | 24.797 | 4.00 |
| Hp6 | | 8 | 88.80 | 1.70 | 3.257 | | 10 | 3.070 | 0.01395 | 0.1116 | 24.908 | |
| H7 | 1 | 2 | 34.00 | 1.70 | 2.977 | 42 | 10 | 3.360 | 0.01526 | 0.0305 | 24.939 | 4.00 |
| Hp7 | | 8 | 88.80 | 1.70 | 3.257 | | 10 | 3.070 | 0.01395 | 0.1116 | 25.050 | |
| Helical | 7 | 14 | | | | 294 | | | | 0.2136 | | |
| Hoop | | 60 | | | | | 10 | 3.070 | | 0.8367 | | |
| Total | 1 | 11 | | | | | | | | 1.0504 | 25.050 | |

* Fiber = E-Glass, 113 Yield (yd/lb)
* E-Glass Area/Tow = 2.67E−03 in²
* Hx = Helical Layer Sequence, Hpx = Hoop ply sequence
* One Helical layer = one pair of ±34° plies
* Inside Diameter for analysis = 48.00 in.
* NO. CIRCUITS PER LAYER ARE MINIMUM, MAY BE EXCEEDED.
* Pull-Back = Outer layer surface distance from boss
* The actual pullback schedule may be refined/revised during 1st vessel winding

TABLE 5.2
48 Inch Pipe Weight and Volume

| | | | Internal |
|---|---|---|---|
| Component | Quantity | Weight, lb | Volume, ft³ |
| 80 ft Steel Cylinder | 1 | 20772 | 1005.3 |
| End Cap | 2 | 1863 | 36.4 |
| Welding Neck Flange | 2 | 4279 | 2.7 |
| Total Steel | | 26915 | 1044.4 |
| Cylinder E-Glass Composite | 1 | 11385 | |
| Dome E-Glass Composite | 2 | 117 | |
| Total Composite | | 11502 | |
| Total | | 38417 | |

TABLE 5.3
48 Inch Overall Deformation & Volume

| Pressure | Temperature | OAL, | OD, | ID, | |
|---|---|---|---|---|---|
| psi | ° F. | inch | inch | inch | Vol, ft³ |
| 0 | 70 | 1033.0 | 50.100 | 47.00 | 1044.4 |
| 3240 | 70 | 1034.5 | 50.371 | 47.27 | 1058.1 |
| 0 | 70 | 1033.7 | 50.211 | 47.11 | 1050.0 |
| 2160 | 70 | 1034.3 | 50.318 | 47.22 | 1055.4 |
| 2160 | −60 | 1033.7 | 50.285 | 47.18 | 1053.3 |
| 0 | 70 | 1033.7 | 50.211 | 47.11 | 1050.0 |
| 25 | −260 | 1032.0 | 50.114 | 47.01 | 1044.0 |
| 0 | 70 | 1033.7 | 50.163 | 47.06 | 1047.9 |
| 6480 | 70 | 1041.4 | 51.023 | 47.92 | 1094.6 |

5.1. Basic Cylinder Analysis

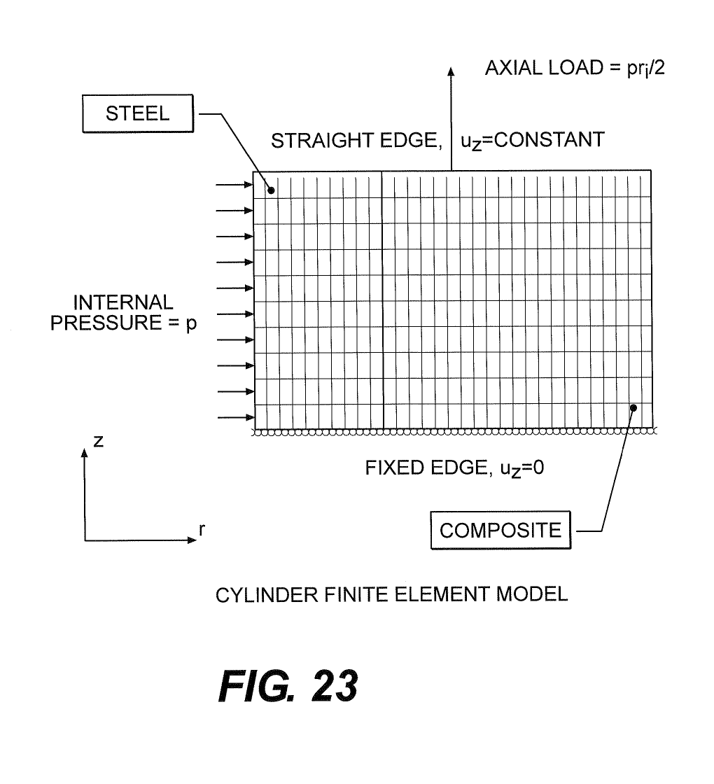

A simple finite element model of a section of the cylinder was used to evaluate the design for the cylinder remote from the cylinder/end cap joints. The model is illustrated in FIG. 23 and was analyzed with geometric and material nonlinear analysis using the load sequence from FIG. 15.

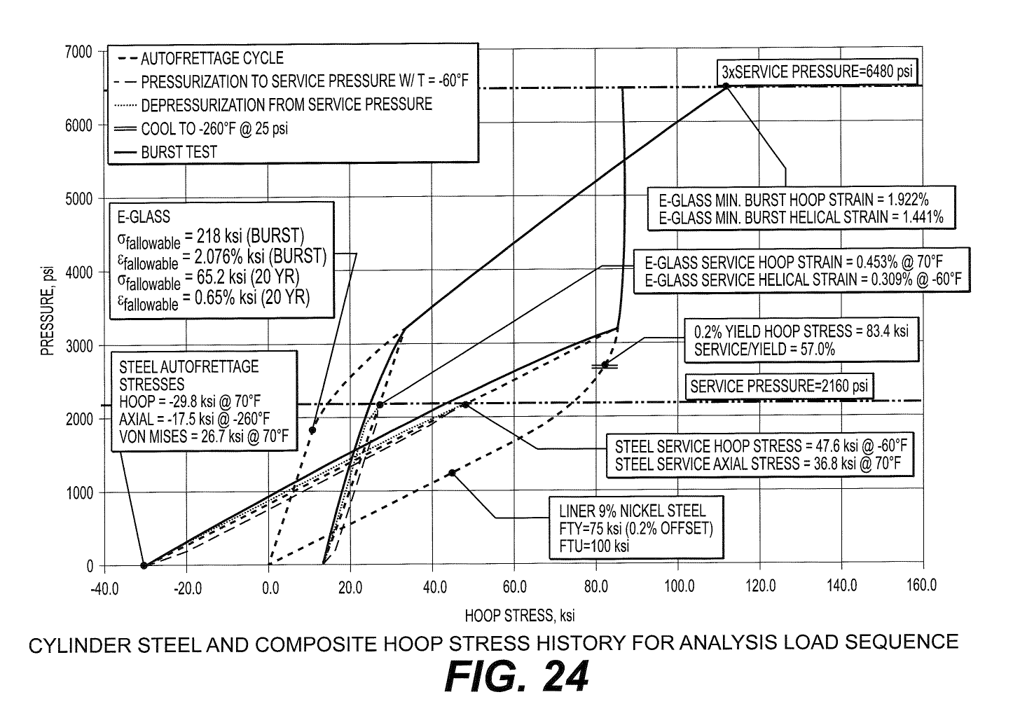

The hoop stress history results are shown in FIG. 24 for the maximum stress locations in the steel and composite. The portions of the curves representing the autofrettage cycle, high pressure and low temperature service cycles and the design burst test are represented by the colors indicted in the legend. The portions of the curves that overlap each other where the steel is elastic are offset for visual purposes.

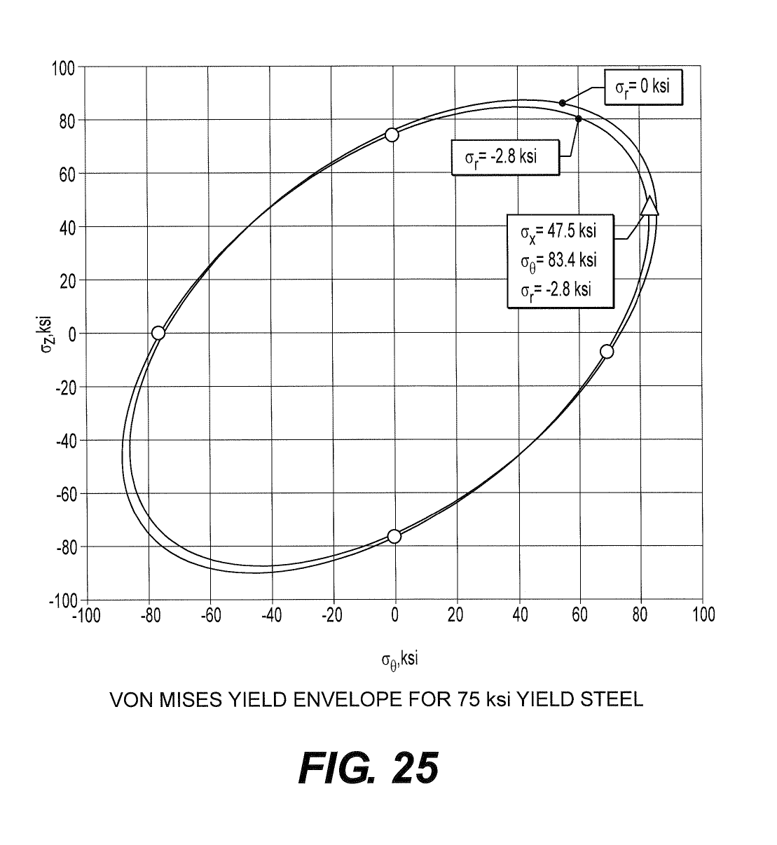

Both curves start out linear with zero pressure and stress. The steel reaches the Von Mises 0.2% offset yield point at a pressure of 2847 psi and a hoop stress of 83.4 ksi. The hoop stress at yield is higher than the unidirectional yield strength due to the triaxial stress state. The Von Mises yield envelope is shown in FIG. 25.

The steel continues to deform plastically up to the autofrettage pressure of 3240 psi. The maximum axial and hoop stresses at the autofrettage pressure are 59.5 and 85.5 ksi. The corresponding maximum hoop and helical fiber strains are 0.5655% and 0.3320%.

The steel follows the elastic curve during depressurization, parallel to the linear portion of the pressurization curve. The maximum unpressurized residual axial and hoop stresses in the steel after autofrettage are −7.8 and −29.8 ksi. The corresponding unpressurized hoop and helical fiber strains are 0.2309% and 0.1397%.

The steel operates in the elastic range at less than 57% of the yield stress state for all service conditions. The maximum service hoop strain is 0.4533% at 2160 psi and 70° F. The maximum service helical fiber strain is 0.3086% at −60° F. The hoop strain is 21.8% of the ultimate allowable and FIG. 19 indicates a sustained load life of well over 100 years for the most severe service conditions.

The steel reaches 87.0 ksi in the hoop direction at the design burst pressure, 87% of the ultimate strength. The maximum hoop and helical fiber strains are 1.922% and 1.4409%. The hoop strain is 92.6% of the hoop strain allowable. So, the predicted burst failure mode in the cylinder is hoop fiber failure at a pressure of 7000 psi.

5.2. Cylinder/Cap Joint Analysis

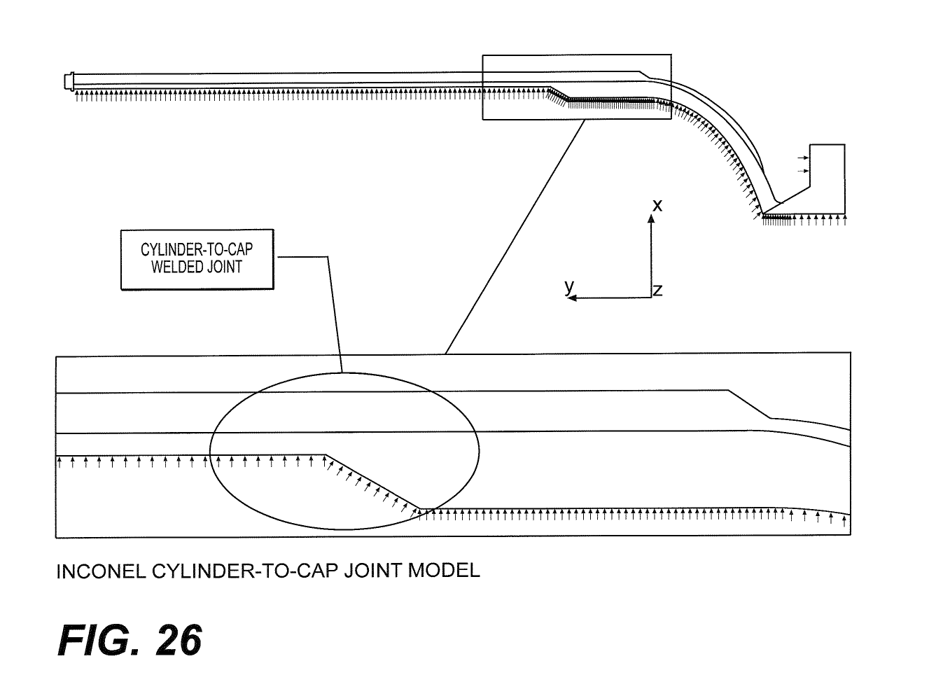

A more detailed finite element model was developed to evaluate the cylinder-to-cap welded joint and associated composite overwrap. The model is illustrated in FIG. 26 and was analyzed with geometric and material nonlinear analysis using the load sequence from FIG. 15. The model includes the dome and welding neck flange geometry and a coarse representation of the dome composite. A single composite property was used in the cylinder to represent the 20%±34° helical and 80% hoop laminate. Each dome element has a unique property set representing the local helical angle range. The methods of Ref. 6 were used to calculate the laminate properties.

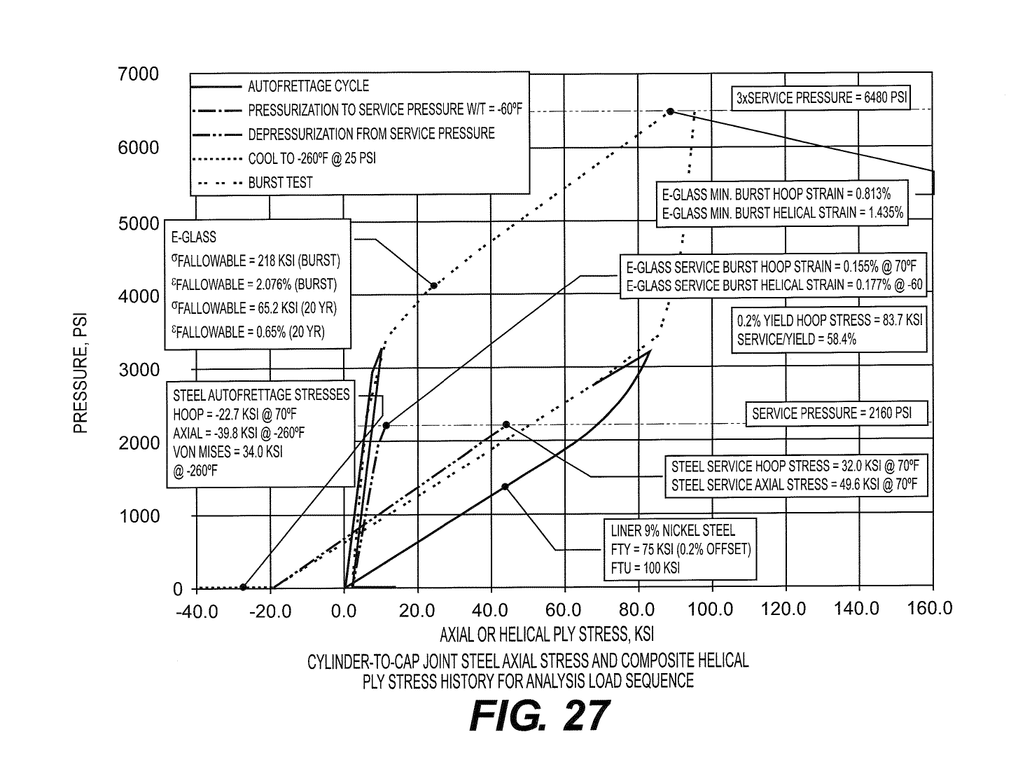

The axial steel stress and helical ply stress history results are shown in FIG. 27 for the maximum stress locations in the steel and composite. The portions of the curves representing the autofrettage cycle, high pressure and low temperature service cycles and the design burst test are represented by the colors indicted in the legend. The portions of the curves that overlap each other where the steel is elastic are offset for visual purposes. Both curves start out linear with zero pressure and stress. The steel reaches the Von Mises 0.2% offset yield point at a pressure of 3236 psi and an axial stress of 83.7 ksi. This pressure is just below the autofrettage pressure. As before, the axial stress at yield is higher than the unidirectional yield strength due to the triaxial stress state.

The steel continues to deform plastically up to the autofrettage pressure of 3240 psi. The maximum axial and hoop stresses at the autofrettage pressure are 59.3 and 85.7 ksi. The corresponding maximum hoop and helical fiber strains are 0.1988% and 0.1467%.

The steel follows the elastic curve during depressurization, parallel to the linear portion of the pressurization curve. The maximum unpressurized residual axial and hoop stresses in the steel after autofrettage are −19.3 and −22.7 ksi. The corresponding unpressurized hoop and helical fiber strains are 0.0289% and 0.0275%.

The steel operates in the elastic range at less than 58.4% of the yield stress state for all service conditions. The maximum service hoop strain is 0.1553% at 2160 psi and 70° F. The maximum service helical fiber strain is 0.2131% at −260° F. The helical strain is 10.38% of the ultimate allowable and FIG. 19 indicates a sustained load life of well over 100 years for the most severe service condition.

The steel reaches 95.6 ksi in the axial direction at the design burst pressure, 95.6% of the ultimate strength. The maximum hoop and helical fiber strains are 0.8132% and 1.4350%. The helical strain is 69.1% of the hoop strain allowable. So, the predicted burst failure mode in the cylinder-to-cap joint is ultimate steel failure at a pressure of 6778 psi.

5.3. Steel Shell Fatigue

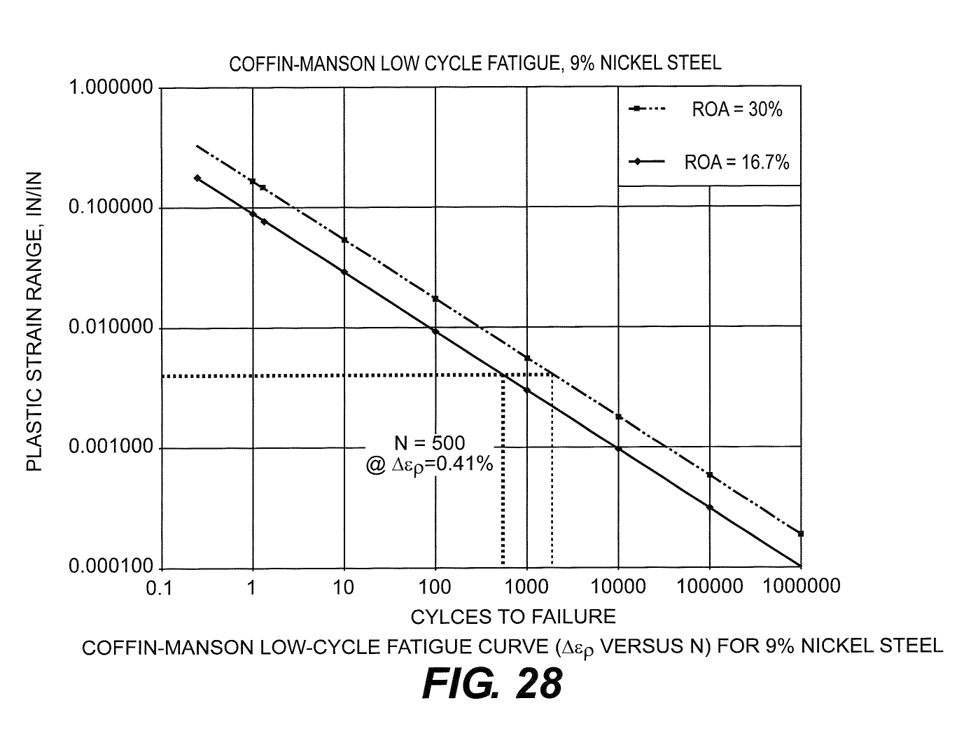

The low-cycle fatigue curve for 9% nickel steel is shown in FIG. 28. This curve was calculated based on the Coffin-Manson law which states that the fatigue life when cycled in the plastic strain range is simply a function of the reduction in area at failure (ROA) of the metal and the plastic strain range (Δεₚ) which occurs during one cycle (Ref. 7):

$$N = \frac{1}{2 {Δɛ}_{p}} ln ( \frac{1}{1 - ROA} ) .$$

Only the ultimate elongation (20%) for 9% nickel steel is given in Ref. 1. A lower bound for the ROA can be calculated from the ultimate elongation by:

$$ROA = \frac{e}{1 + e} = \frac{0.2}{1 + 0.2} = 16 \text{.} 7 \%$$

where “e” is the ultimate elongation. This is conservative since the elongation is averaged over a test length and ROA is measured at the fracture. The elongation at the fracture may be more than twice as high as the average and the ROA could be twice as high. The low cycle fatigue is shown for ROA's of 16.7% and 30% in the figure.

The figure shows that the allowable plastic strains per cycle for a 500 cycle life is 0.41%. At the same plastic strain level, the cycle life is about 2000 cycles if the ROA is 30%. Also, the cycle life for a cyclic plastic strain range of 0.1% is about 10,000 cycles. The steel shell does not yield at all during service, so the fatigue life will be much more than 10,000 cycles.

5.0 Conclusion

The analysis shows that the minimum predicted burst pressure for the vessel is 6,778 psi with an axial stress failure mode in the cylinder-to-cap weld joint. This pressure exceeds the design minimum burst pressure of 6,480 psi. The analytical low cycle fatigue life of the liner exceeds the needs for one autofrettage cycle, five hundred high pressure operating cycles and five hundred low temperature cycles by more than a factor of ten, while using conservative assumptions.

The composite safety margins are high at service conditions because load sharing 9% nickel steel cylinder operates in the elastic range and carries a large share of the load due to its stiffness. The composite carries a higher share of the pressure at the burst condition because the shell stress is nearly constant once yielding begins. The composite failure pressure is 7000 psi, only 3.3% greater than the predicted steel shell failure pressure.

MDPE-Lined Composite Tank Design

### 1. INTRODUCTION

This report summarizes the design and analysis of a 42 inch diameter filament wound pressure vessel. The pressure vessel uses a rotational molded Medium Density Polyethylene (MDPE) liner and is filament wound with Carbon/epoxy composite. The tank was designed for a design burst factor of safety of 4.0.

The basic dimensional constraints are a 42.0 inch liner inside diameter and a 196 inch overall boss-to-boss length.

The liner has two areas of medium risk. The liner functions as a gasket for the closure seal and extrusion of the liner at the edges due to transverse compression is a concern. The design minimizes this concern by containing the potential extrusion. Also, there is an area of inherently high liner strain at the outer edge of the polar fitting flange.

### 2. PREFERRED EMBODIMENTS

The tank preferred specifications are defined in Table 2.1. The tank contains inert gas. The pressure vessel liner material is MDPE with integral A286 stainless steel end fittings. The internal tank diameter (42.0 inch) is specified and the external diameter is a result of the structural thickness requirements. The preferred service pressure and temperature is 3600 psi at −50° F. The preferred ultimate burst factor is 14,400 psi (4.0×Operating Pressure). Although this factor is used for the composite, it is also preferred on the MDPE and metal components.

TABLE 2.1
42 Inch Diameter Tank Preferred Specifications

Dimensions
Liner ID = 42.0 Inch
Overall Length (Boss-to-Boss) = 192 inch
Ports = ˜5.0 ID
Materials
Liner: MDPE (Nova Chemical RMs-539-U, Ref. 1)
Polar Hardware: A286 Stainless Steel (Ref. 2, 3)
Filament Wound Composite
Grafil MR60-H 24K Carbon Fiber
CTD-525 Resin
Loads
Operating Pressure = 3600 psi (Inert Gas)
Minimum Burst Pressure = 14400 psig (FS = 4.0)
Cycles: 500 Cycles; 0-3600 psig @ −50° F. w/ 1-2 Week Hold

### 3. MATERIALS

Grafil® MR60H, 24K Carbon Roving is used for this pressure vessel. This roving was chosen to for its high tow density to maximize the winding bandwidth and minimize thickness problems in the polar region near the fittings. In this embodiment, the winding machine is limited to 24 tows. The tow has the following properties per the Grafil® datasheet:
6. Tow cross sectional area, CSA=7.20E-4 in²/tow.
7. Fiber modulus, E_{f}=42.0 msi.
8. Fiber density, ρ_{f}=0.065 lb/in³.
9. Impregnated strand tensile strength=810 ksi.

The epoxy resin selected for this pressure vessel development is CTD-525 resin.

The estimated composite B-Basis strength properties in Table 3.1 were used for the design of this pressure vessel. The room temperature dry mean fiber tension allowable is 70% of the typical strand tensile strength from the Grafil® data sheet. This is a conservative estimate based on experience with other Grafil® fibers. The A-Basis and B-Basis tension allowables are calculated from the mean values by applying typical statistical reduction factors. The remaining compression and interlaminar shear values are typical values used for other carbon fiber and resin systems. The tension properties for pressure vessel design are of primary importance and compression does not exist. A similar fiber/resin combination was qualified for use on a pressure vessel for the Comanche helicopter for Hamilton-Sundstrand.

TABLE 3.1
Estimated MR60H Fiber and Ply Allowables

| | Mean | B-Basis | A-Basis |
|---|---|---|---|
| Property | ksi | ksi | ksi |
| Room Temperature, Dry | | | |
| Fiber Tension, ksi | 566 | 532 | 509 |
| Fiber Tension, μin/in | 13476 | 12673 | 12122 |
| Uni-Ply Tension, ksi | 340 | 319 | 305 |
| Uni-Ply Compression, ksi | 221 | 204 | 192 |
| Interlaminar Shear, ksi | 15.8 | 14.6 | 13.8 |
| Room Temperature, Wet | | | |
| Fiber Tension, ksi | 509 | 479 | 458 |
| Fiber Tension, μin/in | 12128 | 11406 | 10910 |
| Uni-Ply Tension, ksi | 306 | 287 | 275 |
| Uni-Ply Compression, ksi | 188 | 175 | 164 |
| Interlaminar Shear, ksi | 13.4 | 12.4 | 11.7 |
| 250° F., Wet | | | |
| Fiber Tension, ksi | 453 | 426 | 407 |
| Fiber Tension, μin/in | 10782 | 10138 | 9699 |
| Uni-Ply Tension, ksi | 272 | 255 | 244 |
| Uni-Ply Compression, ksi | 166 | 153 | 144 |
| Interlaminar Shear, ksi | 11.8 | 10.9 | 10.3 |

Note:
Uni-ply properties normalized for 60% fiber volume. Fiber tension based on 100% fiber volume.

The MDPE liner material does not contribute significantly to the structure, but was included in the FEA to assess the survivability of the liner. Material properties for Nova Chemical's rotational molding resin RMs244 U/UG were used. The properties were derived from the product datasheet. A simple bilinear stress strain curve was used with the following modulus, yield strength and tangent modulus:
E=137,800 psi
σ_{yld}=3200 psi
Eₜₐₙ=10,800 psi.

The specified alloy for the polar fittings is A286 Stainless steel. The properties for this steel used are shown in Table 3.2. The properties for the aged condition were used, although the solution is sufficient with some redesign.

TABLE 3.2
A286 Stainless Steel Properties

| | Solution | |
|---|---|---|
| Condition | Treated | Aged |
| E, msi | 29.1 | 29.1 |
| ν | 0.30 | 0.30 |
| FTY, ksi | 40.0 | 115.0 |
| FTU, ksi | 90.0 | 148.0 |
| e_{yld}, % | 0.14 | 0.40 |
| eᵤₗₜ, % | 40.00 | 24.90 |
| Eₜₐₙ, msi (Estimated) | 0.125 | 0.135 |
| ρ, lbₘ/in³ | 0.286 | 0.287 |

Data per Technical Data BLUE SHEET, Allegheny Ludlum Corporation u Pittsburgh, Altemp ® A286 Iron-Base Superalloy (UNS Designation S66286)

HNBR rubber is used as a shear ply material between the composite and steel polar fitting. Typical properties used in the analysis are shown in Table 3.3.

TABLE 3.3
Typical HNBR Rubber Properties

| Property | Value |
|---|---|
| Tensile Strength, psi | 4350 |
| Abrasion Resistance, Akron Type Index | 180 |
| Continuous Service Temperature, ° C. (1000 hrs) | 160 |
| Elongation, percent | 520 |

### 4. PRESSURE VESSEL DESIGN

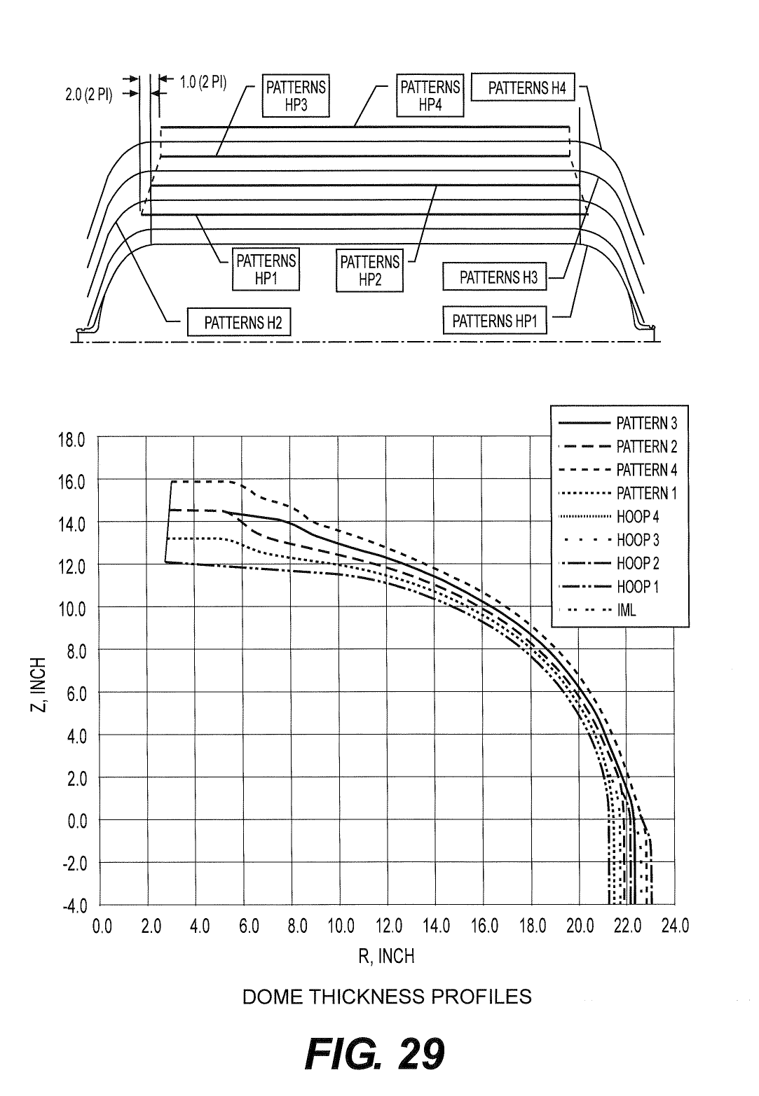

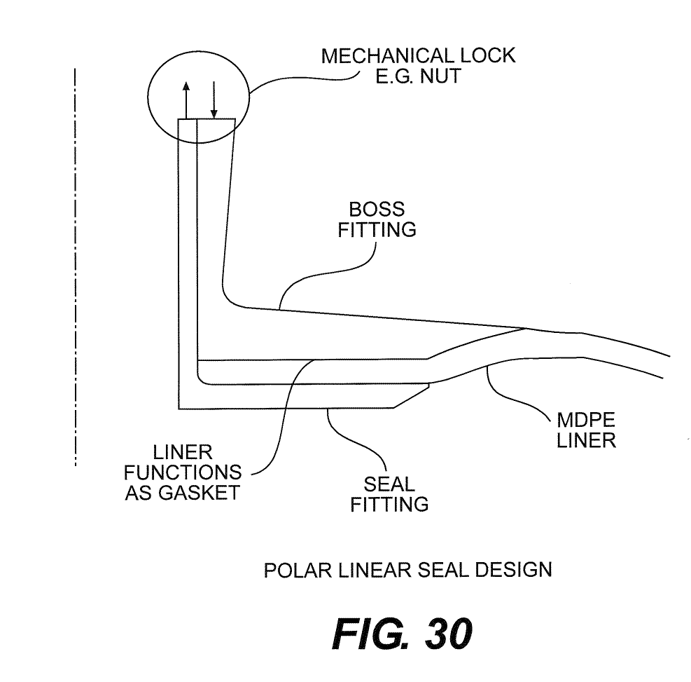

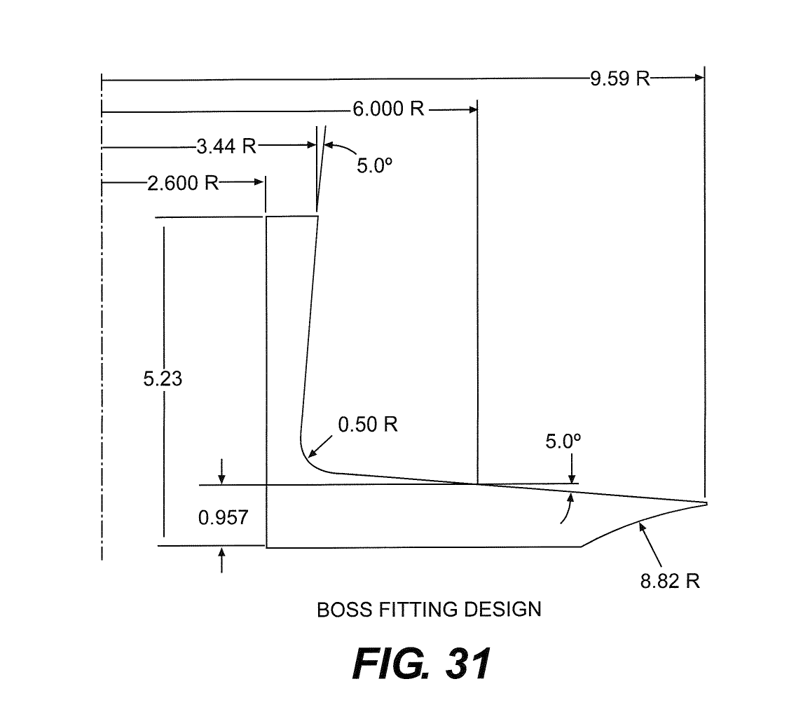

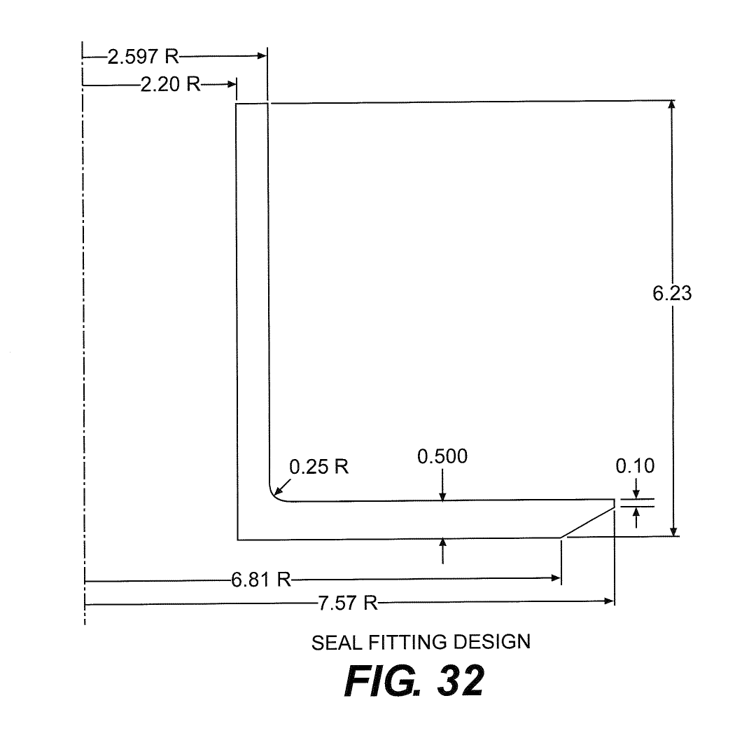

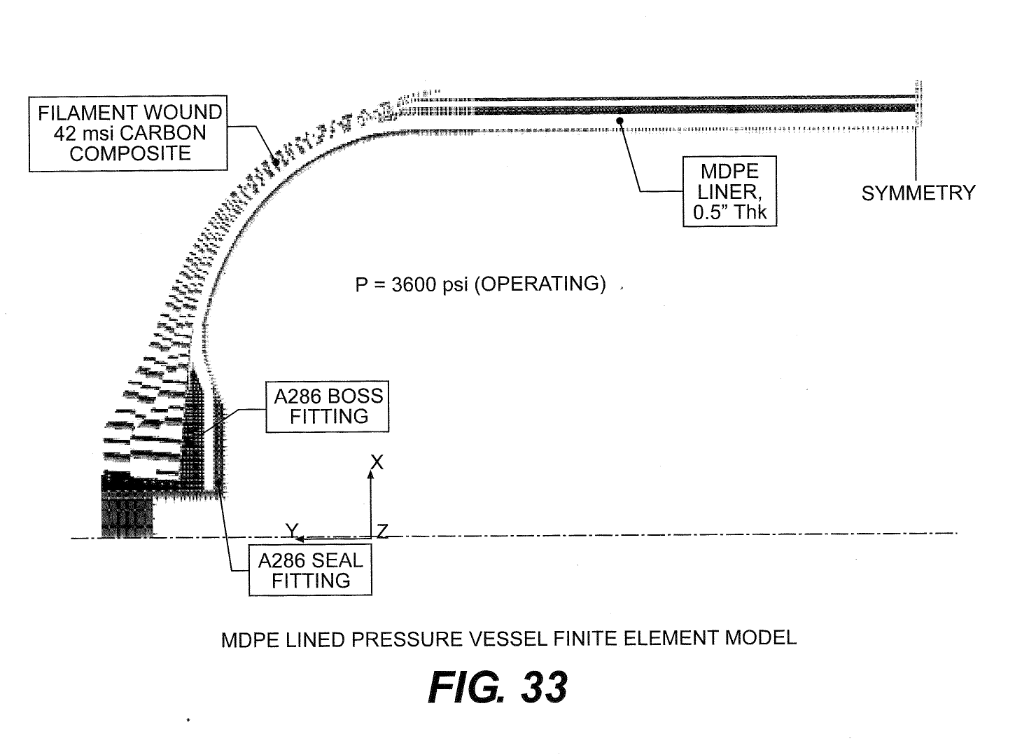

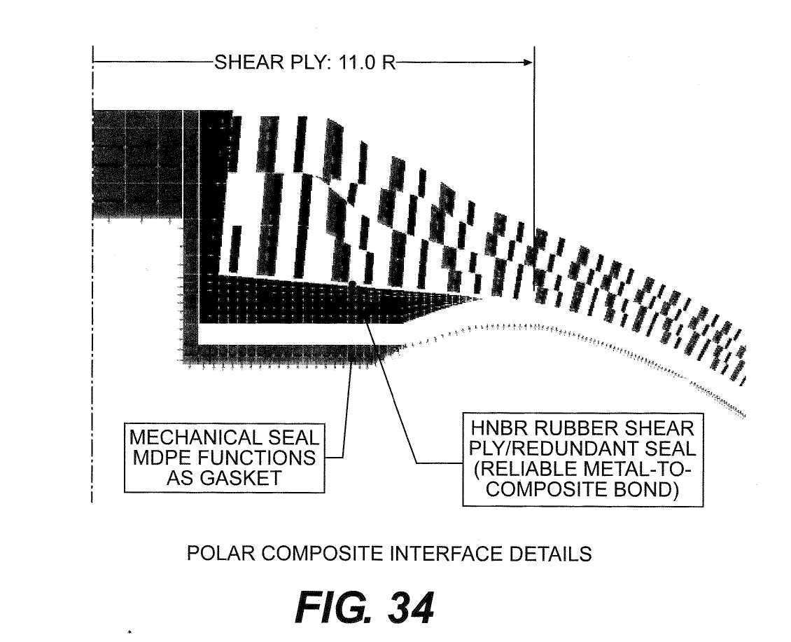

The winding schedule in Table 4.1 describes the preferred details of the composite fabrication. It is important to accurately predict the composite thicknesses, fiber angles, and material properties in order to properly model the pressure vessel dome. The fiber angles at a point in the dome are not unique and vary over a range of values. The presentation in Appendix A describes the approach to this problem used in this analysis. The liner outer surface coordinates are tabulated in Appendix B. The thickness profiles used in the finite element analysis are shown in FIG. 29. The weight and performance of the design is summarized in Table 4.2. The details of the polar composite construction are illustrated in FIG. 30. The assembly consists of the filament wound composite, an HNBR rubber shear ply, two steel fittings (boss fitting and seal fitting) and the MDPE liner. The details of the fitting designs are shown in FIGS. 31 and 32. The composite is separated from the steel fitting by a 0.08 inch thick HNBR rubber shear ply. The rubber shear ply is used to isolate the stainless steel fitting from the wound composite to prevent large interface shear stresses that would otherwise develop. The FEA showed that adhesive bond stresses would be extremely high if a bonded approach were used. The MDPE liner is assumed to be bonded to the internal surfaces of the composite, shear ply and boss fitting. The seal fitting is unbonded to the liner and boss fitting and will initially clamp the liner against the inner surface of the boss fitting by some mechanism such as a nut that bears against the boss face and threads onto the external surface of the seal fitting. This interface has not been designed due to the nature of the opening design. The MDPE liner is clamped between the internal steel closure plate and the steel polar fitting. The polyethylene functions as a gasket seal. The polyethylene is exposed to a clamping pressure of about 330 psi when the tank is pressurized to the operating pressure. This pressure is selectively increased by reducing the diameter of the seal fitting if necessary. The simplicity of the design has significant advantages over other approaches considered. The weight, volume and performance of the design are summarized in Table 4.2.

TABLE 4.1
Tank Filament Winding Schedule

| | | | | | | No. | | | | Total | | Pull- |
|---|---|---|---|---|---|---|---|---|---|---|---|---|
| | No. | No. | Wind | Bulk | Band | Circuits | No. Tows | No. Tows | Ply Thickness | Thickness | r_{OML}, inch | Back, |
| Pattern | Layers | Plies | Angle, ° | Factor | Width, in. | per Layer | per Band | per in. | @ Equator, in. | @ Equator, in. | @ Equator | inch |
| H1 | 7.0 | 14 | 10.60 | 1.80 | 2.187 | 60 | 24 | 10.972 | 0.01422 | 0.1991 | 21.449 | 0.00 |
| Hp1 | 8.0 | 16 | 89.00 | 1.65 | | | 1 | 12.710 | 0.01510 | 0.2416 | 21.691 | |
| H2 | 7.0 | 14 | 10.60 | 1.80 | 2.208 | 60 | 24 | 10.870 | 0.01409 | 0.1972 | 21.888 | 0.00 |
| Hp2 | 8.0 | 16 | 89.00 | 1.65 | | | 1 | 12.710 | 0.01510 | 0.2416 | 22.129 | |
| H3 | 7.0 | 14 | 10.60 | 1.80 | 2.253 | 60 | 24 | 10.653 | 0.01381 | 0.1933 | 22.323 | 2.21 |
| Hp3 | 8.0 | 16 | 89.00 | 1.65 | | | 1 | 12.710 | 0.01510 | 0.2416 | 22.564 | |
| H4 | 8.0 | 16 | 10.60 | 1.80 | 2.298 | 60 | 24 | 10.445 | 0.01354 | 0.2166 | 22.781 | 0.00 |
| Hp4 | 8.5 | 17 | 89.00 | 1.65 | | | 1 | 12.710 | 0.01510 | 0.2567 | 23.038 | |
| Helical | 29 | 58 | 10.60 | 1.80 | | 1260 | | | | 0.8062 | 22.323 | |
| Hoop | 33 | 65 | 65.72 | 1.65 | | | 1 | 12.710 | | 0.9815 | 22.564 | |
| Total | 62 | 123 | | | | | | | | 1.7876 | 22.564 | |

* Fiber = MR60H, 24K
* MR60H Area/Tow = 7.20E−04 in²
* MR60 Fiber Strength = 530.00
* Inside Diameter for analysis = 42.50 in.
* NO. CIRCUITS PER LAYER ARE MINIMUM, MAY BE EXCEEDED.
* Pull-Back = Outer layer surface distance from boss
* The actual pullback schedule may be refined/revised during 1st vessel winding

TABLE 4.2
MDPE Lined Pressure Vessel Weight Summary

| Component | Quantity | Weight, lb | % Total |
|---|---|---|---|
| Boss Fitting | 2 | 143.4 | 2.8 |
| Seal Fitting | 2 | 62.7 | 1.2 |
| MDPE Liner, 0.5 in. Thk | 1 | 442.0 | 8.6 |
| Helical Composite | 1 | 2,219.7 | 43.2 |
| Hoop Composite | 1 | 2,268.6 | 44.1 |
| HNBR Shear Ply | 2 | 2.1 | 0.0 |
| Total | | 5,138.6 | 100.0 |
| Volume, ft³ | | 142 | |
| Volume, in³ | | 244,685 | |
| Design Burst Pressure, psi | | 14,400 | |
| Design PV/W, in-lb/lb | | 685,686 | |
| Composite Only | | 784,661 | |

### 5. FINITE ELEMENT ANALYSIS

The composite was determined to be bonded to the liner over the entire interface. Normal pressure was applied to the entire internal surface. Material and geometric nonlinear analysis was used. Only half of the tank was modeled, with symmetric boundary conditions being used at the center of the tank. Pressure was applied to the internal surfaces as shown in FIG. 22. The distribution of material properties among the elements in the dome is illustrated in FIG. 22. Each element in the dome has a unique material property set to approximate the continuously varying dome properties. These properties were calculated using the methods of Reference 4.

FIG. 23 shows the details of the model in polar region. The composite is isolated from the fitting and liner by the HNBR rubber shear ply over the region shown. The analysis was run with these surfaces bonded, but the bond stresses between the composite and fitting were much higher than any adhesive capabilities. The shear ply was chosen to prevent wear between the surfaces and to provide a redundant seal. The MDPE liner is assumed to be bonded to the internal surface of the composite, shear ply and boss fitting. The seal fitting is unbonded and the interfaces between the liner and boss fitting are modeled as sliding surfaces.

5.1. Fitting Analysis

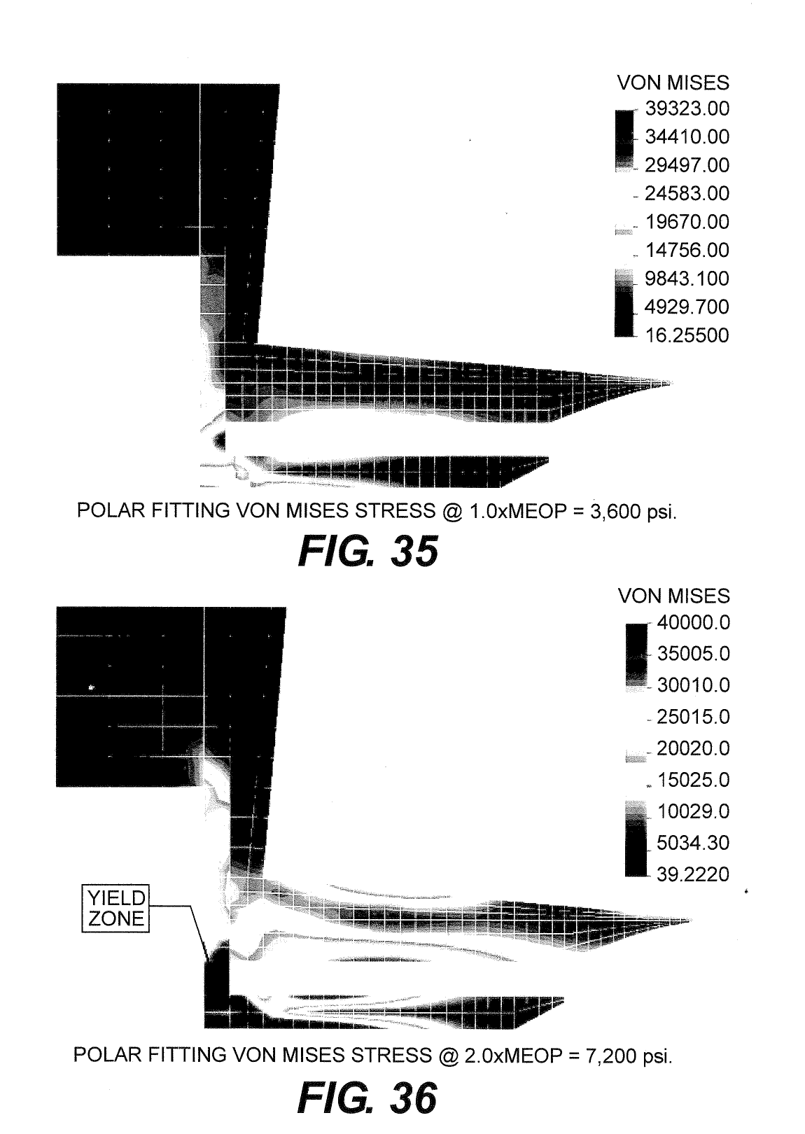

The Von Mises stresses for the baseline aged A286 stainless steel fitting are illustrated in FIGS. 35-37 for the maximum expected operating pressure (MEOP), 2.0×MEOP and the design burst pressure (4.0×MEOP).

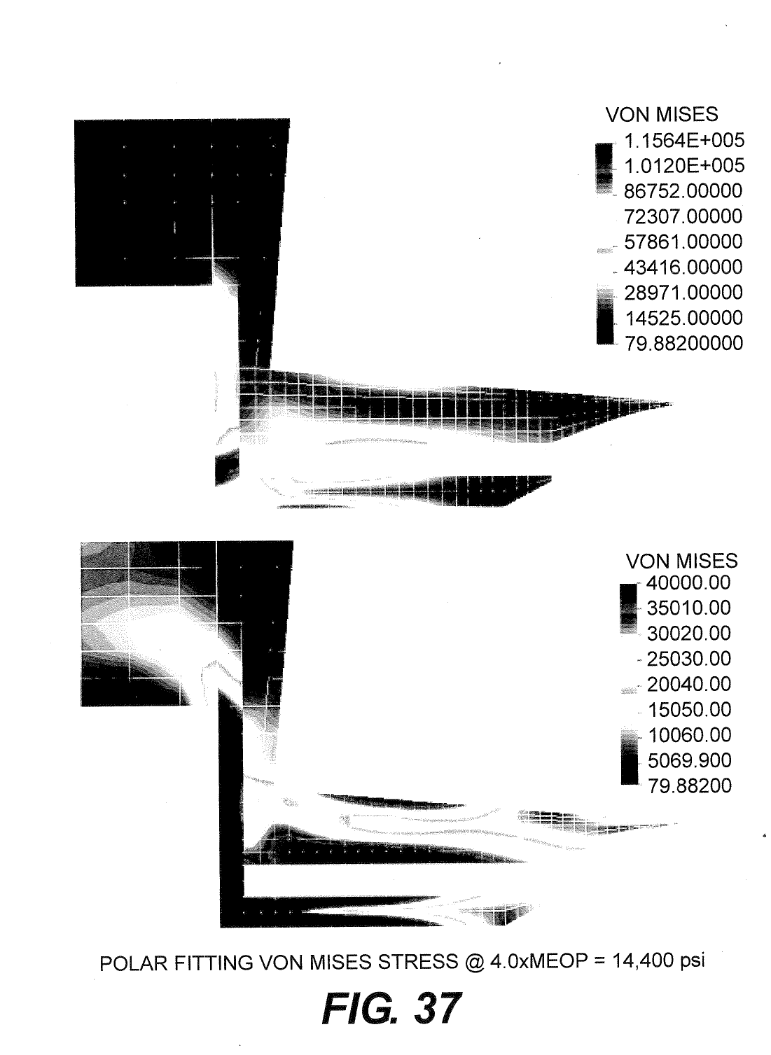

The stresses at the operating pressure in FIG. 35 are well below the aged A286 yield strength. They are also well below the unaged yield strength, except in the throat of the seal fitting where yielding is impending. There is a generous fillet in the fitting in this area and the maximum stresses will be lower. The proof pressure is less than 4700 psi, so the stresses shown in FIG. 36 are greater than any tank would experience. The upper value of the color scale in this figure was limited to the unaged yield strength (40 ksi) to show the yield zones at this pressure. The boss fitting is completely elastic. However, the seal fitting is well into the yield zone in the area shown. Although the steel strain hardens, the associated plastic strains may affect the performance of the fitting seal against the liner. FIG. 37 shows the fitting Von Mises stresses plotted with both the maximum stress and unaged yield stress as upper limits. This figure shows the aged A286 would not significantly yield at the burst pressure, but the unaged A286 significantly yielded in the seal fitting. The seal fitting was redesigned with a thicker throat and flange when the unaged A286 is selected. The boss fitting design is acceptable.

5.2. Liner Analysis

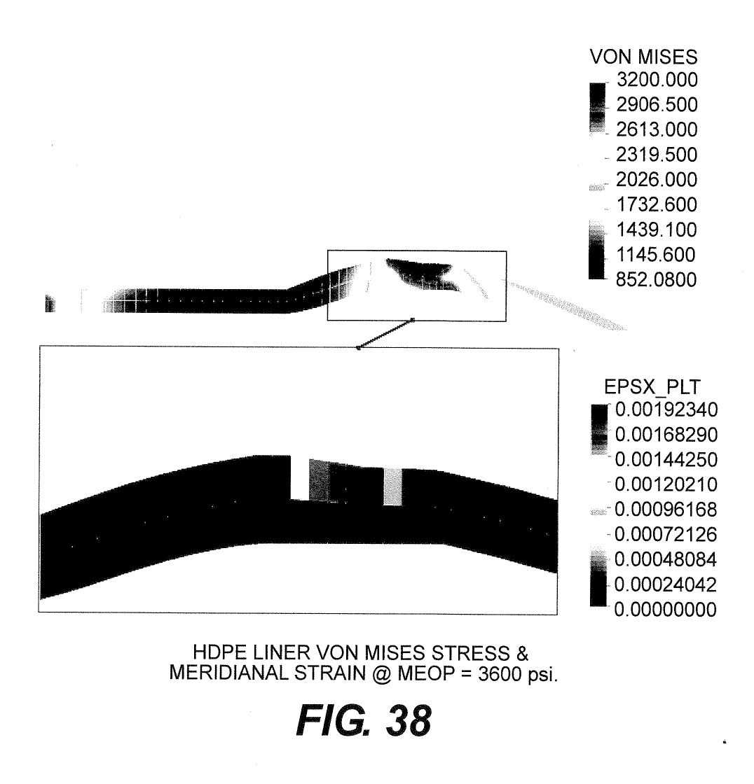

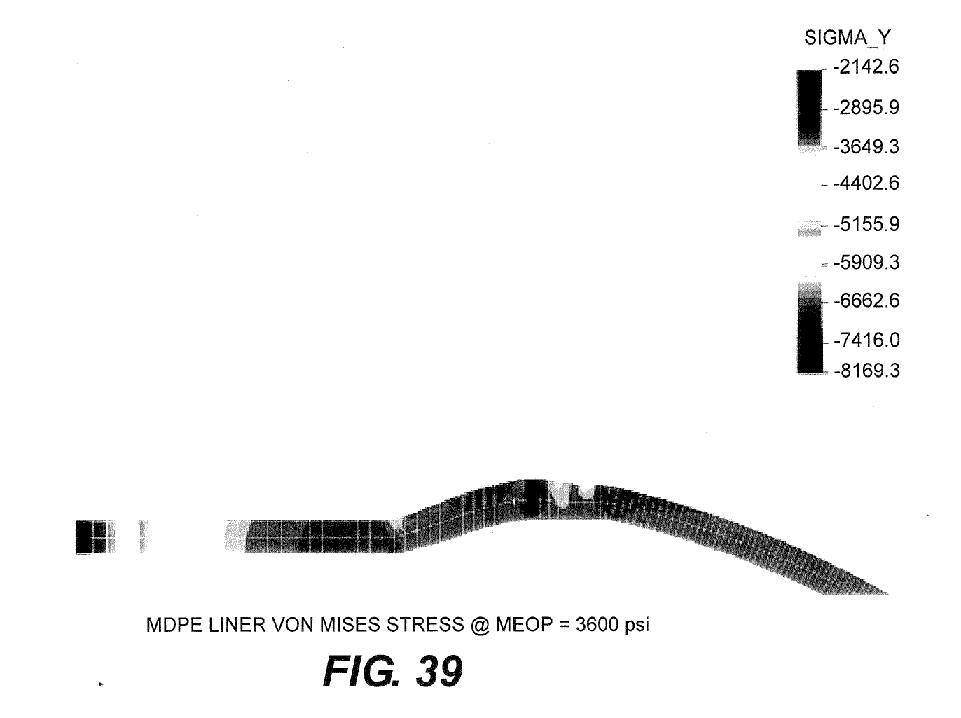

MDPE liner stresses are illustrated in FIGS. 38-39. FIG. 38 shows the Von Mises stress and plastic strain exceed the yield strength of the MDPE liner just outboard of the boss fitting flange. The rest of the liner is well below the yield strength. The maximum plastic strain is only 0.2%. The liner yields slightly in this area during a proof cycle and operates elastically for all service conditions due to the residual compressive stresses.

FIG. 39 shows the maximum compressive stress through the thickness is 8170 psi at the operating pressure in the area clamped between the two fittings. However, there is a high component of hydrostatic compression and yielding does not occur, as indicated by the Von Mises stress in FIG. 38.

5.3. Composite Analysis

5.3.1. Fiber Strain Analysis

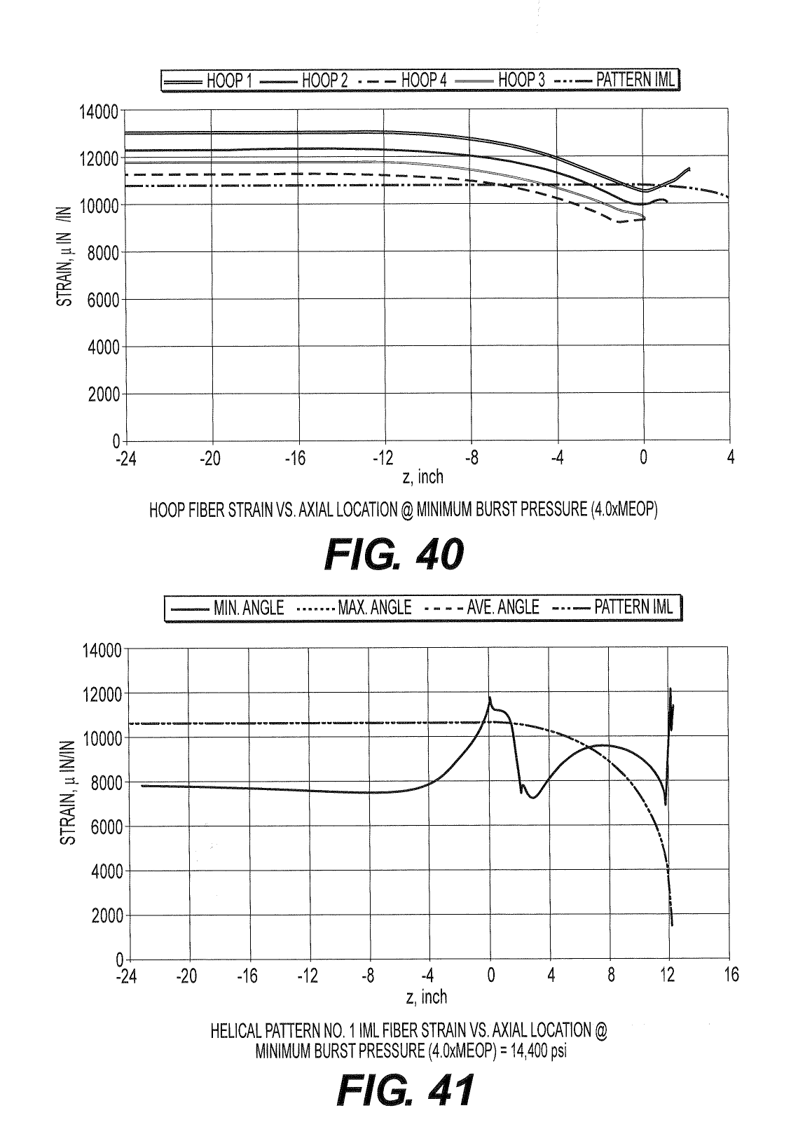

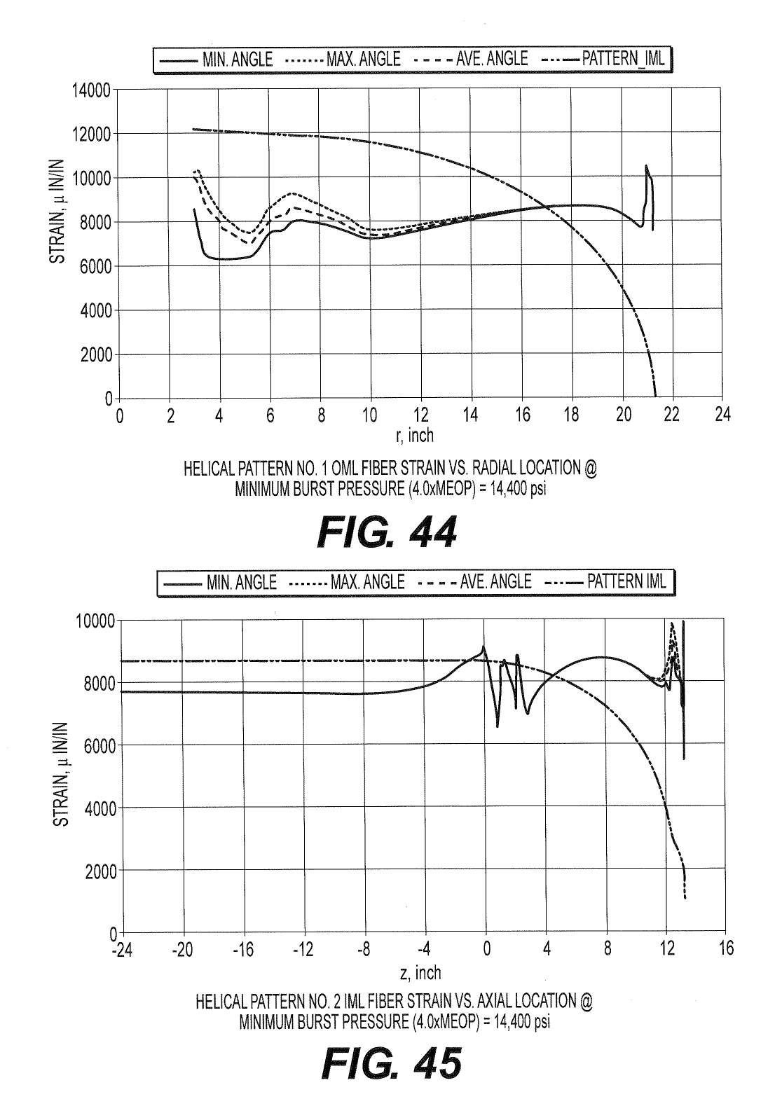

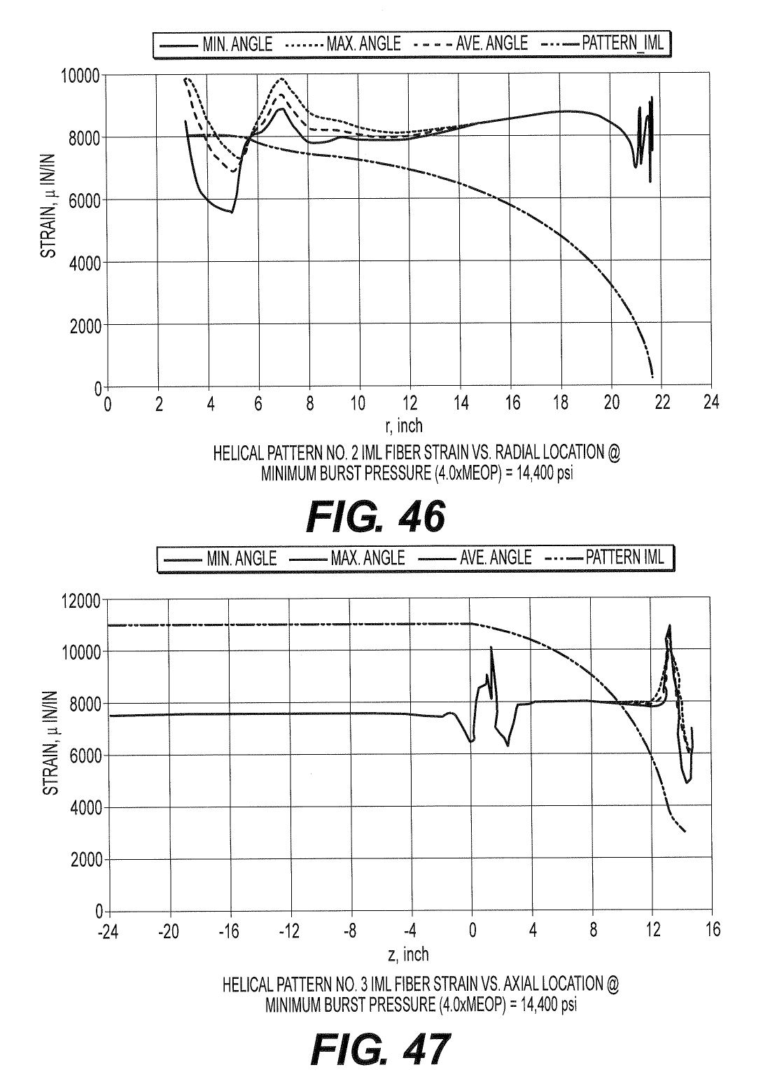

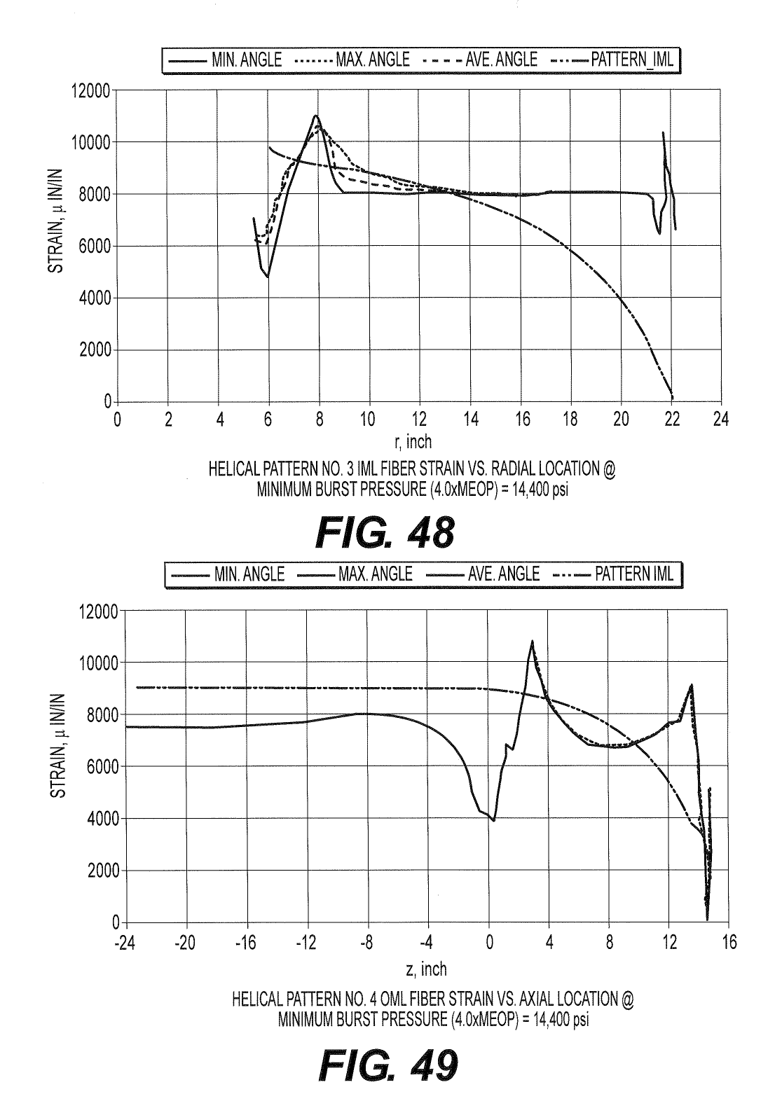

The critical quantities for dome performance are primarily the fiber stress or strain and secondarily the interlaminar shear stress. Fiber strain leads directly to ultimate failure while interlaminar shear failure degrades the fiber strength and can lead to premature fiber failure. The fiber strains, derived from the element stresses, are plotted in FIGS. 40-50 for the design burst condition, 14,400 psi. FIG. 40 illustrates the hoop fiber strain for the four interspersed hoop ply groups. The maximum hoop fiber strain occurs at the innermost ply (12630 μin/in @ 14,400 psi). The minimum margin of safety for hoop fiber failure is:

$${MS}_{Hoop} = \frac{12673 μ}{12630 μ} - 1 = + 0.003 .$$

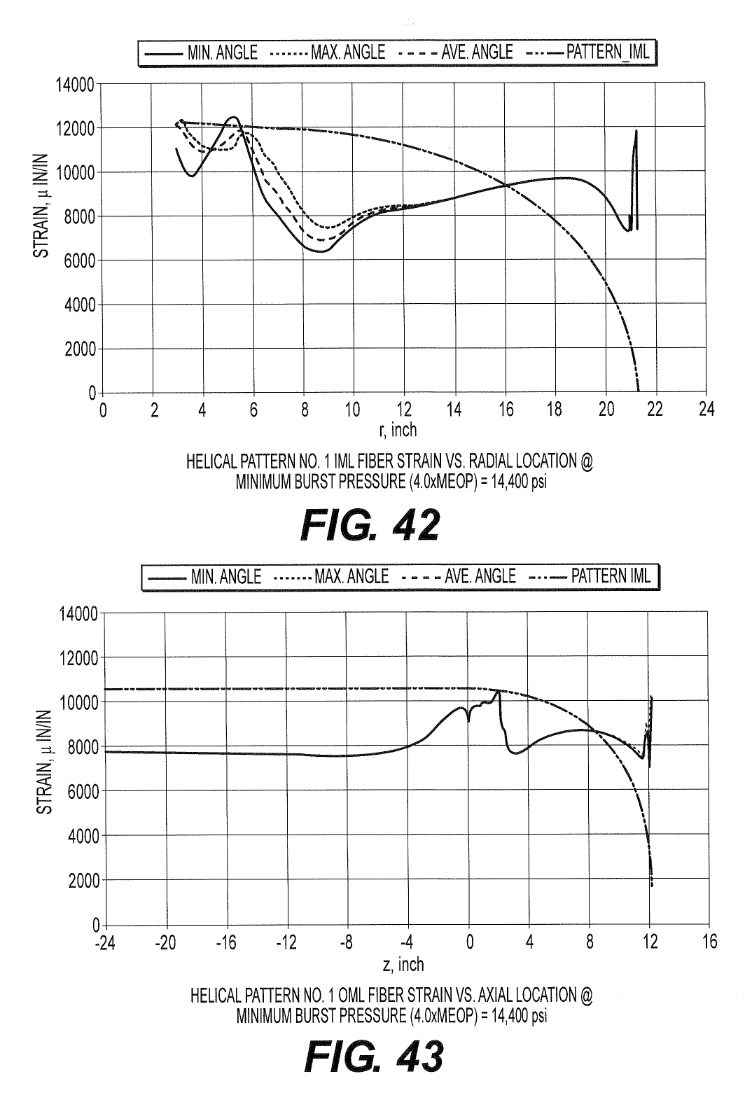

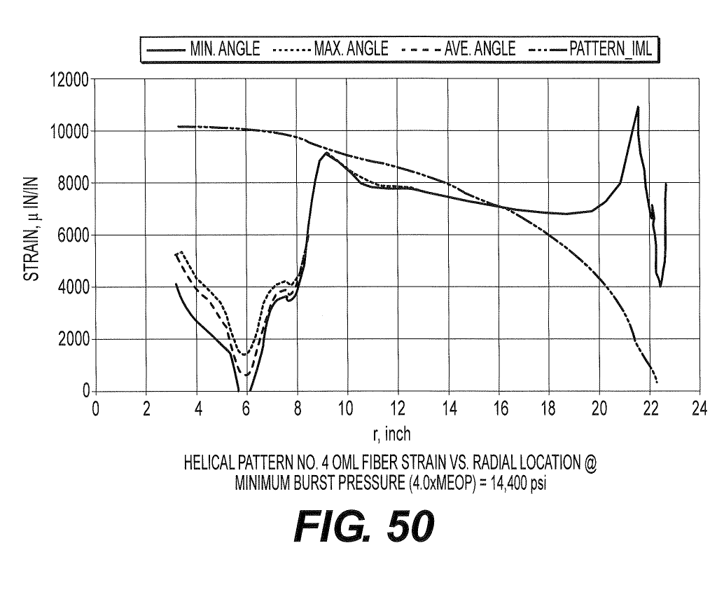

Hoop fiber failure was determined to occur at 4.01 times the operating pressure −14,450 psi. FIGS. 41-50 show the strains for each of the four helical layer groups. The fiber angle at a point in the dome is not unique as discussed in Appendix A. This is accounted for during preliminary design by using a reduced helical fiber tension allowable (typically 70% to 80% of the hoop fiber tension allowable). The actual fiber strain allowable (12,673 μin/in) is still used for both helical and hoop fibers in the detailed FEA. The differences in wind angle within the band become more significant as the radius decreases. The strains vary with direction and the effect of this phenomenon is an unavoidable additional reduction in the dome efficiency. A range of fiber angles exists at a point in the dome as previously presented above. The two curves (red and blue) in the plots represent the upper and lower limits of the fiber angle range. The violet curve lying between the maximum and minimum curves represents the strain at the center of the band. The inner surface fiber strains for the first helical layer, shown in FIGS. 41 and 42, are fairly uniform between the tangent line and a radius of about 8 inches. Inboard of this location, the strains are affected by the fitting stiffness and the turnaround locations of the pull-back layers. The maximum inner surface strain is 12,427 μin/in, occurring in the dome about 2.5 inches from the boss. These strains were initially very high for the first FEM iteration. They were reduced to the current level by increasing the stiffness of the steel fitting beyond the initial sizing. The metal fitting appears over designed by itself, but the stiffness controls the polar composite strains. The outer surface fiber strains for the last helical layer, shown in FIGS. 49 and 50, are a maximum near the tangent line due to flexure. The maximum strain in this area is 10,893 μin/in.

The results show the maximum helical fiber strain in the dome is 12,427 μin/in on the inner surface near the polar opening. Therefore, the ultimate margin of safety for helical fiber tension failure at the minimum burst condition (14,400 psi) is:

$$MS = \frac{12673 μ}{12427 μ} - 1 = + 0.020 .$$

Initial helical fiber failure is predicted at 4.08 times the operating pressure, 14,685 psi. This strain is a result of the expansion of the composite away from the boss and of the fitting flange bending. The flange bending allows the composite to rotate and increase the outer surface strain. This phenomenon was minimized by increasing the fitting stiffness, but it is still an important contributor to the maximum strain.

### 6. CONCLUSION

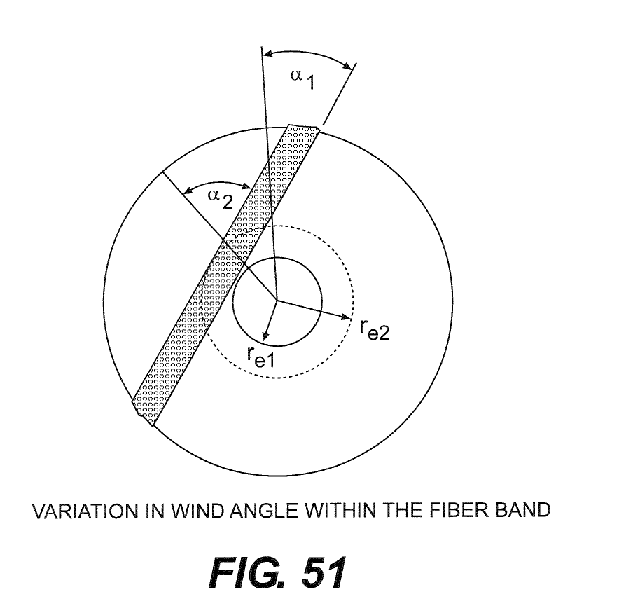

The analysis shows that the minimum predicted burst pressure for the vessel is 14,450 with a hoop fiber failure mode at mid cylinder. Analysis further shows the initial hoop fiber failure is immediately followed by a helical fiber failure near the boss. However, this may not lead to catastrophic failure because local fiber angles vary over a range and the strains in the lower angled fibers are lower. The HDPE liner has two areas of medium risk. The liner functions as a gasket for the closure seal and extrusion of the liner at the edges is a concern. The design minimizes this concern by containing the potential extrusion. Also, there is an area of inherently high liner strain at the outer edge of the polar fitting flange. Prediction of thicknesses and fiber angles becomes more difficult near the polar opening. As illustrated in FIG. 51 at a radius, r, the fiber angle relative to a meridianal line varies from one edge of the band to the other. When the radius is less than one band width from the polar opening, the fiber angle at the outside of the band, α₂ in the figure, is 90° while the fiber angle at the inside of the band, α₁ in the figure, is significantly less than 90°. The fiber angles for geodesic domes at the inside and outside of the band are accurately predicted by equations similar to the geodesic angle equations:

$${α}_{1} ( r ) = {sin}^{- 1} [ ( \frac{{r}_{{e}_{1}}}{r} ) ( 1 + {k}_{{α}_{1}} ( r - {r}_{{e}_{1}} ) ) ] , \\ {α}_{2} ( r ) = {sin}^{- 1} [ ( \frac{{r}_{{e}_{2}}}{r} ) ( 1 + {k}_{{α}_{2}} ( r - {r}_{{e}_{2}} ) ) ] \\ where {k}_{{α}_{1}} = \frac{( \overline{r} sin \overline{α} - {r}_{{e}_{1}} )}{{r}_{{e}_{1}} ( \overline{r} - {r}_{{e}_{1}} )} and {k}_{{α}_{2}} \frac{( \overline{r} sin \overline{α} - {r}_{{e}_{2}} )}{{r}_{{e}_{2}} ( \overline{r} - {r}_{{e}_{2}} )} \qquad ( A .1 )$$

The radii, rₑ_{₁} and rₑ_{₂}, are the edge-of-band radii tangent to the polar opening.

The thicknesses in the dome are accurately predicted by the following equation for positions on the dome more than two bandwidths from the polar opening:

$${t}_{ɛ} ( r ) = \frac{{k}_{ref}}{r cos α ( r )} , \qquad ( A .2 )$$

where k_{ref}=t _{α̅} r̅ cos α̅ and t _{α̅} is the thickness at the tangent line.

This equation is inaccurate for positions inside two bandwidths and the following equation is used:

$${t}_{ɛ} ( r ) = \frac{{k}_{ref}}{r} {\int }_{- \frac{1}{2}}^{ξ} \frac{ⅆ ξ}{cos ( α ( r , ξ ) )} , - \frac{1}{2} \leq ξ \leq \frac{1}{2} , \qquad ( A .3 )$$

where

$$α ( r , ξ ) = {sin}^{- 1} [ \frac{( {r}_{e} ( ξ )}{r} ( 1 + {k}_{α} ( ξ ) ( r - {r}_{e} ( ξ ) ) ) ] , \\ {k}_{α} ( ξ ) = \frac{( \overline{r} sin \overline{α} - {r}_{e} ( ξ ) )}{{r}_{e} ( ξ ) ( \overline{r} - {r}_{e} ( ξ ) )} ,$$

and ξ is the normalized location within the band relative to the center.

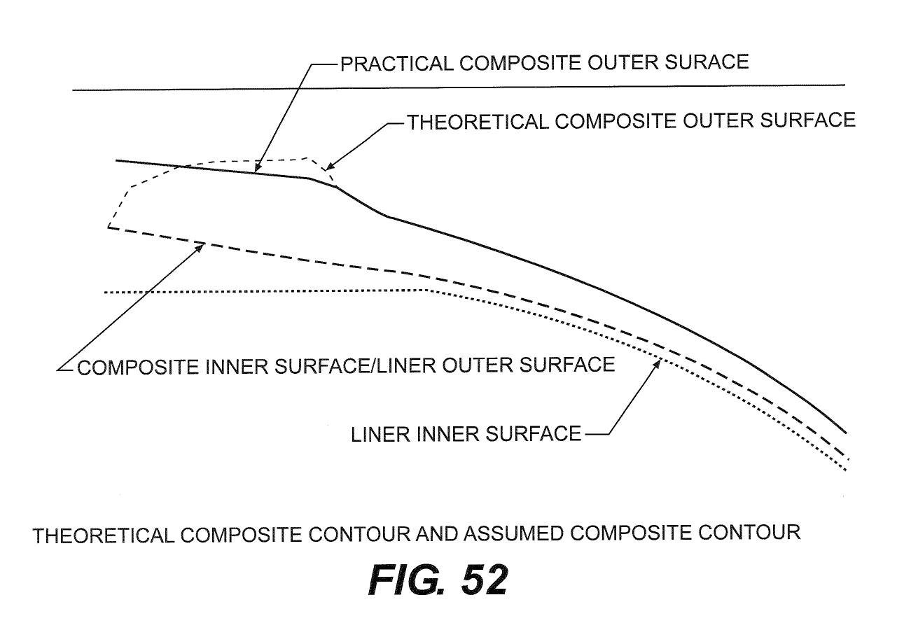

A polar opening composite thickness calculated from the above equations is shown by the green line in FIG. 52. There is a characteristic cusp in the contour located one bandwidth from the boss opening. The fiber path has a negative curvature to actually wind this contour which is extremely difficult. The band will bridge fibers will tend to slip towards the boss for large buildups such as this in the area inside the cusp. The area outside of the cusp will either bridge or be resin rich due to low compaction pressure. The assumed “practical” contour shown in FIG. 52 is estimated based on experience and is used for the finite element analysis. The assumed thickness profile is obtained by locally varying the fiber resin content. The actual fiber volume is theoretically accurate.

Material properties were calculated for unique cross ply angles of the filament wound composite using an SCC computer program based on the methods of Reference 5 taking into account the local resin content variation. The fiber angle in a point in the dome as explained above varies from the inner edge of the band to the outer edge of the band. Consequently, the material properties should represent a range of angles at a point. It can be shown that the material compliance matrix coefficients at a point in the dome are given by:

$${\overline{E}}_{ij} = \frac{1}{{α}_{2} - {α}_{1}} {\int }_{{α}_{1}}^{{α}_{2}} {E}_{ij} ( α ) ⅆ α . \qquad ( A .4 )$$

A numerical integration of this equation using Simpson's Rule is used to calculate the local material properties throughout the dome.

The surface critical to the design is the outside surface of the MDPE liner define by the coordinates (ri,zi). The inside surface defined by (ri1,zi1) are based on a nominal thickness of 0.50 inch. These coordinates to not reflect the presence of the boss fitting. The outside composite surface is defined by coordinates (ro,zo).

| i | ril, in. | zil, in. | ri, in. | zi, in. | ro(i) | zo(i) |
|---|---|---|---|---|---|---|
| 1 | 21.000 | 0.000 | 21.250 | 0.000 | 21.978 | 0.000 |
| 2 | 20.823 | 1.894 | 21.069 | 1.940 | 21.790 | 2.073 |
| 3 | 20.300 | 3.724 | 20.534 | 3.812 | 21.238 | 4.080 |
| 4 | 19.457 | 5.428 | 19.672 | 5.556 | 20.349 | 5.959 |
| 5 | 18.334 | 6.960 | 18.525 | 7.121 | 19.165 | 7.662 |
| 6 | 16.976 | 8.285 | 17.141 | 8.474 | 17.738 | 9.160 |
| 7 | 15.437 | 9.384 | 15.573 | 9.593 | 16.123 | 10.437 |
| 8 | 13.766 | 10.249 | 13.875 | 10.474 | 14.373 | 11.499 |
| 9 | 12.012 | 10.883 | 12.096 | 11.118 | 12.542 | 12.366 |
| 10 | 10.219 | 11.289 | 10.281 | 11.531 | 10.677 | 13.075 |
| 11 | 8.624 | 11.466 | 8.669 | 11.712 | 9.004 | 13.632 |
| 12 | 7.366 | 11.573 | 7.397 | 11.821 | 7.641 | 14.077 |
| 13 | 6.036 | 11.686 | 6.058 | 11.935 | 6.206 | 14.546 |
| 14 | 4.430 | 11.823 | 4.452 | 12.072 | 4.485 | 15.109 |
| 15 | 2.875 | 11.956 | 2.875 | 12.207 | 2.875 | 15.246 |
| 16 | 0.500 | 12.159 | 0.500 | 12.410 | 0.500 | 15.449 |

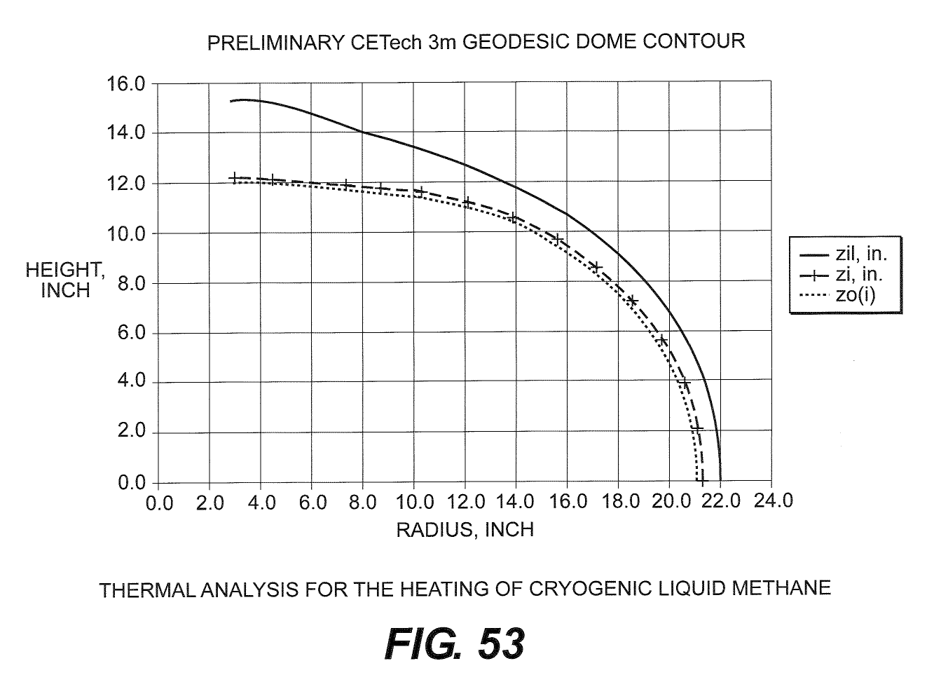

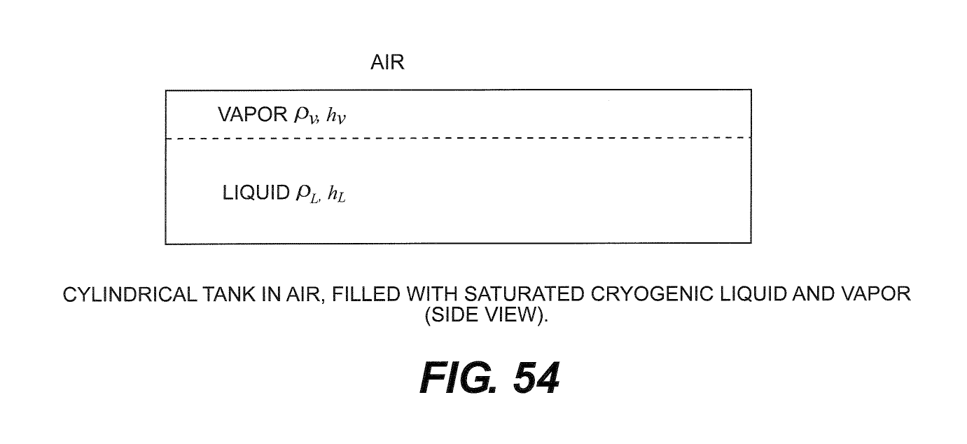

Calculate time to heat, from ambient air in large room (natural convection), a 2-phase cryogenic fluid (liquid and vapor) from −260 deg F. to −60 deg F. in a sealed, cylindrical tank. Air temperature is 68 deg F. Initial pressure is ambient (14.7 psia.) Final pressure is limited to 2160 psig. The fluid is methane. The geometry of the tank is cylindrical, 80 ft long by 4 ft outer diameter. Ignore heat transfer through end plates. Also, determine initial liquid volume fraction and fluid characteristics as a function of time/temperature. See FIG. 53.

Method:

1. Assume warming process is isochoric, that the temperature of the fluid within the tank is uniform, heat transfer rate from the tank to the fluid is much higher than (can be ignored) from the air to the tank, and that the heat transfer coefficient (from the air to the tank) for a cylinder applies to the tank. The finite thickness, thermal inertia, and conductivity of the tank can be included as an option but are not describe herein.
2. Determine the average density of the fluid from the NIST data at the final (limiting) state (temperature and pressure):
   p_{MAX}=maximum pressure
   =2174.7 psia
      T_{f}=final temperature
   =−60 deg F.
      ρ_{AVE}=average density of fluid (methane)
   =ρ(p_{MAX}, T_{f})=15.298 lbm/ft³
3. From the tank geometry and average density, determine the mass of the fluid:

$$V = π \frac{{d}_{O}^{2}}{4} l$$

m=ρ_{AVE} V
where
V=volume of fluid (tank)
d_{O}=outer diameter of tank
l=length of tank
m=mass of fluid
4. For the range of temperatures (−260 to −60 deg F.) at small temperature intervals, obtain properties of fluid (construct a table) from NIST:
   T=temperature
   p=pressure
   ρ_{V}=density of vapor
   ρ_{L}=density of liquid
   u=internal energy of fluid
   u_{V}=internal energy of vapor
   u_{L}=internal energy of liquid
5. From the mass equation, calculate the liquid volumetric fraction at the initial temperature (and subsequent) temperature(s). Also calculate volumes and masses of liquid and vapor.

$$\begin{matrix}{m}_{L} = {V}_{L} {ρ}_{L} \\ {m}_{V} = {V}_{V} {ρ}_{V} \\ {V}_{L} = fV \\ {V}_{V} = ( 1 - f ) V \\ m = {m}_{L} + {m}_{V} \\ = {V}_{L} {ρ}_{L} + {V}_{V} {ρ}_{V} \\ = fV {ρ}_{L} + ( 1 - f ) V {ρ}_{V} \\ ∴ f = \frac{\frac{m}{V} - {ρ}_{V}}{{ρ}_{L} - {ρ}_{V}}\end{matrix}$$

where
f=fraction of tank volume that is liquid
=V_{L}/V
   V_{V}=volume of vapor
   V_{L}=volume of liquid
   m_{V}=mass of vapor
   m_{L}=mass of liquid
6. Calculate energy of fluid
   E=m u
   where
   E=energy of fluid
7. For each temperature step i, e.g., at 1 deg F. intervals, calculate change in energy

$$\begin{matrix}Δ {E}_{i} = {E}_{i + 1} - {E}_{i} \\ = A {\dot{Q}}_{i} Δ {t}_{i}\end{matrix}$$

where the heat flux is
\dot{Q}=h_{c}(T_{A}−Tᵢ)
or the resulting heat rate is
q=\dot{Q}A
and
A=surface area of cylinder, excluding end caps
=πd_{O}l
   h_{c}=heat transfer coefficient for natural convection, typically 0.9 to 5 BTU/hr-ft²
=0.18(ΔT)^{1/3}, 10³<D³ ΔT<10⁶ [Eshbach, for horizontal pipe]
T_{A}=ambient temperature
Tᵢ=temperature of fluid at step i
Δtᵢ=time interval at step i
and solve for the time interval

$$Δ {t}_{i} = \frac{Δ {E}_{i}}{A {\dot{Q}}_{i}}$$
8. Return to Step 4 for the next iteration and repeat through Step 8 until final temperature reached.
9. Sum the time intervals to obtain the total time

$${t}_{TOT} = {\sum }_{i} Δ {t}_{i}$$

Results

The volume of the tank, area of the tank, and mass of fluid are:

Vₜₖ=1005.31 ft³

A=1005.31 ft²

m=15,379 lbm

The given and calculated constants of the problem and the parameters for the initial part of the temperature rise are listed in Table 1. Note that the initial value for fraction of volume that is liquid (f) is 0.577. The final temperature iterations are also listed in Table 1.

TABLE 1
Constants and Initial and Final Temperature Rises.
HEATING OF A CRYOGENIC FLUID IN A TANK (SOLID IGNORED)

ignoring end plates

| (ft) | (in) | (ft) | (ft\hat{ }3) | (ft\hat{ }2) | (psig) | (psia) | (deg F.) |
|---|---|---|---|---|---|---|---|
| I | doin | do | V | A | pmaxg | pmax | T0 |
| 80 | 48 | 4 | 1005.31 | 1005.31 | 2160 | 2174.7 | −260 |

| | NIST: | | | | | |
|---|---|---|---|---|---|---|
| (deg F.) | (lbm/ft\hat{ }3) | (lbm) | (w/(m-K)) | (BTU/ft-se [symbol] | (in) | (in) |
| Tf | rhopxTf | m | kcompM | kcomp | tsteel | tcomp |
| −60 | 15.298 | 15.379 | 1.31 | | 0.5 | 0.375 |

| (deg F.) | (deg F.) | Eshbach |
|---|---|---|
| dT | TA | solid ignore |
| 1 | 68 | 0.000139 |

| (deg F.) | (psia) | (lbm/ft\hat{ }3) | (lbm/ft\hat{ }3) | (−) | (BTU/lbm) | (BTU) | (BTU) |
|---|---|---|---|---|---|---|---|
| T | p | rhoL | rhoV | f | u | E | dE |
| −260 | 13.8 | 26.434 | 0.107 | 0.5770 | −0.62 | −9608 | 0 |
| −259 | 14.5 | 26.384 | 0.112 | 0.5780 | 0.23 | 3486 | 13093 |
| −258 | 15.2 | 26.333 | 0.117 | 0.5791 | 1.08 | 16600 | 13115 |
| −257 | 15.9 | 26.282 | 0.122 | 0.5801 | 1.93 | 29737 | 13137 |
| −256 | 16.6 | 26.231 | 0.127 | 0.5812 | 2.79 | 42896 | 13158 |
| −255 | 17.3 | 26.180 | 0.132 | 0.5822 | 3.65 | 56077 | 13182 |
| −254 | 18.1 | 26.129 | 0.137 | 0.5833 | 4.50 | 69282 | 13205 |
| −64 | 2073.7 | 15.298 | 15.298 | 0.0000 | 162.40 | 2497586 | 6767 |
| −63 | 2099.0 | 15.298 | 15.298 | 0.0000 | 162.85 | 2504507 | 6921 |
| −62 | 2124.3 | 15.298 | 15.298 | 0.0000 | 163.29 | 2511274 | 6767 |
| −61 | 2149.6 | 15.298 | 15.298 | 0.0000 | 163.73 | 2518041 | 6767 |
| −60 | 2174.9 | 15.298 | 15.298 | 0.0000 | 164.17 | 2524808 | 6767 |

| | (BTU/ | (BTU/ | | | | |
|---|---|---|---|---|---|---|
| (ft\hat{ }3-deg) | hr-ft\hat{ } [symbol] | sec-ft [symbol] | (BTU/sec) | (sec) | (sec) | (hr) |
| D3dT | hhr | h | g | dtime | timeTOT | timeTOThr |
| 20992 | 1.4483 | 0.000402 | 132.65 | 0.0 | 0 | 0.00 |
| 20928 | 1.4468 | 0.000402 | 132.11 | 99.1 | 99 | 0.03 |
| 20864 | 1.4453 | 0.000401 | 131.58 | 99.7 | 199 | 0.06 |
| 20800 | 1.4438 | 0.000401 | 131.04 | 100.3 | 299 | 0.08 |
| 20736 | 1.4423 | 0.000401 | 130.50 | 100.8 | 400 | 0.11 |
| 20672 | 1.4409 | 0.000400 | 129.96 | 101.4 | 501 | 0.14 |
| 20608 | 1.4394 | 0.000400 | 129.43 | 102.0 | 603 | 0.17 |
| 8448 | 1.0692 | 0.000297 | 39.41 | 171.7 | 31074 | 8.63 |
| 8384 | 1.0665 | 0.000296 | 39.02 | 177.4 | 31251 | 8.68 |
| 8320 | 1.0638 | 0.000296 | 38.62 | 175.2 | 31426 | 8.73 |
| 8256 | 1.0611 | 0.000295 | 38.22 | 177.0 | 31604 | 8.78 |
| 8192 | 1.0583 | 0.000294 | 37.83 | 178.9 | 31782 | 8.83 |
| | | | tTOT | 31,782 | | |
| | | | tTOThr | 8.8 | | |

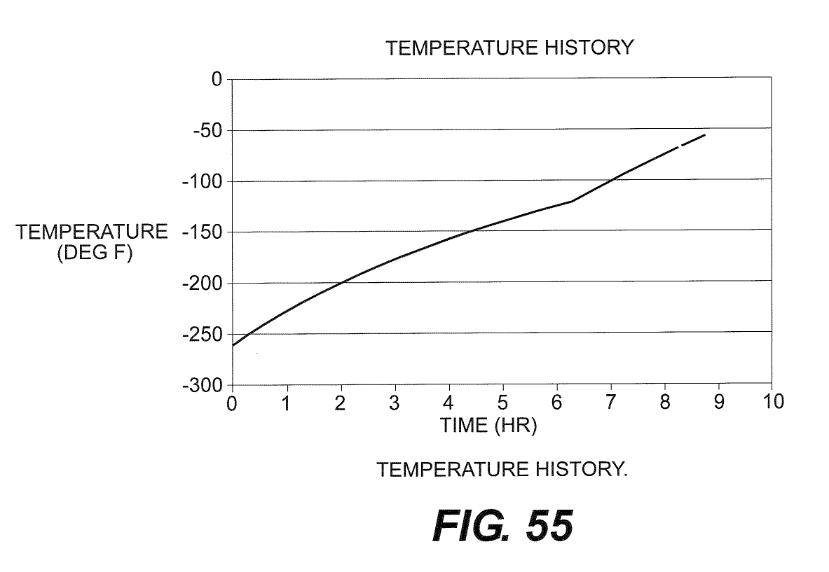

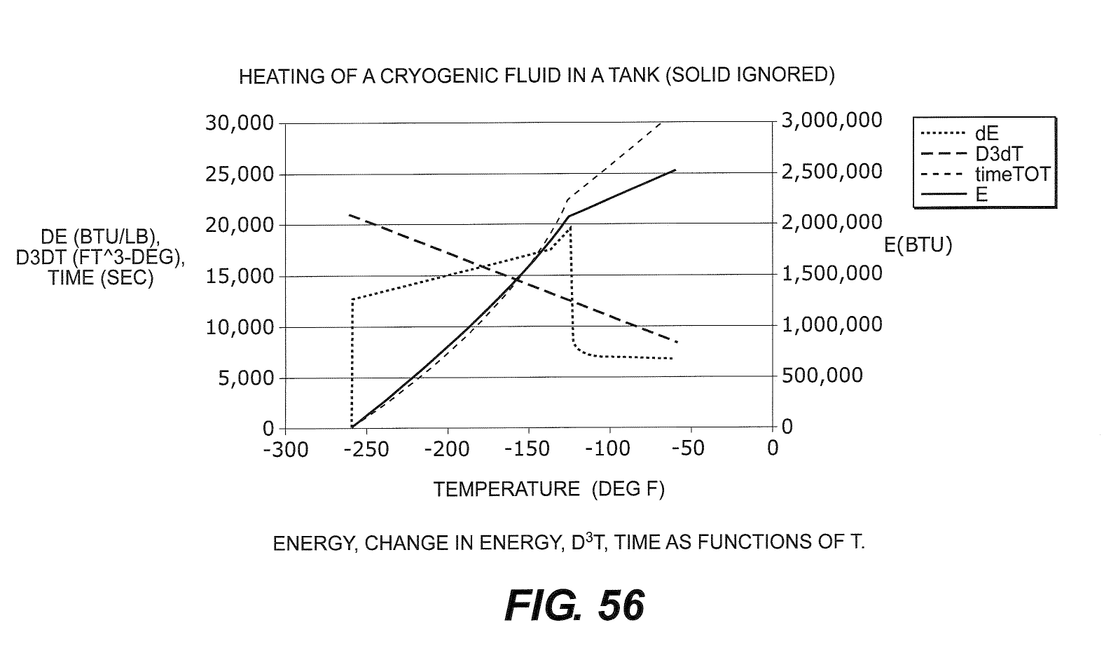

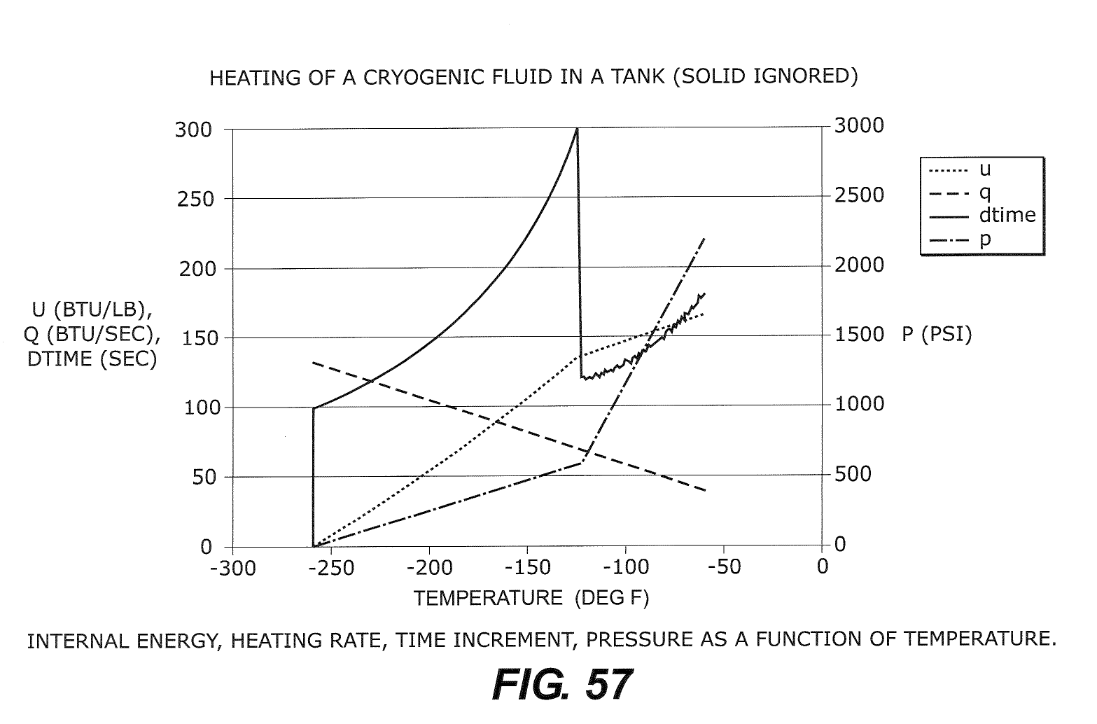

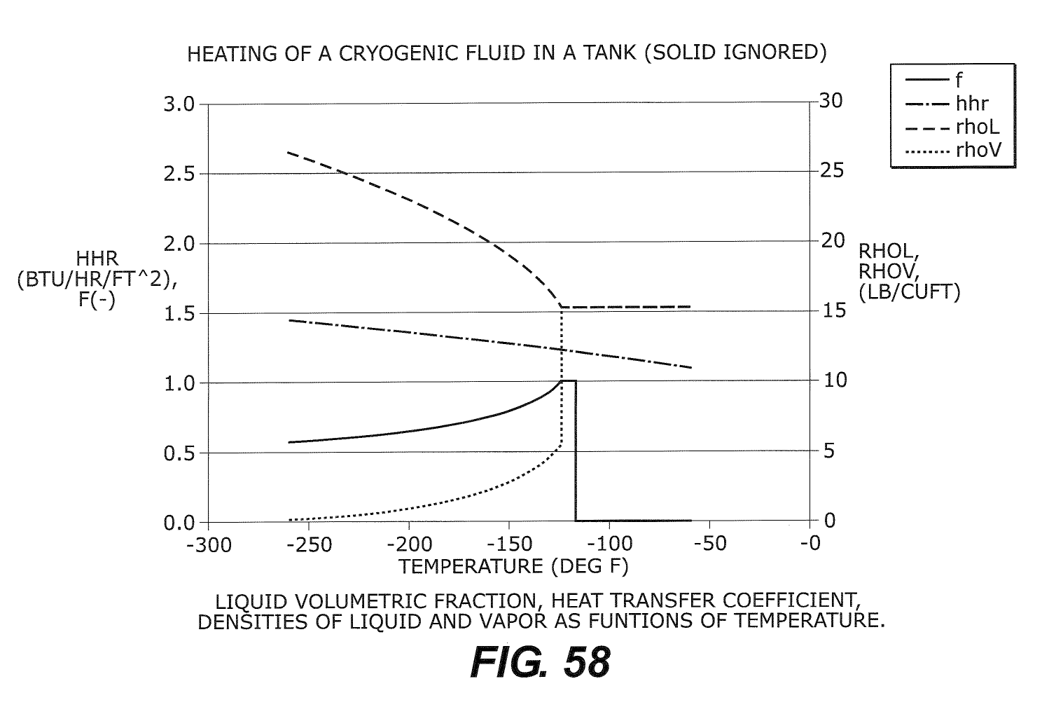

Table 1 indicates that the final time is 8.8 hours. FIG. 55 depicts a plot of the temperature history, from which it can be observed that the change in slope at about −124 deg F. due to the elimination of the vapor phase, precluding the absorption of energy by the change in phase. FIG. 56 depicts energy, change in energy, D³T, and time as functions of temperature. The change in energy rises at first, drops by a factor of three at the point that the vapor phase is eliminated, then decreases thereafter. FIG. 57 depicts internal energy, heating rate, time increment, and pressure as a function of temperature. The time interval rises to triple its initial value, then suddenly drops by a factor of two when the vapor phase is eliminated and, finally, rises again. The slope of the pressure curve increases markedly and becomes nearly constant at this same point. FIG. 58 depicts liquid volumetric fraction, heat transfer coefficient, and densities of liquid and vapor as functions of temperature. Notice that the fluid starts as a mixture of liquid and vapor, becomes liquid only partially through the process, and ends up as supercritical fluid. Heat transfer coefficient decreases modestly.

The following outlines and describes the preliminary description and schedule needed for the feasibility of an insulated composite over-wrapped pressure vessel to store pressurized cold-gas. Further, the necessary steps to develop an operational array of tanks for the transport of dense phase gas are also detailed.

Some of the elements determined include, but are not limited to:
A. Developed designs an analyses for light-weight pressure vessels that are capable of withstanding pressures of equal to or greater than 2160 psig and temperatures of between −150° C. and +30° C. for repeated storage (i.e. cycled loading) and transportation of fluids (the “Operational Specifications”);
B. Developed and tested new pressure vessels to determine their ability to meet the Operational Specifications;
C. Developed procedures for the manufacture of containers that meet the Operational Specifications for further experimental and operational testing and evaluation.

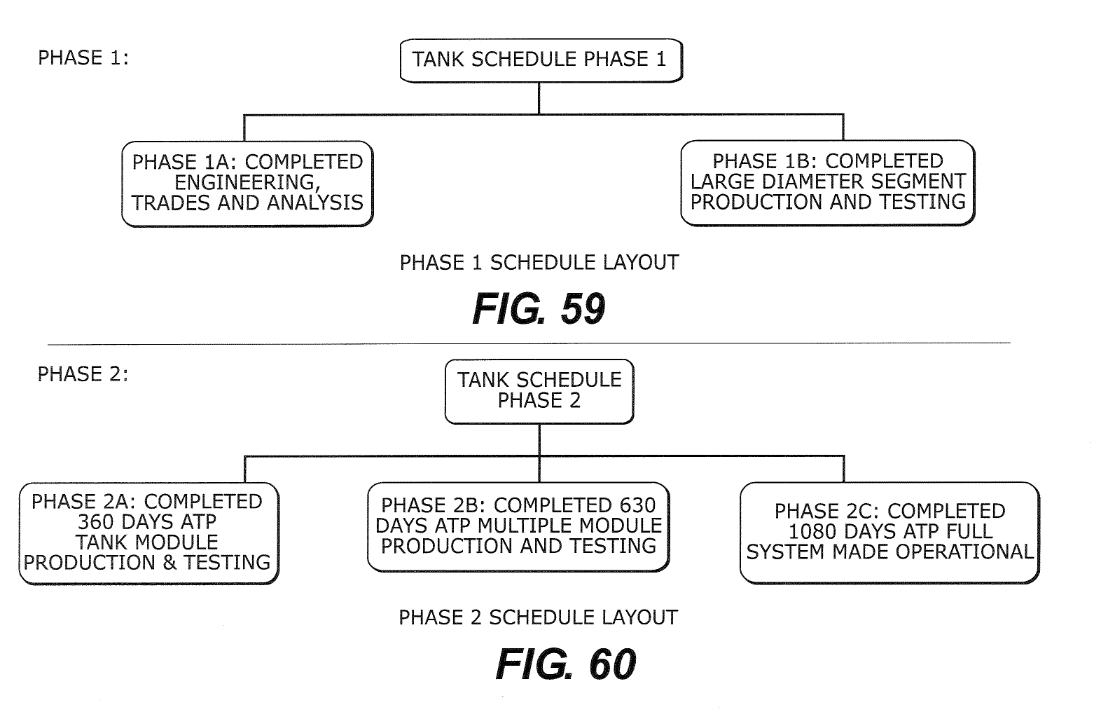

The dense phase cold-gas tank development, demonstration, and production program consists of two principle phases. During Phase 1, which contains two sub-phases, the initial concepts and trades are explored and analyzed and four full diameter shortened production tanks were tested, as depicted in FIG. 59. Phase 2, which also consists of three sub-phases, demonstrates a full-scale tank module, a fully functional collection of tank modules, and the final production system.

Phase 1A:

Phase 1A consists of the necessary tasks to mature a cold-gas composite tank design to facilitate the future production and testing of full diameter tanks. The phase begins with a more task defined and detailed schedule, then direct dialogue regarding the specifics of the system, which is immediately followed by a comprehensive engineering trade study that determined a set of general design characteristics. Only lightweight, cost-effective technology and materials was considered for the tank design, with a goal net weight reduction of at least 50% over the metal equivalent. The trade studies included a close examination of the optimized size and configuration of the tanks to meet and exceed the volume and ease of manufacturing. In addition, the trade studies examined the necessary logistical, transport, storage, and operating environment considerations. Additional studies centered on how to efficiently remove the entire working fluid from the tanks. Further concept exploration, with a particular emphasis on barrier design and thermal considerations, was then carried out to determine a specific barrier design for the given parameters.

Several initial barrier concepts were considered and partially developed, all of which reduced cost, weight, and manufacturing time. The concept used a high density polyethylene liner over-wrapped with carbon fiber. The polyethylene portion was fabricated through rotational molding techniques, and represented a significant cost and time savings over traditional customized spun metal liners. However, the minimum operating temperature for such a polyethylene material is approximately −75° F., so additional heating tankage and equipment was used to reach this temperature while in port. Another liner concept that was developed revolved around the use of an Inconel-lined composite over-wrapped pressure vessel, which handles a much wider temperature range. However, this approach was later abandoned due to its higher cost. With the completion of the plastic-lined design and the Inconel design, the final liner concept, which uses commercial-off-the-shelf steel pipeline as a liner and composite over-wrap to provide the extra needed strength, was analyzed and designed. The remainder of the Phase 1A efforts focused on developing this pipeline technology, including a formal design and analysis effort centering on the performance of the thick-walled liner. Once this liner technology was shown to be sufficient for the operating conditions, an exact carbon over-wrapped pattern was designed to exceed the Factor of Safety by accepted industrial standards.

During this phase, engineering also performed the system engineering, feasibility and trade studies for the liner and tank configuration. Further, a risk assessment was performed based on the initial needs and information gathered from consultants familiar with the operations in the field and thermo characteristics.

Upon completion of an over-wrap scheme, an appropriate insulation design was generated to ensure maximum temperature containment in the pressure vessel, with a minimum of energy required to maintain the desired gas temperature (and pressure). Additional design efforts focused on the operational environment of the production tanks and the associated fittings and attachment points. Once the tanks were fully designed, a rigorous analysis took place to fully verify the designs. This analysis included a pressure vessel stress analysis using Finite Element Analysis (FEA) and classical calculations, as well as a full thermal analysis.

Once a suitable tank design was reached, two storage systems were then designed. The first system was a smaller, containerized version of the overall transportation system that consists of approximately 60 standard shipping container freezers that contain 4 pressure vessels each. Each of these containers is a self contained unit that is capable of being removed from the ship and transported by truck and rail to the specified destination. This system provides a final validation of the overall system's concept and is put into operational use to act as an instant infrastructure for regions that do not have processing stations. The second system is the full-sized, ship-mounted storage structure that exceeds the minimum 2 b.c.f. gas requirement. Depending upon the ship selected, this system consists of independent pipelines that are manifolded together and chilled.

Phase 1B:

Phase 1B focused on the production and testing of four full diameter tanks to verify the direct feasibility of the full-scale tank design, as well as the continued design and thermal analysis of the containment system. The principle test specimens produced in Phase 1B are pressure vessels with a diameter comparable to that which are used in the industrial environment, which corresponds to a diameter of approximately 48 inches. However, the cylindrical portion of the tanks are approximately 10 feet in length, as this is a substantial cost savings effort that also produces reliable test results, since the tangential (hoop) stress in the cylindrical portion of the tank is approximately constant throughout. The testing protocol for this phase consisted of the first of the four tanks being hydrostatically burst to verify the overall strength of the pressure vessel. The other three tanks underwent an initial proof/autofrettage pressure test (typically 1.25×MOP), then thermal cycle tests, which consisted of warming and chilling the tank while under operating pressure, multiple long duration hold tests in which the tank was held at a constant pressure for a specified amount of time (2 weeks), and finally a terminal leak failure test, during which the tank was intentionally taken past its designed pressure until it failed. This test series provided ample verification of the tanks' principle design. After completion of the testing, all critical analyses and cost data were closely re-scrutinized to assure that the proper overall design and configuration were reached to facilitate ease in production, transport, and eventual maintenance and repair.

The continuing design and analysis effort commenced with an immediate revision of the detailed design document that outlines a snapshot of the system's current design. A detailed design document for the smaller system was also generated, which outlines and describes the system's characteristics. Additionally, continuing thermal analysis was performed to fully understand and quantify the demanding thermal environment that takes place within the system. The thermal data became an integral part of the system's overall design, as the thermal characteristics of the system largely drive certain parameters. Additional risk assessment and mitigation, as well as logistics and manufacturing analysis, were also performed and documented.

Phase 2A:

The goal of Phase 2A is to manufacture and test a full-scale unit of tanks to verify the modular concept of the small system. Currently, it is preferred that each individual tank is a part of a self-contained cluster of tanks, which enables the system to be highly modular and easy to operate/repair. So, during this phase, a small group of full-sized tanks was fully interconnected through both structure and plumbing. This battery of tanks was taken through a rigorous testing protocol, including both land-based and sea-based testing, to demonstrate its operational viability. Several individual full-sized tanks were taken through a similar testing regiment that the shortened tank was taken through during Phase 1B. Once the individual tanks were verified, the working module of tanks was constructed and interconnected. Then, the module was put through a battery of operational tests to ensure that the interconnections and structures worked well together. A portion of this operational test took place at sea to simulate the environment that the operational system is subjected to.

This phase also produced and tested longer pipeline segments to verify the manufacturability and performance of the elongated structure similar to validate the full-sized, rigidly ship-mounted system. This testing simulated the long tank being mounted in a ship's cargo or tankage hold, and then taken through operational and worse-than-operational testing protocols. This series of tests added to the validation of the systems, as it closely simulated the operational circumstances.

Phase 2B:

With the verification of a tank cluster complete, Phase 2B focuses on producing and testing a set of full-scale production tank modules, for both the smaller system and the full-sized, ship-mounted system. This set of tanks is first interlinked and tested to ensure all piping performs as desired. Then, the set of modules and/or the rigidly mounted pipeline segments is placed on a barge and undergoes a full set of sea trials. These trials include traveling to a remote location, loading actual product, and making their way back to a U.S. (or other) port for off-loading. This phase fully demonstrates the operational reliability of the system in its true operating environment. This testing cluster would not be destroyed and could be implemented into the future operational system.

Phase 2C:

Phase 2C is marked by the operational system being brought online for full commercial use. All tanks and supporting structures are aggressively manufactured, with a high level of quality assurance being implemented into the production. The system is then built into the ship(s) in the selected optimized configuration. The full system then goes through rigorous sea trials to ensure it is operating properly. These trials include full commercial runs between ports and processing stations of interest. Following the completion of all testing, the system begins service for commercial use and remains in minimum operational goal of 20 years.

Storage Tank System Criteria

Insulating foam on storage tanks is preferrably from between 0-3 inches, preferably 2 inches thick. E-glass is one preferred winding layer, and carbon fiber is another preferred winding layer. The cargo ship hold is preferably climate controlled, although the tanks are designed for exposure to the elements. Preferably, the cargo ship has a dedicated power supply to provide refrigeration to the storage tank clusters. One embodiment is for four 15 MW generators to provide for storage tank refrigeration, separate from the ship's own power supply. The ship's cargo hold is preferably insulated to maintain a hold temperature of approximately 50 degrees F. Sources for E-glass include Owens Corning® and Hexyl®.

As embodied and broadly described herein, the present invention is directed to systems and methods, and also specific apparatus, for unloading and vaporizing LNG, as well as the processes for compressing, chilling and/or liquefying quantities of LNG and transporting those volumes to markets for redelivery. An exemplary embodiment of the invention comprises an offshore berthing facility at which LNG tankers are docked and unloaded, a series of pumps to offload the LNG from the tanker, temporary storage tankage to store the LNG, and a gasifying apparatus to gasify the LNG, which regasifies the LNG into a commonly usable form. Once in a usable form, the NG flows into the existing infrastructure to transport the gas to market. Alternatively, the gasification is more transitory, allowing efficient transportation and storage, with subsequent regasification and transportation to market.

One advantage of the present invention is the use of offshore berthing facilities to provide docking for NG tankers. This minimizes public concern over accidents, and the reality attributed to safety measures that should be taken against real accidents and possible terrorism. Public concerns are alleviated, in significant part, because the NG is far enough from shore so that even a catastrophic failure would not pose a danger to the local populace or structures. While a concern still exists for the safety of the tankers' crew members and the crew of the berthing facility, safety precautions are incorporated into the design of the berthing facility for a fraction of the cost of similar safety systems at an on-shore facility. For example, safety escape pods are positioned in easily accessible locations for use during an emergency situation. The escape pods are manually or automatically driven to a distance safe from explosion or fire.

Offshore berthing facilities are also beneficial in that they do not require a large area of waterfront real estate, thereby removing the costs associated with purchasing waterfront real estate and the interference they pose to other commercial and recreational traffic. Offshore facilities are also more flexible in that they are less affected by inclement weather than shore facilities.

While it is preferred that the berthing facility is offshore, the present invention is not limited to offshore berthing facilities. For example, berthing facilities are alternatively located along the shore, in inland waterways, or even in man-made waterways. The facilities are capable of accommodating tankers carrying chemical cargo of any nature. Preferably the cargo is natural gas, but another hydrocarbon liquid other than NG, such as ethane, propane, butane or even heavier hydrocarbons is equally suitable.

Once a tanker is docked at the berthing facility, LNG is either regasified at the berthing facility or transferred to a short term storage tankage. In the latter circumstance, LNG is transferred to an NG storage facility. If not converted on the berthing facility, the LNG is either regasified by using the heat of the intervening seawater between the berthing facility and the host platform or transferred to an NG tank on the host platform for storage. Using seawater to warm the NG results in considerable savings in time, cost and equipment. In one embodiment, a jacketed pipe system employing a warming fluid is used to gasify the LNG. Such a jacketed system provides an advantage in that it is designed to local conditions in such a manner as to prevent unacceptable ice buildup and unwanted flotation tendencies as called for by process designers. In a preferred embodiment, this jacketed system fluid contains propane, which does not freeze at LNG temperatures. In a further embodiment, the jacketed system also serves as a safety system such that an NG leak will cause an over-pressure relief system to provide a signal for NG shutoff. This jacketed system is used, for example, for regasification between the berthing barge and the host platform, or after transfer of the LNG to the host platform.

Once the LNG is regasified, transportation facilities, whether existing or new, are utilized to transport the gas to market. Preferred embodiments use onshore or offshore salt caverns or depleted gas reservoirs as LNG gas storage facilities.

Docking of NG Tanker Ships

In one preferred embodiment, an NG tanker docks at an offshore berthing facility or berthing barge, transfers NG through a pipeline system to a pumping platform equipped with tankage and ancillary equipment for pumping the NG and thereafter introducing the NG to a piping system designed to vaporize the NG while en route to shore for usage or storage. Preferred embodiments of the invention use free floating berthing facilities. These facilities are flexibly moored such that they rise and fall with the tide and rise and fall with the docked tankers. In one such embodiment, the NG tankers are preferably externally secured to the facility, allowing for fast docking and departing of the NG tankers. The offshore berthing facility alternatively has a wet dock that allows NG tankers to dock inside the berthing facility and be secured therein, such that the NG tankers rise or fall due to ocean movement along with, or even inside, the facility. In one such embodiment, the berthing facility preferably secures the NG tanker in place by closing a lock behind the tanker.

The berthing barge is designed for use with various size tankers in either seawater, brackish or fresh water. It is anchored or tethered so as to maintain lateral position, is dynamically positioned to maintain lateral position, is free to float in a fixed matrix designed to restrict lateral movement and thereby maintain lateral position, is moored to a fixed platform to maintain lateral position, but with break away capability in the event of operational need or emergency. Additionally, the barge is designed for either self propulsion or arranged for towing.

In preferred embodiments, the berthing barge accepts vessels that are either mid ship, bow or stern cargo discharge. The berthing barge is also preferably arranged with multiple platforms suitable for handling cargo discharge and taking on required supplies. The berthing barge can be arranged to receive service vessels or helicopters. Embodiments include the berthing barge is arranged to receive such items as NG vapor return or nitrogen gas in the case of NG cargo handling, as well as to receive ships stores, fuel oil, electrical service and communication service for NG or other cargo handling. Preferred embodiments advantageously have a berthing barge designed to contain NG or other spills and properly dispose of them with due regard to safety and environmental concerns. The barge is designed with safe operating and control rooms and/or facilities, with safety systems triggered either automatically or manually which have the capability to shield personnel from heat or dangerous atmospheres and to extinguish fires using dry powder and/or fire water systems.

In an alternate embodiment of the invention, the offshore berthing facility is firmly connected to the ocean floor or another non-floating object that itself is selectively secured to the ocean or sea floor, or other solid feature of the body of water, to provide a secure and stable platform for the docking of tankers. In preferred embodiments of the invention, NG tankers is selectively docked within the berthing facility or external to the berthing facility. Ships stores and nitrogen are provided on the berthing facility or the pumping platform to re-supply NG tankers as required.

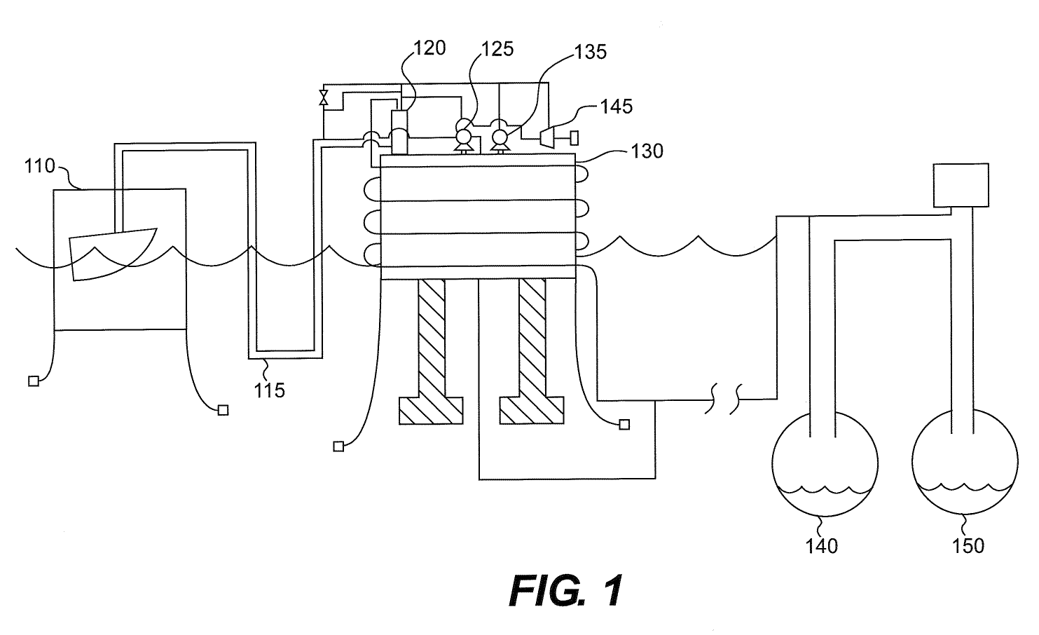

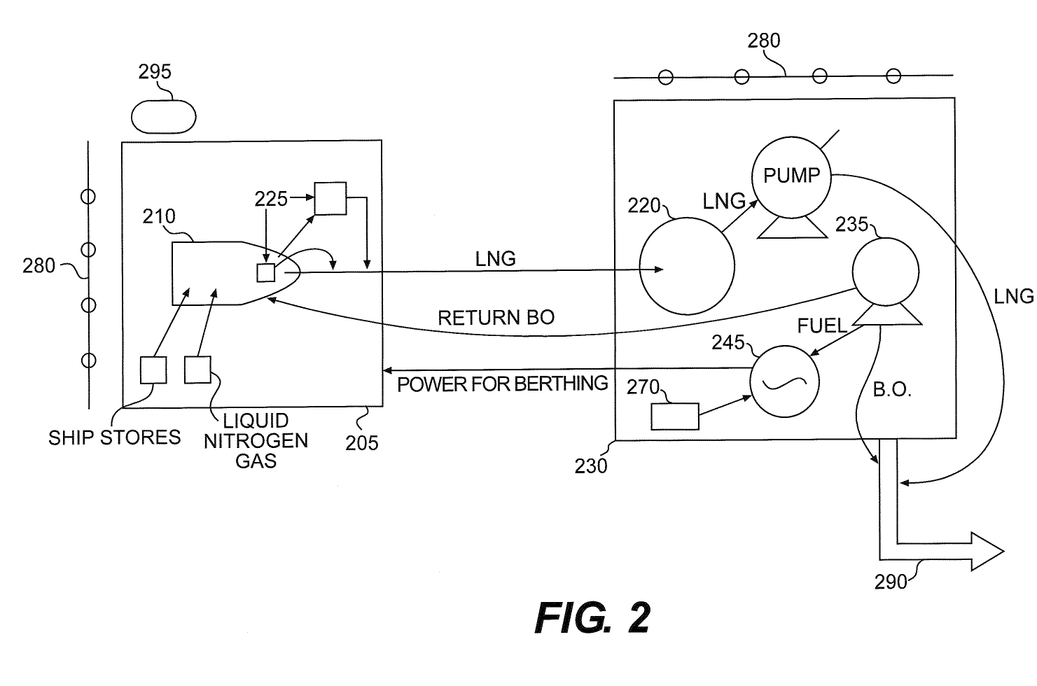

As depicted in FIGS. 1 and 2, in one embodiment, berthing facility 110, 210 is designed to receive several sizes of commercial LNG transport vessel 105, 205 and rise and fall with the tide and waver to minimize unloading arm design problems. The vessels can be received either internally or externally by the berthing, and are selectively arranged to “break-away” and go to sea in case of emergency or berthed in to become a unitary piece. In additional preferred embodiments, the unloading arm connection for the berthing facility is arranged to accommodate vessel unloading systems of various designs, such as mid-ship-side unloading or low and/or stern unloading, depending on vessels berthed at the berthing facility.

Off Loading of NG

On-board NG ship pumps are utilized to move the NG cargo through underside insulated liners 115 to the platform 130 for introduction into NG surge tankage 120 designed for both top and bottom fill to minimize the tendency to “roll-over” and thereby do not overstress the surge tankage. Tanks are of low profile design to minimize wind forces on the structure.

Once an NG tanker is docked at the berthing facility, the tanker and the facility are functionally connected such that the NG is able to be unloaded from the tanker (see FIG. 2). In one embodiment of the invention, a series of pumps 225 are located on tanker 205 to transfer the NG. In another embodiment, the pumps 125 are located on pumping platform 130 to transfer the NG. In yet another embodiment, a series of pumps are located on the berthing facility to transfer the NG. Although the term “platform” is used here, it is not intended to define or limit the possible structure of the pumping structure to a platform design or any particular structure. Many variations of structures including conventional structures are contemplated.

While it is preferred that multiple pumps are available to transfer NG, a single pump or other means of transferring the NG is alternatively used. A preferred embodiment uses a parallel array of pumps to pump liquid NG from the tanker. By using multiple pumps, the rate of NG transfer can be adjusted. The pumping platform is equipped with NG tanks sufficiently large to span the ship arrival times while continuing to pump NG to minimize the thermal cycling stresses in the NG piping vaporizing and warm-up system. Pumps are arranged to pump in parallel so as to accommodate either fast or slow pumping by adding or removing pumps from the active pumping configuration. Pumps are also “in-tank” or external as preferred by the process designer.

Boil-off compressor 135, 235 and associated piping are provided to return boil off (BO) to LNG tanker 105, 205 during unloading, to provide fuel gas for turbines or compressors, and/or to introduce boil-off gas into the high pressure LNG/gas pipeline 290 (see FIG. 2). An electrical generating system arranged with distributive switchgear and wiring is resident on the pumping platform, and is designed to use boil-off as primary fuel but also operate as a standby fuel source 270. The generating system 145, 245 is arranged to provide service to the berthing facility through an undersea system.

The berthing facility is preferably configured so as to connect to other offshore facilities for handling offloaded NG with concomitant vapor return, as well as receiving LN₂ (liquid nitrogen), fuel oil, electric power, communications, and ships stores. Service vessel docking and receiving are also incorporated into the facility design. The docking facilities are preferably designed for safe quick release of docked tankers or service vessels in the event of an emergency. The design of the facility is such that it is capable of remaining at sea during all conceivable weather conditions. As shown in FIG. 2, emergency alarm and fire preventing and fighting systems 280 are locatable on the facility. Such systems include dry powder and seawater systems. Escape modules 295 are selectively provided for operating personnel. Materials of construction for the facility are selected so as to mitigate the danger of spilled cryogenic fluids.

The invention also comprises an unloading arm on the berthing facility to functionally connect the tanker with the berthing facility. The unloading arm is designed to provide a pathway for the transfer of LNG regardless of movement of the tanker relative to the berthing facility. This arm comprises a swivel connector for mid-ship unloading, bow unloading, and/or stern unloading.

NG Storage after Offloading

Temporary storage tankage is provided on the berthing facility such that NG is transferred from a tanker to the storage tankage on the berthing facility. Temporary storage is storage that is intermediate between offloading and transfer to a gasification facility. In another embodiment, similar storage tankage is located on a pumping platform, or located on both the berthing facility and the pumping platform. The term “tankage” is used to indicate that various embodiments of the invention may use different arrangements and types of tanks to store the L NG.

In one embodiment, high pressure gas is directed into a prepared salt cavern for use at a later time. There are several hurdles associated with the storage of NG gas in salt caverns. Initially, when the salt caverns are hollowed out, rock and other non-soluble materials that were trapped in the solid salt are freed. These solids settle to the bottom of the cavern where they trap water. When gases are stored in the caverns, the water evaporates into the gas thereby hydrating the gas. When the hydrated gas is extracted from the cavern, it should be dehydrated, a process involving expensive equipment.

Caverns for storing natural gas are constructed by drilling a well into a salt diapir, anticline, dome or other structure, pumping fresh water into the well to dissolve the salt, and then disposing of the resulting salt water. The cavern shape is controlled by directing fresh water to the portion of the salt designated for removal. Most of the salt structures contain insoluble substances such as anhydrites or hydrates which cannot be removed with the brine and therefore fall to the bottom of the resulting cavern. The insoluble rubble is undesirable because it makes it very difficult to remove all of the salt water from the cavern.

When such a cavern is utilized as a gas storage container the gas comes into direct contact with the residual water and absorbs some of the water. Depending on the circulating rate of the gas, the gas absorbs a quantity of water such that expensive dehydration is needed prior to introducing the gas into a pipeline system. This gas circulation rate is a function of several forces such as the rate of gas injection, the location of gas injection, and the thermal influx from the salt.

Before LNG can be introduced into a cavern at a rate for maximum efficiency, the cavern should be cooled significantly either by injection of liquids or gases. If the integrity of the reservoir is not maintained, the difference in temperatures results in thermal shock of the cavern atmosphere causing the cavern walls to crack. In a preferred embodiment, LNG is pumped off the tanker and significantly warmed via a wrapped pipeline and seawater circulation. The warmed LNG is then pumped into the cavern and back out again before passing through a heater and compressor and distributed for sale. With each exchange of LNG passing through the salt cavern, the temperature in the salt cavern decreases and the cavern increasingly withstands colder LNG introduced until a maximum rate of LNG can be injected.

In a preferred embodiment of the invention, a layer of propane is interposed as a buffer layer between the gas and the water to reduce the propensity of the water to go into the gas mixture. A buffer layer, or rubble seal, is effective, because the sub cooled liquid propane blanket is less dense than the water, or brine, in the bottom of the cavern and denser than the regasified NG. By covering the rubble and the water with the propane blanket, the amount of hydration that occurs in the stored NG gas is minimal. Such a buffer greatly reduces the water content of NG exiting a salt storage cavern, thereby greatly reducing, or even eliminating, the need for expensive gas dehydration that otherwise is necessary to meet marketing specifications for the gas.

Chemicals are used as the buffer layers that have at least a specific gravity that is greater than NG but less than water. Preferably, the chemical used is not miscible or only slightly miscible in water or NG. However, so long as the miscibility does not interfere with downstream use of the NG, more miscibility may be tolerated, which may need replenishment of the pad. Replenishment is constantly provided or periodic (e.g., daily, weekly, monthly or longer) through appropriate pipes and channeling apparatus, which are constructed by those of ordinary skill in the art. The periodicity of replenishment depends on a combination of factors including miscibility of the substance with the NG or with the water, NG temperature, water temperature, cavern temperature, depth of the cavern, the overall structure and contours of the cavern, and the presence and amount of rubble. The buffer layer or pad is sufficiently thick to prevent mixing of the NG and water, brine, rubble and other materials at the bottom of the cavern. A suitable pad is from about 15 cm to about 10 meters in thickness, preferably from about ½ meter to about 10 meters thick, and more preferably from about 1 to about 5 meters thick. Substances that are used as the pad include, but are not limited to ethane, methane, propane, carbon dioxide, liquid nitrogen and combinations thereof. Chemicals to control unwanted side effects attributed to the substances such as buffers, thickeners, acids and alkalines are also be included as necessary or desired.

Volumes of LNG are introduced into the gas storage reservoirs. Prior to or simultaneous with such introduction, a layer of liquefied propane or similar fluid provides a buffer layer that prevents the intermingling of the LNG with the salt water and/or rubble at the base of the reservoir. In this embodiment, the LNG is directly injected into the cavern, which has already been chilled through injection of increasingly cold gases and thereafter, liquids until the LNG is introduced with minimal thermal shock. Once in place, through circulation incidental to injection of new volumes and warming effected through thermal interaction at the subterraneous levels, gasification is commenced in situ with further gasification.

The propane buffer seal is gradually consumed during commingling with the gas. Propane is periodically added to the buffer seal to maintain the depth of the buffer fluid in a preferred range. Fluids other than propane are also used to form the buffer layer, such as a mixture of ethane and heavier hydrocarbons.

The cavern shape is controlled and changed as desired using conventional equipment and engineering techniques. In a preferred embodiment, the bottom of the cavern is formed such that the diameter is reduced. By reducing the diameter of the bottom of the cavern, the surface area over which the water is absorbed by the gas is also reduced, and in embodiments using a buffer layer as described above, the water and the buffer layer, and the buffer layer and the gas are also reduced. By reducing the surface area over which the water enters the propane and over which the propane enters the gas, the need for dehydration and buffer maintenance are reduced. In a preferred embodiment, the insoluble materials are isolated by careful shaping of the bottom of the cavern. A total seal is created by forming a bottle shape at the bottom of the cavern.

After the insoluble rubble has fallen below the bottle neck, the lower plastic salt completely seals the neck. When storing NG in a salt cavern, the internal pressure of the cavern is considered. There is a maximum safe pressure to which a salt cavern used to store natural gas is pressurized. The internal cavern pressure is affected by conditions such as the cavern salt temperature, the physical shape of the cavern, the physical and chemical composition of the salt and the nature, depth and density of the overburden (soil or sand) above the salt structure in which the cavern exists. If a cavern is filled with gas at a temperature lower than the temperature of the salt, the gas is warmed and the pressure rises. If the pressure rises above a safe level, the integrity of the storage cavern is possibly threatened. To lower the pressure, gas withdrawal from the cavern is initiated or if it is already being withdrawn, the rate of withdrawal is increased. The pressure in a cavern is then lowered, allowing for the temporary storage of a greater volume of gas by gradually allowing LNG to enter the cavern, thereby reducing LNG tanker unloading time. The effectiveness of this technique, in part, depends on the proximity of the cavern to an LNG dense phase warming system, and whether the storage cavern, is utilized for in situ gasification.

NG Storage Tanks

NG is stored in containers during shipment, after offloading in land or water, and at various points during transportation to the customers. The design and structure of these containers is well known to those skilled in the art. Typical shipping containers are spherical, preferably cylindrical, and contain approximately one million cubic feet of LNG. Ocean going ships carry from one to four of these containers, preferably three. Because the LNG in such instances is a liquid, no pressurization is needed. However, containers should withstand temperatures down to −240° C. Typical containers are composed of a nickel-steel alloy.

CNG is also transported in containers, but because the NG is compressed, pressurization is needed. Pressurization may be from 500 to 5,000 psig, preferably from 1,000 to 4,000 psig, more preferably from 2,000 to 3,000 psig, and most preferably from 1,400 to 3,600 psig. Container design is preferably a cylinder with rounded ends for maximum structural integrity. Cylinder size ranges from 1-6 feet in diameter, and from 20 to 400 feet long. Cylinder widths and lengths vary depending mostly on manufacturing and transportation needs.

Preferably cylinders are composed of a light-weight material that is relatively unaffected by cold temperatures and expected pressures. Temperature of CNG range from −100° C. to 30° C., and preferably from −80° C. to −20° C., and more preferably about −40° C. A material that adequately withstands such temperatures and also expected pressures includes, but is not limited to, steel, fiberglass, graphite, plastics, carbon fibers and combinations thereof. Additionally, containers may include a steel, aluminum or glass fiber lining, but an inner lining is preferably not needed. More preferred is steel, which has a high ductile fracture mode and a low brittle fracture mode. Also preferred is carbon fiber/binder wrapped containers using binders such as, but not limited to epoxies such as polyacrylonitrile (PAN), resins such as polyesters and combinations thereof. Carbon fibers that are both strong and light weight, as compared to steel, include, but are not limited to graphite, carbon composites, codified solid fibers, laminated carbon fibers, PAN-based carbon fibers, pitch-based carbon fibers and combinations thereof.

Container sizes for CNG preferably hold from 1 million cubic feet to 1 billion cubic feet of NG. The more compressed the NG, the greater strength desired against expansion of the container. The colder the CNG, the greater the resistance needed against brittle fracture. More preferred sizes are dictated by the requirements of the particular transportation vessel (e.g. ship), or storage facility size at which they are maintained.

Regasification

Once the LNG is unloaded from the tanker, it is stored as is, or gasified prior to short-term (e.g. days to weeks) or long-term (e.g. weeks to months to years) storage. The LNG is regasifiable at any point prior to reaching either an LNG or a gas storage facility. Examples include, but are not limited to, gasification during offloading if no LNG storage tankage is utilized, during transfer from the LNG storage tankage to an offshore NG storage facility, or during transfer from LNG storage tankage to a land based storage facility. The regasification of the LNG selectively begins immediately upon commencement of unloading from the tanker. Also, the regasified NG does not need to be transferred to a gaseous storage facility. The gaseous NG may be shipped to other offshore facilities, vessels, or locations, or even fed into existing gas pipelines as detailed later. For clarity of explanation, the majority of examples described herein will involve transferring the gaseous NG to a storage facility.

Liquid NG is gasified by a vaporization system that has any one or more of several configurations which include being submerged to make use of the warming capability of seawater. To gasify NG, liquid NG is pumped to an elevated pressure and is preferably introduced to a pipe or multiplicity of pipes, which are non-insulated, insulated, or partially insulated, and are configured to accommodate either natural or forced seawater circulation to facilitate warming at a desired rate.

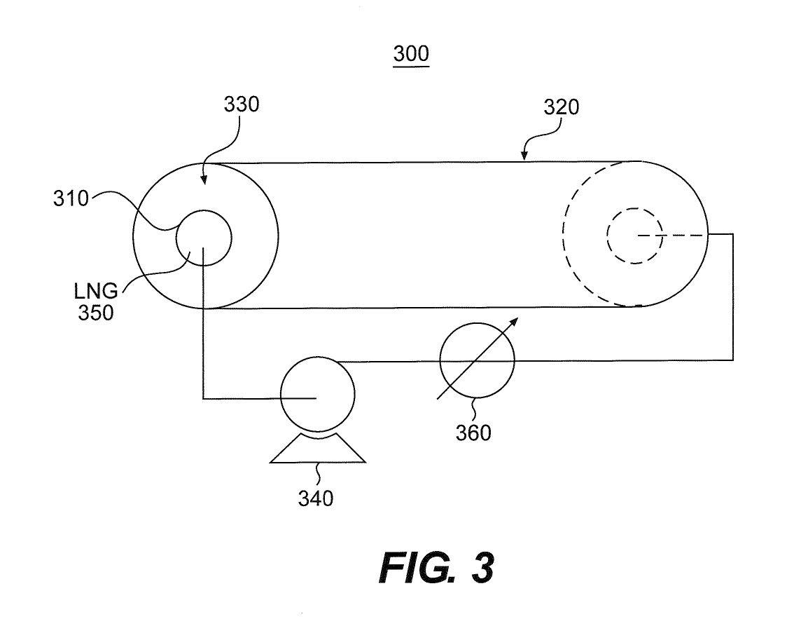

One preferred embodiment of the invention utilizes a jacketed pipe system similar to a tube-in-tube heat exchanger 300 (see FIG. 3). In this embodiment, liquid NG is transported through an inner pipe 310 that is surrounded by an outer pipe 320, which extends the entire length of the piping, partway, or in segments. The outer pipe is preferably filled with circulating liquid propane 330. A propane pump 340 pumps the liquid propane through the outer pipe 320 to warm the NG (in the inner pipe) 350. Ambient seawater pumped through a seawater exchange warmer 360 is used to warm the propane 330. An advantage of this embodiment is that the propane does not freeze at the temperature of the NG, and the propane is circulated at a rate such that seawater does not freeze on the exterior of the piping, thereby preventing buoyancy problems. An additional advantage is that if the inner pipe fails, the outer pipe then experiences an overpressure situation which detectable and used to produce a signal to stop the flow of the NG.

In an alternate embodiment of the invention, the piping is “wrapped” around the pumping platform supporting structure in a coiled spiral configuration to accommodate forced circulation (see FIG. 1). One or more coils or turns of piping are located underneath the seawater for heating of the NG inside the piping system. Preferably, at least 3 coils are located underwater, more preferably at least 4 coils are located underwater so that seawater is forced over piping carrying NG. A benefit of forcing seawater over the piping is that it prevents ice from forming on the outside of the piping. Forcing circulation of the seawater also prevent pockets of cold water from forming around the piping. Such pockets prevent efficient heating of the NG. By wrapping the piping around the structure, a minimal number of water movers, such as large underwater turbines, are needed to force seawater over a significant portion of the piping system. In further embodiments, the path of the piping is changed to maximize the warming capacity of the seawater.

In an alternate embodiment, the piping system is buried in the sea floor enrooted to shore side facilities. Further embodiments utilize insulation and anti-buoyancy systems to prevent ice-build up and unwanted buoyancy problems. NG is then safely vaporized, gasified, and warmed to normal pipeline temperature in a single carrier pipe submerged in seawater, with appropriate cryogenically qualified piping to carry the NG during the regasification process during the course of transportation.

In a further embodiment of the invention, a system utilizing different stages of piping is used to regasify the LNG. In this embodiment a first stage uses a jacketed pipe to carry the LNG from the tanker or storage facility, a second stage uses cryogenic piping, and a third stage uses standard piping. The different stages of piping are sized such that they correspond to the calculated temperature of the NG at each position in the regasification process. By matching the appropriate type of piping with the temperature of the NG, the system is robust enough to withstand the necessary temperature differences between the NG and the heat source (e.g. seawater), while having the most efficient heat transfer properties allowable.

NG is therefore safely vaporized, gasified, and warmed to normal pipeline temperature in a multiplicity of pipes submerged in seawater. Natural or forced seawater circulation is used as a heat source. Insulation is also used to moderate the heat transfer characteristics of the applied heat source. The pumping rate of the NG and/or the jacket fluid is used to moderate the heat transfer characteristics of the applied heat source. The warming fluid in the jacketing system, which is preferably propane, is warmed to an appropriate temperature for circulation by an exchange with seawater. Liquids other than propane that have appropriate chemical and physical properties such that they do not freeze at temperatures or harm the jacketing on safety system are used as the warming fluid in the jacketed system. Warming is used to control system buoyancy and the jacketed system is used as a leak monitor for the NG vaporizing system.

In a further embodiment, a pumping system is employed to force the circulation of seawater to control NG vaporizing/warming as well as control buoyancy, which is much more environmentally friendly than a heating system. Once the NG is regasified, it is stored or it is transported. Onshore storage systems are used to mitigate the flow quantities required to steadily supply the gas market regardless of flow variations from the offshore system operating parameters. Alternatively, an NG storage facility is incorporated to store the regasified NG.

In a further embodiment, after cooling of a salt cavern and the introduction of a barrier to the bottom rubble and salt water, the LNG is introduced directly into the salt cavern, circulating out in the process the cooling medium utilized to minimize the thermal shock associated with the introduction of the LNG directly into the storage cavern, where gasification and redelivery begins. The storage cavern in this embodiment has warming devices included in the cavern to circulate a warming medium to regasify the LNG for redelivery to traditional transportation systems.

The following examples illustrate embodiments of the invention, but should not be viewed as limiting the scope of the invention.

### EXAMPLES

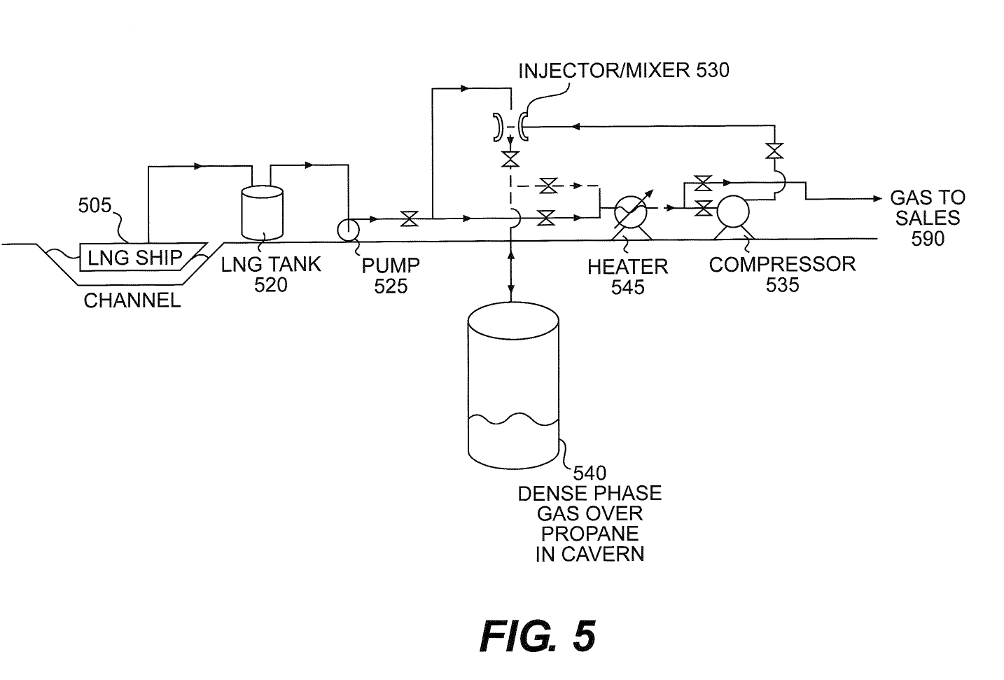

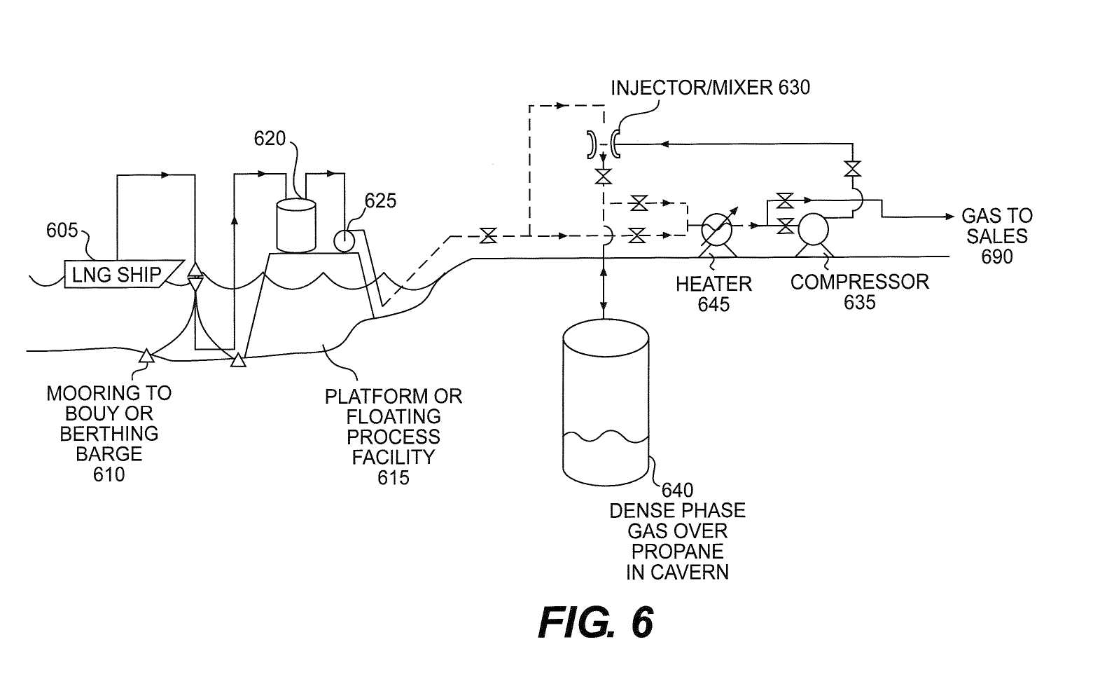

FIGS. 5 and 6 depict the use of dense phase equipment. In FIG. 5, NG is pumped from an offshore docked tanker 505 to a temporary NG tank 520 on shore. From the temporary tank, NG is pumped into an underwater cavern 540. A layer of propane is interposed by an injector/mixer 530 into the cavern as a buffer layer between the gas and the water to reduce the propensity of the water to go into the gas mixture. When desired, the NG is pumped out of the cavern, vaporized by a heater 545, and then distributed for sale through a pipeline system 590. The heater 545 and compressor 535 are optionally included for further compression. Preferably, onshore storage systems are used to mitigate the flow quantities needed to steadily supply the gas market regardless of flow variations from the offshore system operating parameters.

Preferably the gas stored in the salt cavern is natural gas, but any other hydrocarbon gas is acceptable. A method and/or apparatus is used to force gas out of the cavern by pushing propane from a second cavern with the driving force being salt water forced into second cavern. More preferably, the need for dehydration on removal of the gas from the storage cavern is mitigated by employing a propane water seal over the top of the water filled rubble (such as anhydrites) which exists in the cavern bottom.

In FIG. 6, this preferred embodiment depicts an offshore mooring 610 to the buoy berthing barge for docking and unloading of the NG tanker 605. The NG is pumped onto a platform or floating process facility 615 into a temporary tankage 620. Pump 625 then transfers the NG through an insulated/uninsulated line to shore and into underwater cavern 640. An injector/mixer 630 introduces the propane layer into the cavern as a rubber seal or buffer layer. When desired, the NG is pumped out of the onshore underwater cavern 640 and then distributed for sale through a pipeline system 690. Optionally, the NG passes through a heater 645 and compressor 635 before distribution.

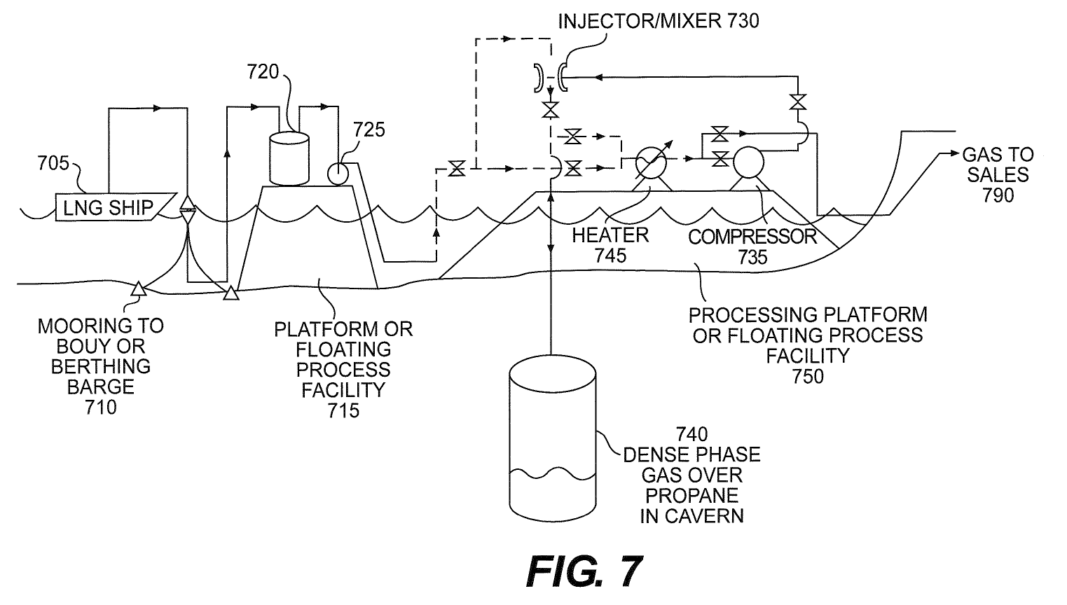

FIG. 7 shows the use of an offshore cavern. The NG tanker 705 is moored to buoy or berthing barge 710 while the NG is offloaded through insulated pipes to a temporary tankage 720 on a platform or floating process facility 715. A pump 725 on the platform transfers the NG via uninsulated pipelines onto another processing platform or floating process facility 750 with the dense phase equipment 730. The NG is stored in an underwater salt cavern 740 utilizing dense phase technology. When desired, the NG is pumped out of the offshore underwater cavern 740 and then distributed for sale through a pipeline system 790. Optionally, the NG passes through a heater 745 and compressor 735 before distribution.

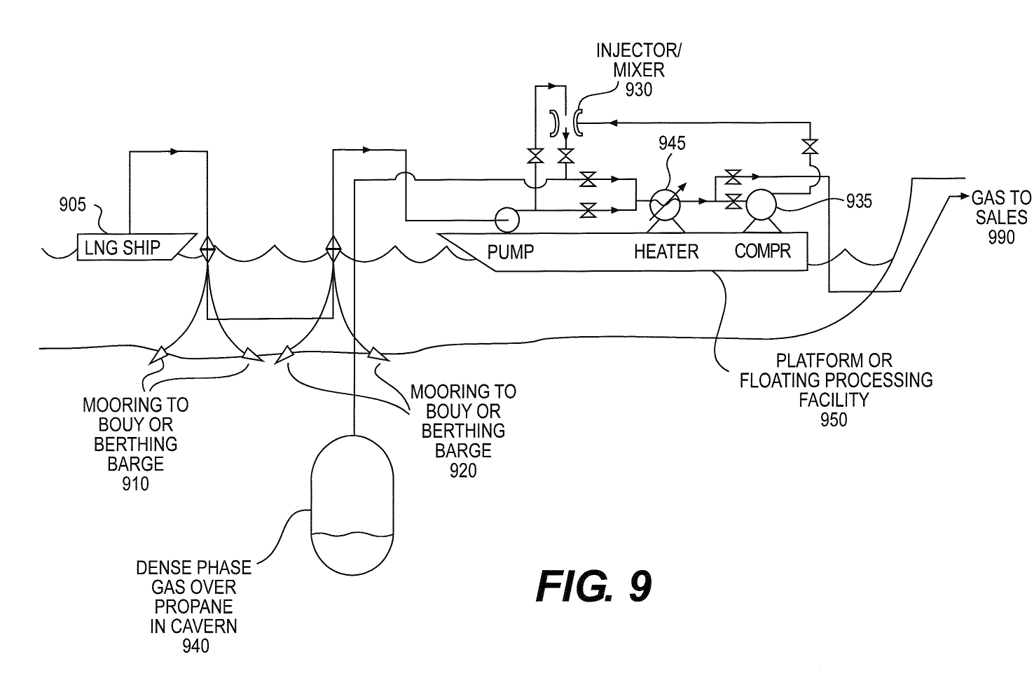

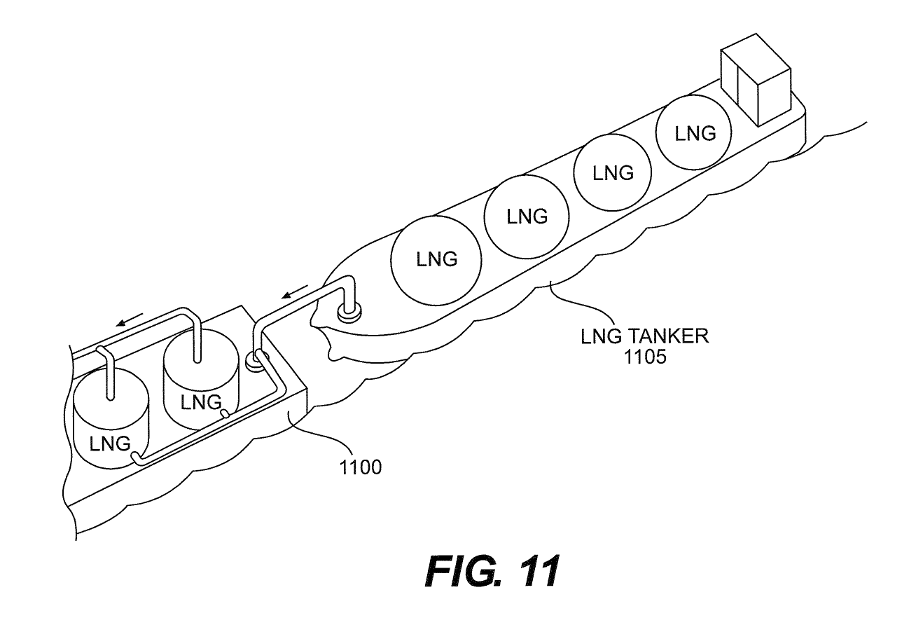

FIG. 11 shows an LNG tanker 1105 moored in tandem to a berthing barge 1110 offshore. Use of an optional additional and separate surge tank and optional floating platform are included in the various berthing facility embodiments. As shown in FIG. 9, the NG tanker 905 is moored offshore to multiple buoys/berthing barges 910, 920 to support insulated pipelines for NG transfer to a platform or floating processing facility 950 without a surge tank. Pump 925 then transfers the NG into an offshore underwater salt cavern 940. In FIG. 9, dense phase equipment 930 is used, but in other embodiments, it may be excluded. When desired, the NG is removed from the offshore underwater salt cavern 940 and carried onshore by existing offshore lines 990 for distribution. Optionally, the NG passes through a heater 945 and compressor 935 before distribution.

When gas is stored in a salt cavern it is difficult to regulate the flow out of the cavern. When the gas is stored under a high pressure, the gas can be withdrawn quickly. However, when the gas pressure in the cavern is reduced, it is much harder to withdraw the gas quickly.

In preferred embodiments, the NG is directed into a prepared gas storage cavern formed from a salt dome at high pressure, or is forced into the storage cavern by causing it to displace propane to a second cavern, which in turn displaces salt water to a storage reservoir.

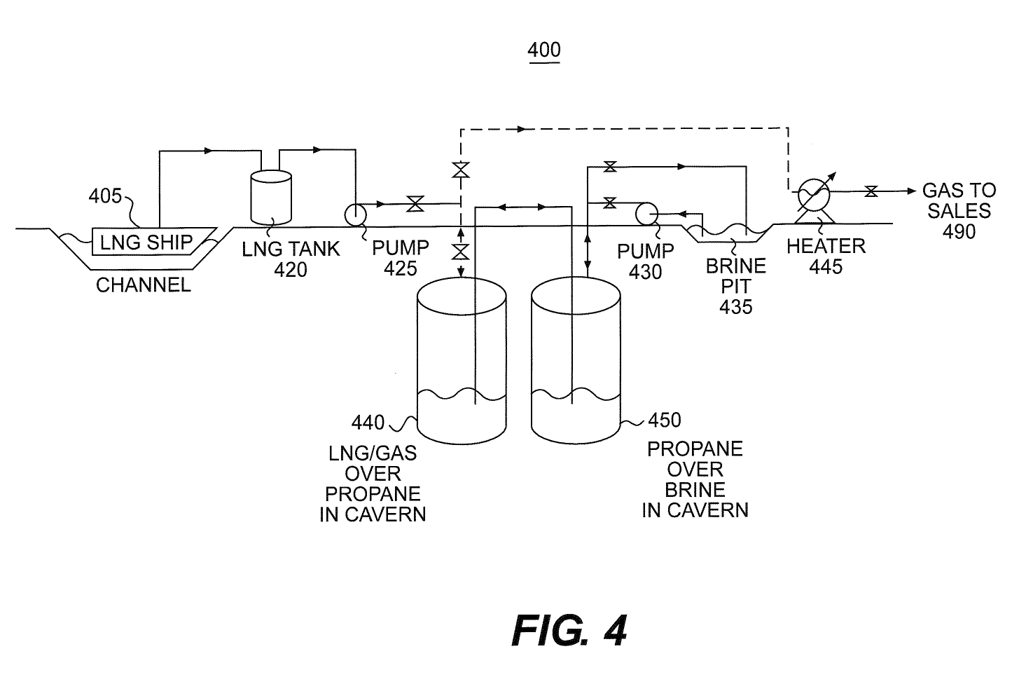

Accordingly, a further embodiment utilizes both a first salt cavern 440 and second salt cavern 450 as depicted in FIG. 4. The second cavern 450 is mostly filled with liquid propane. The remainder of the second cavern is filled with brine. An additional brine storage pool 435 is also utilized. The NG is pumped off the offshore NG tanker 405 into a temporary NG tankage 420 on shore, transferred via pump 425 into the first salt cavern 440. When the pressure in the first cavern 440 falls below a desired level, brine is pumped from the brine pool 435 into the second cavern 450, thereby displacing a portion of the liquid propane, the liquid propane is evacuated through a piping system into the bottom of the first cavern 440, thereby raising the pressure of the NG in the first cavern to the desired level. When desired, the NG is pumped out of the first cavern, heated into gaseous form by heater 445 and distributed for sale by pipeline 490.

The process is also reversible. NG introduced into the first cavern 440 for storage, the introduction displacing some of the liquid propane from the first cavern 440 into the second cavern 450, thereby displaces brine from the second cavern. The propane and/or the brine is displaced by pressure alone, or in another embodiment, the propane and/or the brine is pumped.

While the above embodiments use either one or two caverns, there is no limit to the number of caverns that are used. Alternate embodiments utilize other storage structures such as depleted gas reservoirs or man made storage facilities. If depleted reservoirs are used, multiple piping systems are used such that the reservoirs are uniformly filled.

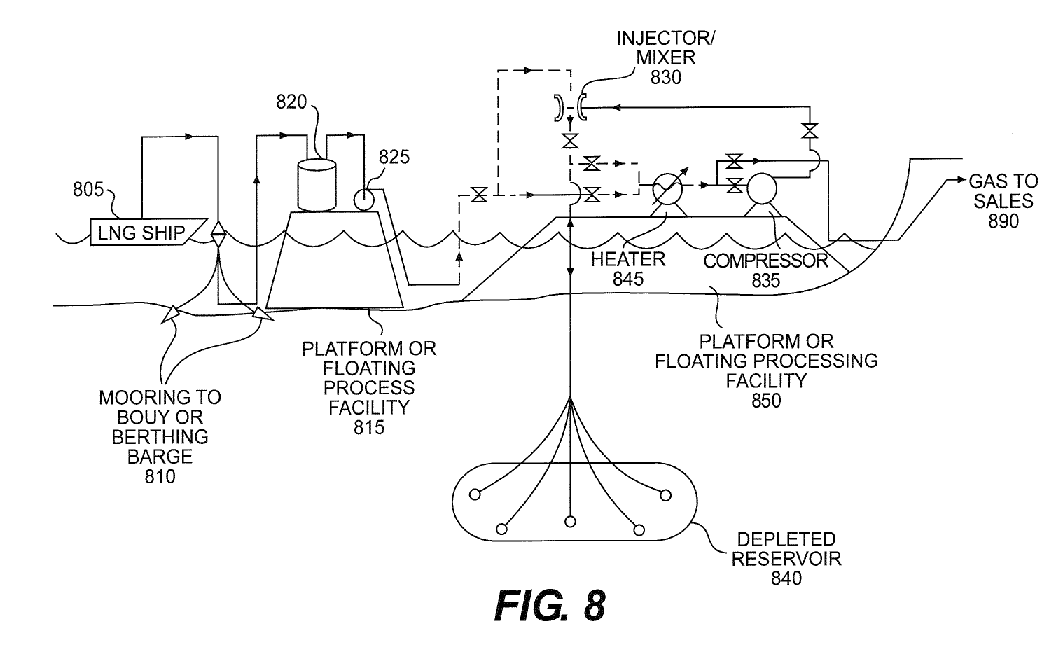

As shown in FIG. 8, a preferred embodiment includes offloading and storage in a depleted reservoir offshore. The NG tanker 805 is moored to buoy or berthing barge 810 while the NG is pumped through insulated pipes into a surge tank 820 on a platform or floating processing facility 815. The NG is then transferred by pump 825 via uninsulated pipes into an offshore underwater depleted reservoir 840. Dense phase equipment 830 is located on a platform or floating processing facility 850. When desired, the NG is pumped out of the offshore underwater depleted reservoir 840 and then carried onshore in an insulated pipeline for distribution 890. Optionally, the NG passes through a heater 845 and compressor 835 before distribution.

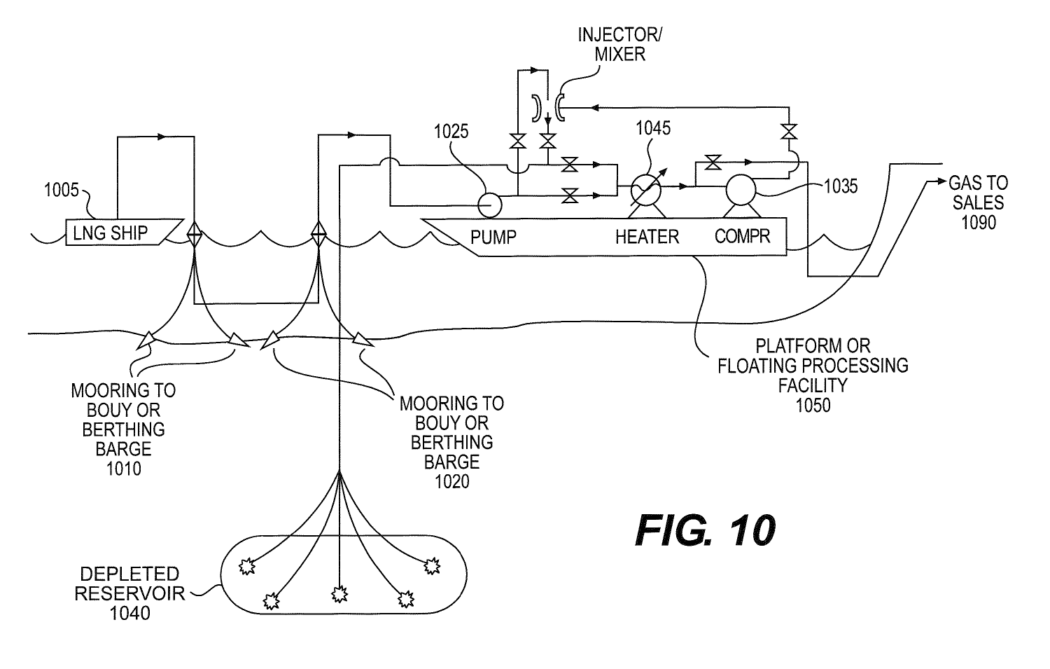

The separate temporary tankage is optionally included in the various embodiments of berthing facilities. As shown in FIG. 10, the NG tanker 1005 is moored offshore to multiple buoys/berthing barges 1010, 1020 to support insulated pipelines for NG transfer to a platform or floating processing facility 1050. Pump 1025 then transfers the NG into an offshore underwater depleted reservoir 1040. In FIG. 10, dense phase equipment 1030 is used, but in other embodiments may be excluded. When desired, the NG is removed from the offshore underwater depleted reservoir 1040 and carried onshore by existing offshore lines 1090 for distribution. Optionally, the NG passes through a heater 1045 and compressor 1035 before distribution.

In a further embodiment of the invention, NG is unloaded into the salt cavern or the propane gas pod and subsequently regasified by boil-off and/or surface reheating and/or transfer to further caverns, enhancing storage volume and control of the regasification process.

FIG. 12 shows an embodiment of a container for storing CNG on a tanker. Preferably one or more of the containers are located on a berthing facility, more preferably on a berthing facility receiving the tanker, and more preferably on both the tanker and the berthing facility. The depicted cylindrical container preferably holds 400-800 M ft³ of natural gas on one tanker. Preferably, the container is a hoop wrapped composite cylinder. The cylinder liner is made of steel or other suitable material that retains its strength at the lowest transportation temperatures maintained during transportation or during unloading of the CNG. The composite wrapping or filaments selectively comprise carbon, graphite or fiber glass, with a bonding material of epoxy or other resin.

Other embodiments and uses of the invention are apparent to those skilled in the art from consideration of the specification and practice of the invention disclosed herein. All references cited herein, including U.S. patent application Ser. No. 11/240,627 and all other publications, and U.S. and foreign patents and patent applications, are specifically and entirely incorporated by reference. It is intended that the specification and examples be considered exemplary only with the true scope and spirit of the invention.

1. An apparatus for storing and transported hydrocarbon gas comprising a cylindrical tube; a pair of end caps, one for each end of said cylinder; a reinforcing layer, attached to the outside of said cylinder and said end caps; a pair of flanges, one for each of said end caps; a manifold, for connecting a plurality of said apparatuses together; and insulation for covering said cylinder and said end caps.

2. The apparatus according to claim 1, wherein said cylinder is made of a metal.

3. The apparatus according to claim 1, wherein said reinforcing layer is a composite material.

4. The apparatus according to claim 1, wherein said end caps are secured to said cylinder by welding.

5. The apparatus according to claim 1, wherein said flange connects to said manifold.

6. The apparatus according to claim 1, further comprising sensors for monitoring the status of said gas.

7. The apparatus according to claim 1, further comprising a venting system.

8. An apparatus for transporting and storing hydrocarbon gas, said apparatus comprising a plurality of cylinders with end caps flanges, a manifold connected to said flanges, a rack for storing said cylinders in a group; a refrigeration system for maintaining the gas at a desired temperature; a power supply; a pumping system for loading and unloading said gas; and a venting and monitoring system for overseeing the storing and transporting of said gas.

9. The apparatus of claim 8, wherein said racks are transportable outside of a cargo hold of a ship.

10. The apparatus of claim 8, wherein said cylinders are wrapped with a reinforcing layer of composite material.

11. The apparatus of claim 8, wherein said cylinders are covered with an insulator.

12. The apparatus of claim 8, wherein said cylinders are stored in a climate-controlled chamber on board a ship.

13. The apparatus of claim 8, wherein said cylinders are individually removable.

14. The apparatus of claim 8, wherein said racks are individually removable.

15. The apparatus for transporting hydrocarbon gas comprising a pipeline running between at least two locations, a body of water, a plurality of pumps and heat exchangers, a gas supply source, and a gas receiving storage facility.

16. The apparatus according to claim 15, said pipeline further comprising a jacketing system, wherein an inner layer contains said hydrocarbon gas and an outer layer contains a circulating fluid, such as seawater, a circulation pump, and a means for detecting leakage of said inner layer.

17. The apparatus according to claim 15, wherein said pipeline is wrapped around a pumping platform for warming of said hydrocarbon gas.

18. The apparatus according to claim 15, wherein said pipeline comprises a plurality of stages for gasifying said hydrocarbon gas.

19. The apparatus according to claim 15, wherein said pipeline comprises a plurality of sizes.

20. The apparatus according to claim 15, further comprising auxiliary power supplies.

21. The apparatus according to claim 15, wherein said pipeline further comprises manual hand valves.

22. The apparatus according to claim 15, wherein said gas receiving storage facility comprises a plurality of tanks having individual valve sets, pressure venting, and quick-connect attachments for ease of replacement.

23. An apparatus for transporting hydrocarbon gas comprising a berthing facility capable of docking a hydrocarbon gas tanker internally or externally, a floating pumping platform, a plurality of pumps and heat exchangers, a generator, piping, an unloading arm, insulated liners designed for both top and bottom fill, and an underwater natural gas storage facility.

24. The apparatus of claim 23, said berthing facility further comprising a series of pumps located on said gas tanker.

25. The apparatus of claim 23, said berthing facility further comprising a plurality of pumps on said pumping platform.

26. The apparatus of claim 23, said berthing facility further comprising a plurality of pumps mounted on said berthing facility.

27. The apparatus of claim 23 further comprising a surge tank.

28. The apparatus of claim 23 further comprising a boil off compressor.

29. The apparatus of claim 23, said plurality of pumps further comprising a parallel arrangement.

30. The apparatus of claim 23, wherein said piping is wrapped around said pumping platform to accommodate forced circulation and facilitate natural gas warming.

31. The apparatus of claim 23, wherein said floating pumping platform houses dense phase equipment for the transfer of said hydrocarbon gas.

32. The apparatus of claim 23, wherein said piping is buried in or secured to the seafloor.

33. The apparatus of claim 23 further comprising a safety system.

34. The apparatus according to claim 23, further comprising auxiliary power supplies.

35. The apparatus according to claim 23, wherein said pipeline further comprises manual hand valves.

36. An apparatus for offloading or storing hydrocarbon gas comprising a gas transporter, a plurality of pumps and heat exchangers, piping from said transporter to a first underwater cavern, and a fluid buffer between said gas and the walls of said cavern.

37. The apparatus according to claim 36, further comprising a second cavern containing said fluid buffer.

38. The apparatus according to claim 36, further comprising a pump to transport said fluid buffer between said first and second caverns.

39. The apparatus according to claim 36, further comprising a pool for storing said fluid buffer which is pumped into said second cavern to raise the pressure in said first and second caverns to a desired level.

40. The apparatus according to claim 36, further comprising a plurality of auxiliary power supplies.

41. The apparatus according to claim 36, wherein said pipeline further comprises a plurality of manual hand valves.

42. An apparatus for storing hydrocarbon gas in an underwater facility with dense phase equipment comprising a plurality of pumps and heat exchangers, piping between a transport and an underwater facility, a fluid buffer interposed between said gas and the seawater to reduce the propensity of said gas and said buffer to mix, and a pump to periodically supplement said buffer to maintain a desired buffer thickness.

43. The apparatus according to claim 42, wherein said underwater facility is shaped such that the diameter around the bottom of said facility decreases so as to reduce the surface area over which said seawater can enter said gas and over which said buffer can enter said gas.

44. The apparatus according to claim 42, wherein said underwater facility is bottle-shaped.

45. An apparatus for storing hydrocarbon gas wherein an underwater cavern contains said gas, seawater, and a fluid buffer between said gas and said seawater.

46. The apparatus according to claim 45, wherein said fluid buffer comprises propane, methane, or a mixture thereof.

47. The apparatus according to claim 45, further comprising a plurality of auxiliary power supplies.

48. The apparatus according to claim 45, wherein said pipeline further comprises a plurality of manual hand valves.

49. An apparatus of transferring hydrocarbon gas comprising an underwater cavern, a pump for transferring said gas between a transport and said cavern, and pipes connected to said transport, said pump, and said cavern, a portion thereof submerged in seawater.

50. The apparatus according to claim 49, further comprising a plurality of auxiliary power supplies.

51. The apparatus according to claim 49, wherein said pipeline further comprises a plurality of manual hand valves.

52. An apparatus for storing and transporting hydrocarbon gas, said apparatus comprising a tank with a cylindrical inner layer of a material suitable for the transportation of hydrocarbon liquid and a reinforcing outer layer of a composite resin material; a valve system for filling and emptying the hydrocarbon liquid into said apparatus; a manifold system for connecting a plurality of said apparatuses; and a conex container for transportation, shelter from the elements, and temperature regulation of the hydrocarbon liquid.

53. The apparatus according to claim 52, wherein a refrigeration system maintains the hydrocarbon liquid in a desired state.

54. The apparatus according to claim 52 wherein said manifold system distributes hydrocarbon liquid between other said apparatuses for purposes of filling, emptying, or ballasting of hydrocarbon liquid cargo.

55. The apparatus according to claim 52 wherein said reinforcing outer layer further comprises a hoop structure of composites.

56. The apparatus according to claim 52 wherein said reinforcing outer layer further comprises additional composite wrapping.

57. The apparatus according to claim 52 wherein said manifold further comprises a plurality of manual hand valves and pressure gauges.

58. The apparatus according to claim 52 wherein said tank has a valve system for emergency pressure venting.

59. The apparatus according to claim 52 wherein said tank is quick-connected to said manifold system for easy replacement and installation.

60. The apparatus according to claim 52 wherein said tank further comprises a plurality of fluid stabilizing elements.

61. A method for transporting hydrocarbon gas comprising a pipeline pumping said gas through a submerged pipeline from an offshore location, warming said gas through natural or forced circulation of seawater or other fluid, transporting of said gas to a shore-based distribution facility, and altering the condition of said gas from a liquid state to a dense-phase gaseous state upon arrival at said shore-based facility.

62. The method according to claim 61, wherein said pipeline is buried under the seafloor.

63. The method according to claim 61, wherein said pipeline is attached to the seafloor surface.

64. The method according to claim 61, wherein said pipeline is laid between a ship berthing barge and a pumping platform.

65. The method according to claim 61, wherein said pipeline is laid between a pumping platform and a shoreline.

66. The method according to claim 61, wherein said pipeline is laid between a plurality of locations, at least one offshore and at least one onshore.

67. The method according to claim 61, wherein said pipeline gasifies said gas by pumping said gas through a plurality of pipeline sizes.

68. The method according to claim 61, wherein said pumping is achieved by a plurality of pumps and heat exchangers.

69. A method of offloading or storing hydrocarbon gas comprising offloading by pumping said gas from a transporter into a first underwater cavern containing a fluid buffer between said gas and water within said cavern and selectively gasifying said liquefied gas during transfer to said first cavern, or during offloading from said transporter.

70. The method according to claim 69, further comprising storing said fluid buffer within a second underwater cavern, wherein said fluid can be selectively pumped into said first cavern during filling of said first cavern with said gas.

71. The method according to claim 69, further comprising pumping of said fluid buffer from a pool into said second cavern, displacing a portion of said fluid buffer into the bottom of said first cavern, raising the pressure in said first cavern to a desired level.

72. The method according to claim 69, further comprising gasifying said gas during transfer into said first cavern or upon offloading from said transporter.

73. The method according to claim 69, said pumping utilizing a plurality of pumps and heat exchangers.

74. A method of storing hydrocarbon gas in an underwater facility with dense phase equipment comprising pumping said gas from a transport to an underwater facility, interposing a fluid buffer between said gas and seawater for reducing the propensity of said seawater to mix with said gas, and periodically supplementing said buffer to maintain a desired thickness of said buffer.

75. The method according to claim 74 wherein said fluid buffer comprises methane, propane, or a mixture thereof.

76. The method of transferring hydrocarbon gas into an underwater cavern comprising acclimating said cavern to approximately the temperature of said gas by repeatedly transferring said gas, heated by passing through pipes submerged in seawater, into said cavern, wherein said gas is colder than said cavern, and each repeated transfer comprises said gas which is colder than the previous transfer.

77. The method of transporting hydrocarbon gas comprising a plurality of said apparatuses arranged on a vessel; a mooring station for receiving and offloading said hydrocarbon liquid from said vessel; an underwater piping system connecting to said station, for maintaining hydrocarbon liquid at a desired state, said piping system connected to a receiving station for receiving said hydrocarbon liquid; said receiving station for dispensing said hydrocarbon liquid into said apparatuses for transportation or storage.

78. The method according to claim 77 wherein said mooring station is located on the shore or along inland waterways.

79. The method according to claim 77 wherein said piping system comprises an external jacket containing a thermodynamic liquid for controlling the temperature and state of said hydrocarbon liquid and monitoring for any leakage of the hydrocarbon liquid into said thermodynamic liquid.
